(19) United States
(12) Patent Application Publication
(10) Pub. No.: US 2025/0089689 A1
(43) Pub. Date: Mar. 20, 2025

(54) Box Filter w/ C.O.D.

(71) Applicant: Conner J. King, Loveland, CO (US)

(72) Inventor: Conner J. King, Loveland, CO (US)

(21) Appl. No.: 18/470,817

(22) Filed: Sep. 20, 2023

(51) Int. Cl. A01K 63/04

(52) U.S. Cl. CPC A01K 63/042; A01K 63/045; A01K 63/047

(57) ABSTRACT

A box filter w/c.o.d. formed of plastic. It includes a system of filtration that will render any aquatic environment cycleless and has connections for internal plumbing and compressed oxygen diffusion or c.o.d., wet/dry biologic bacteria generation and storage, submerged lighting, protein bioskimmer filter, wet/dry trickle biologic filter, sponge pre-filter, carbon pre-filter, dosing system, window for viewing inside, top surface skimming slots, deep water pull skimming, vac pipe top water skimming with skimbob, water top-off, additive, and fill feeding port with separate submerged water, food, additive release port, manual or electronic feeding system, flow control manifold powerhead/(s), thermostatic system control interface, probes and sensors. The unit can hang or stand freely in/on any chamber bottom or rim and may be elevated. Use includes the transfer of water from any habitat containment chamber and into the filter unit for processing and then back into the main habitat containment chamber again.

### FIELD OF INVENTION

The present invention relates generally to a box filter which hangs over the tank wall or freely stands within any aquarium, tank, sump or pond, and is used to transfer unfiltered water from inside the main tank/habitat chamber containment area and into the internal filter system w/c.o.d. which resides on the inside of the aquarium, tank, sump or pond. After filtering, the newly filtered and processed water is then pumped from the box filter w/c.o.d. and returned inside the tank chamber area once again. This circulating process continues uninterrupted.

### BACKGROUND ART

There are various types of box filters on the market today, most are complicated in nature and limited in functionality. Many, if not all of these filters provide little in the way of added features which can address the extended needs of most modern aquarists.

Some limitations of these filters include their inability to either hang on the wall, stand freely or be expandable to fit in any system application when considering water volume, tank height, and/or tank wall thickness when processing water after initial installation, set up and priming.

Current box filter systems are limited to hanging on the wall or positioning at the top of the tank habitat chamber and do not provide adjustability for internal placement in shallow, tidal-pool environments where water levels may drop down to varies lower levels within the inside of the habitat chamber, nor is it possible to stand them freely on their own and unattached to the outside tank wall.

At this point there does not exist the offered functionality for “compressed oxygen diffusion” or c.o.d. in any filter on the market. Compressed oxygen diffusion provides minute oxygen bubble introduction into any type of aquatic environment and makes the habitat chamber become part of the overall filtration system. By adding c.o.d. to the aquatic habitat chamber, the system becomes “cycleless” or spike free, a feature which has never been available before.

There is also traditionally the lack of any provided top surface skim slots for protein, contaminant, and algae bloom removal.

Most if not all of the current box filters do not provide a protein skimming feature or bioskimmer which removes contaminants such as ammonia, nitrate, nitrite and detritus build-up, as well as ague blooms from the system.

Few provide a method for the process of top surface water skimming let alone both top surface water skimming and low level water pull skimming separately or both at the same time during operation.

In addition, no current box filters offer the ability to bypass the top surface skim slots when applicable when spending time away from the system, an action which will cause the system pump to run dry and possibly overheat and threaten the safety of both the system and the tank inhabitants.

There is currently no provision granted by existing skimming type box filters or deep water pull pipe type box filters to address water level reduction due to the evaporation which takes place when the operator is away or vacationing and cannot provide additional water to the system which results in supply water reduction, pump dry run, and overheating.

They offer little or no ability for the aquarist to add more water when topping off their existing main tank/habitat chamber containment area's internal water level after main tank/habitat chamber containment area evaporation has taken place.

Seldom is there provided any biologic media, or the ability to cultivate, store or maintain cultured bacteria in a standard box filter.

The provision for an internal additive or chemical dosing system is not granted or addressed by most box filter types.

Other disadvantages include a missing or inadequate method for the combined use of a sufficient sponge pre-filter which adds mechanical filtration, and/or a carbon media filter which adds chemical filtration upon initial startup of the filtration system.

The inability of most box filter types to provide water return manifolds or powerheads for flow control leaves them lacking in their use for internal tank circulation as well as their creation of realistic tidal-flow stimulation.

Additionally, there exists the need for some type of feeding apparatus which would provide the inhabitants of the main tank/habitat chamber containment area with submerged food release, this being a feature which would help to eliminate the top feeding habits of most fish and address a condition in fish which is known as Physostomous, or air-bladder disease.

The lack of sufficient technology to incorporate the use of a built-in controller which would include a thermostat and set of diodes and probes, a combination which would provide the aquarist with pertinent real time information regarding the current state of the water quality that is present within the main tank/habitat chamber containment area itself.

Additionally, the use of internal or submersible lighting system is virtually nonexistent on existing box filter types, nor do they offer any places for inhabitants to hide and play while in use.

Finally, there is the overall disadvantage that most box filters have which is that they are solely independent in design and construction and they do not participate or belong to any distinct family or complete system of like products which covers the full spectrum of internal water filtration, purification and processing, this alone rendering them obsolete and most likely incompatible when the aquarist is constructing a new, or expanding an existing filtration system in their overall support of an aquatic environment.

### BRIEF SUMMARY OF THE INVENTION

An aspect of the present invention is to provide a box filter with c.o.d. which is incredibly versatile and easy to install, set up, and use.

An aspect of the present invention is to provide a box filter which can hang on the rim, or stand freely in, or hang on the rim and stand freely simultaneously in an aquatic environment while processing water.

An aspect of the present invention is to provide a box filter with a c.o.d. that allows for the generation and dispersement of compressed oxygen diffusion or c.o.d. into the main habitat chamber of the aquatic environment.

An aspect of the present invention is to provide a multitude of top surface skimming slots which continuously skim the main tank/habitat chamber containment area's upper water column and removes any contaminants which float up to the top surface or reside there.

An aspect of the present invention is to provide a protein skimming feature which removes contaminants such as ammonia, nitrate, nitrite and detritus build-up, as well as algae blooms from the system.

An aspect of the present invention is to provide a method for the processes of both top surface water skimming and low-level water pull skimming simultaneously.

An aspect of the present invention is to provide a standard low-level water pull bypass plug for 100% top surface water skimming activation via the surface water skimming intake slots.

An aspect of the present invention is to provide an optional vac pipe and external top water surface skimbob configuration conversion kit which allows for the offset of the evaporation that takes place in the tank habitat chamber and prevents any surface water skimming from taking place, this often occurs when the system is left unattended during away time, (or vacationing); this illuminates the dry-run and overheating of the pump when the internal tank water level of the habitat chamber falls below that of the acceptable drain level of the surface water skimming intake slots and causes the pump to run dry.

An aspect of the present invention is to provide a removable bio media containment box which allows for assorted media types to be kept in place in a wet/dry atmosphere when cultivating and storing live bacteria.

An aspect of the present invention is to provide a set of interchangeable biotower with a large amount of surface area both submerged and exposed which can generate and store multiple types of living bacteria, and that can also be rinsed out periodically in a timed sequence to avoid bacteria overload and buildup on the specified substrate surface areas.

An aspect of the present invention is to provide a high flow bio skimmer with a waist foam catch cup, float, and float level indicator for particulate and protein removal.

An aspect of the present invention is to provide an additive or chemical dosing system with combination cap/stand and both stream and drip injection features.

Another aspect of the present invention is to provide a translucent or clear window for viewing inside the filter.

Another aspect of the present invention is to provide a method for the combined use of a sponge pre-filter which adds mechanical filtration to the system, and a carbon media pre-filter which adds chemical filtration to the system.

Another aspect of the present invention is to provide the use of an external flow control valve which (also allows for the connection of an additional external positive flow air-pump) and injection manipulation of both the c.o.d. injection rate, and the simulated incoming tidal or slack tidal flowrate of water re-entering the habitat chamber from the pump.

Another aspect of the present invention is to provide a suitable mounting port for the addition of an assortment of bi-directional and adjustable flow control manifolds as well as other aftermarket powerhead assemblies which would assist with main tank/habitat chamber containment area circulation and water return flow control.

Another aspect of the present invention is to provide a combination external top-off, water fill, additive, and food introduction port which can be used for manually adding chemicals, additives or food to the system, or water to top-off the main tank/habitat chamber containment area after evaporation has taken place.

Another aspect of the present invention is to provide an independent top-off, water fill, additive, and slide soak feeder tank wall clip.

Another aspect of the present invention is to provide a manual soak feeder assembly or optional electronic soak feeder attachment for the application of submerged food release prior to feeding, a mechanism which eliminates the top feeding habits of fish and addresses the condition in fish which is known as Physostomous, or air-bladder disease.

Another aspect of the present invention is to provide a controller with a built-in thermometer and a complete set of diodes and probes which can grant the aquarist with a digital display of pertinent real time information regarding the current status of their existing water conditions.

An aspect of the present invention is to provide a submersible lighting system with controller as well as a box filter elevation sub section light mounting stand.

An aspect of the present invention is to provide a set of submersible box filter sub section elevation stands for height adjustment.

Another aspect of the present invention is to provide a compatible new member to an already growing family of scientifically engineered, designed and tested aquatic products which make up an entire process system for both internal and external water purification and processing.

This invention relates generally to the field of aquatics and more specifically, to the processes used in the transfer of water from an aquarium or main tank/habitat chamber containment area, sump or pond and out into a attached or free standing filtration unit for processing before then returning the water back to the aquarium or main tank/habitat chamber containment area, sump or pond, once again.

Since the invention of the box filter, participants in the aquatics game have strived for perfection and reliability in the techniques and equipment being used for aquatic water processing, all while enjoying the fun filled world of aquatics and the personal and family gratification which such activities provide.

There is a complete industry built in the support of the hobby of aquatics. From standard and specialty designed tanks, sumps, filtration systems, lighting and equipment, to multi-million-dollar aquariums which are located all over the world.

Designs and patents exist on all phases of both indoor and outdoor system designs and supporting equipment. Currently, a fully option filled box filter w/c.o.d. design has no present representation in any type of modern aquatic market place, with the exception of existing units that may look similar in nature, but have no c.o.d. or connection with an overall complete system configuration which is as versatile and expansive as the in-depth system design being presented.

### BRIEF DESCRIPTION OF THE DRAWINGS

FIG. 1 depicts an exploded perspective assembly view of all the parts contained in the embodiment of the present invention.

FIG. 2 depicts an exploded perspective assembly view of all the parts contained in the embodiment of an optional FIG. 2 manual soak feeder attachment version AL, AM AND AN, from the embodiment of the present invention.

FIG. 3 depicts an exploded perspective assembly view of all the parts contained in the embodiment of an optional FIG. 3 automatic soak feeder attachment version AO, AP, AQ, AR, AS, AN, AC1, and AT, from the embodiment of the present invention.

FIG. 4 depicts an exploded perspective assembly view of all the parts contained in the embodiment of an optional stand-alone accessory, FIG. 4 sliding soak feeder tank wall clip AU, which can incorporate the optional FIG. 2 manual soak feeder attachment version AL, AM AND AN shown, or the optional FIG. 3 automatic soak feeder attachment version AO, AP, AQ, AR, AS, AN, AC1, and AT not shown, from the embodiment of the present invention.

FIG. 5 depicts a block diagram bill of materials or BOM which consists of individual line items as each is depicted in their alphabetical order of appearance as shown in FIG. 1, FIG. 2, FIG. 3, and FIG. 4, from the embodiment of the present invention.

FIG. 6 depicts a top front perspective view of the assembly unit without options, from the embodiment of the present invention.

FIG. 7 depicts a front plan view of the assembly unit without options, from the embodiment of the present invention.

FIG. 8 depicts a left side plan view of the assembly unit without options, from the embodiment of the present invention.

FIG. 9 depicts a top back perspective view of the assembly unit without options, from the embodiment of the present invention.

FIG. 10 depicts a back plan view of the assembly unit without options, from the embodiment of the present invention.

FIG. 11 depicts a right side plan view of the assembly unit without options, from the embodiment of the present invention.

FIG. 12 depicts a top front perspective view of FIG. 1 box bottom enclosure housing A, from the embodiment of the present invention.

FIG. 13 depicts a bottom back perspective view of FIG. 1 box bottom enclosure housing A, from the embodiment of the present invention.

FIG. 14 depicts a front plan view of FIG. 1 box bottom enclosure housing A, from the embodiment of the present invention.

FIG. 15 depicts a back plan view of FIG. 1 box bottom enclosure housing A, from the embodiment of the present invention.

FIG. 16 depicts a top plan view of FIG. 1 box bottom enclosure housing A, from the embodiment of the present invention.

FIG. 17 depicts a bottom plan view of FIG. 1 box bottom enclosure housing A, from the embodiment of the present invention.

FIG. 18 depicts a left side plan view of FIG. 1 box bottom enclosure housing A, from the embodiment of the present invention.

FIG. 19 depicts a right side plan view of FIG. 1 box bottom enclosure housing A, from the embodiment of the present invention.

FIG. 20 depicts a top plan view of FIG. 1 box bottom enclosure housing A, with the location of (Section A-A), from the embodiment of the present invention shown.

FIG. 21 depicts a (Section A-A view), of FIG. 1 box bottom enclosure housing A, from the embodiment of the present invention.

FIG. 22 depicts a top plan view of FIG. 1 box bottom enclosure housing A, with the location of (Section B-B), from the embodiment of the present invention shown.

FIG. 23 depicts a (Section B-B view), of FIG. 1 box bottom enclosure housing A, from the embodiment of the present invention.

FIG. 24 depicts a front perspective view of FIG. 1 box top enclosure housing B, from the embodiment of the present invention.

FIG. 25 depicts a bottom back perspective view of FIG. 1 box top enclosure housing B, from the embodiment of the present invention.

FIG. 26 depicts a front plan view of FIG. 1 box top enclosure housing B, from the embodiment of the present invention.

FIG. 27 depicts a back plan view of FIG. 1 box top enclosure housing B, from the embodiment of the present invention.

FIG. 28 depicts a top plan view of FIG. 1 box top enclosure housing B, from the embodiment of the present invention.

FIG. 29 depicts a bottom plan view of FIG. 1 box top enclosure housing B, from the embodiment of the present invention.

FIG. 30 depicts a left side plan view of FIG. 1 box top enclosure housing B, from the embodiment of the present invention.

FIG. 31 depicts a right side plan view of FIG. 1 box top enclosure housing B, from the embodiment of the present invention.

FIG. 32 depicts a top plan view of FIG. 1 box top enclosure housing B, with the location of (Section C-C), from the embodiment of the present invention shown.

FIG. 33 depicts a (Section C-C view), of FIG. 1 box top enclosure housing B, from the embodiment of the present invention.

FIG. 34 depicts a top plan view of FIG. 1 box top enclosure housing B, with the location of (Section D-D), from the embodiment of the present invention shown.

FIG. 35 depicts a (Section D-D view), of FIG. 1 box top enclosure housing B, from the embodiment of the present invention.

FIG. 36 depicts a front perspective view of FIG. 1 box bottom elevation stand c.o.d. diffuser C, from the embodiment of the present invention.

FIG. 37 depicts a bottom back perspective view of FIG. 1 box bottom elevation stand c.o.d. diffuser C, from the embodiment of the present invention.

FIG. 38 depicts a front plan view of FIG. 1 box bottom elevation stand c.o.d. diffuser C, from the embodiment of the present invention.

FIG. 39 depicts a back plan view of FIG. 1 box bottom elevation stand c.o.d. diffuser C, from the embodiment of the present invention.

FIG. 40 depicts a top plan view of FIG. 1 box bottom elevation stand c.o.d. diffuser C, from the embodiment of the present invention.

FIG. 41 depicts a bottom plan view of FIG. 1 box bottom elevation stand c.o.d. diffuser C, from the embodiment of the present invention.

FIG. 42 depicts a left side plan view of FIG. 1 box bottom elevation stand c.o.d. diffuser C, from the embodiment of the present invention.

FIG. 43 depicts a right side plan view of FIG. 1 box bottom elevation stand c.o.d. diffuser C, from the embodiment of the present invention.

FIG. 44 depicts a top plan view of FIG. 1 box bottom elevation stand c.o.d. diffuser C, with the location of (Section E-E), from the embodiment of the present invention shown.

FIG. 45 depicts a (Section E-E view), of FIG. 1 box bottom elevation stand c.o.d. diffuser C, from the embodiment of the present invention.

FIG. 46 depicts a top plan view of FIG. 1 box bottom elevation stand c.o.d. diffuser C, with the location of (Section F-F), from the embodiment of the present invention shown.

FIG. 47 depicts a (Section F-F view), of FIG. 1 box bottom elevation stand c.o.d. diffuser C, from the embodiment of the present invention.

FIG. 48 depicts a front perspective view of FIG. 1 optional box bottom elevation stand light D, with FIG. 1 optional box bottom light elevation stand enclosure housing light fixture BB, from the embodiment of the present invention mounted.

FIG. 49 depicts a bottom front perspective view of FIG. 1 optional box bottom elevation stand light D, with FIG. 1 optional box bottom elevation stand light enclosure housing light fixture bulb BF, from the embodiment of the present invention mounted.

FIG. 50 depicts a front plan view of FIG. 1 optional box bottom elevation stand light D, from the embodiment of the present invention.

FIG. 51 depicts a back plan view of FIG. 1 optional box bottom elevation stand light D, from the embodiment of the present invention.

FIG. 52 depicts a top plan view of FIG. 1 optional box bottom elevation stand light D, from the embodiment of the present invention.

FIG. 53 depicts a bottom plan view of FIG. 1 optional box bottom elevation stand light D, from the embodiment of the present invention.

FIG. 54 depicts a left side plan view of FIG. 1 optional box bottom elevation stand light D, from the embodiment of the present invention.

FIG. 55 depicts a right side plan view of FIG. 1 optional box bottom elevation stand light D, from the embodiment of the present invention.

FIG. 56 depicts a top front perspective view of FIG. 1 optional box bottom elevation stand light enclosure housing light fixture bulb BF, and FIG. 1 optional box bottom elevation stand light remote control BG, from the embodiment of the present invention.

FIG. 57 depicts a top plan view of FIG. 1 optional box bottom elevation stand light D, with the location of (Section G-G), from the embodiment of the present invention shown.

FIG. 58 depicts a (Section G-G view), of FIG. 1 optional box bottom elevation stand light D, from the embodiment of the present invention.

FIG. 59 depicts a top plan view of FIG. 1 optional box bottom elevation stand light D, with the location of (Section H-H), from the embodiment of the present invention shown.

FIG. 60 depicts a (Section H-H view), of FIG. 1 optional box bottom elevation stand light D, from the embodiment of the present invention.

FIG. 61 depicts a front perspective view of FIG. 1 optional box bottom elevation stand regular E, from the embodiment of the present invention.

FIG. 62 depicts a bottom front perspective view of FIG. 1 optional box bottom elevation stand regular E, from the embodiment of the present invention.

FIG. 63 depicts a front plan view of FIG. 1 optional box bottom elevation stand regular E, from the embodiment of the present invention.

FIG. 64 depicts a back plan view of FIG. 1 optional box bottom elevation stand regular E, from the embodiment of the present invention.

FIG. 65 depicts a top plan view of FIG. 1 optional box bottom elevation stand regular E, from the embodiment of the present invention.

FIG. 66 depicts a bottom plan view of FIG. 1 optional box bottom elevation stand regular E, from the embodiment of the present invention.

FIG. 67 depicts a left side plan view of FIG. 1 optional box bottom elevation stand regular E, from the embodiment of the present invention.

FIG. 68 depicts a right side plan view of FIG. 1 optional box bottom elevation stand regular E, from the embodiment of the present invention.

FIG. 69 depicts a top plan view of FIG. 1 optional box bottom elevation stand regular E, with the location of (Section I-I), from the embodiment of the present invention shown.

FIG. 70 depicts a (Section I-I view), of FIG. 1 optional box bottom elevation stand regular E, from the embodiment of the present invention.

FIG. 71 depicts a top plan view of FIG. 1 optional box bottom elevation stand regular E, with the location of (Section J-J), from the embodiment of the present invention shown.

FIG. 72 depicts a (Section J-J view), of FIG. 1 optional box bottom elevation stand regular E, from the embodiment of the present invention.

FIG. 73 depicts a front perspective view of FIG. 1 optional box bottom elevation stand tall F1, F2, from the embodiment of the present invention.

FIG. 74 depicts a bottom front perspective view of FIG. 1 optional box bottom elevation stand tall F1, F2, from the embodiment of the present invention.

FIG. 75 depicts a front plan view of FIG. 1 optional box bottom elevation stand tall F1, F2, from the embodiment of the present invention.

FIG. 76 depicts a back plan view of FIG. 1 optional box bottom elevation stand tall F1, F2, from the embodiment of the present invention.

FIG. 77 depicts a top plan view of FIG. 1 optional box bottom elevation stand tall F1, F2, from the embodiment of the present invention.

FIG. 78 depicts a bottom plan view of FIG. 1 optional box bottom elevation stand tall F1, F2, from the embodiment of the present invention.

FIG. 79 depicts a left side plan view of FIG. 1 optional box bottom elevation stand tall F1, F2, from the embodiment of the present invention.

FIG. 80 depicts a right side plan view of FIG. 1 optional box bottom elevation stand tall F1, F2, from the embodiment of the present invention.

FIG. 81 depicts a top plan view of FIG. 1 optional box bottom elevation stand tall F1, F2, with the location of (Section K-K), from the embodiment of the present invention shown.

FIG. 82 depicts a (Section K-K view), of FIG. 1 optional box bottom elevation stand tall F1, F2, from the embodiment of the present invention.

FIG. 83 depicts a top plan view of FIG. 1 optional box bottom elevation stand tall F1, F2, with the location of (Section L-L), from the embodiment of the present invention shown.

FIG. 84 depicts a (Section L-L view), of FIG. 1 optional box bottom elevation stand tall F1, F2, from the embodiment of the present invention.

FIG. 85 depicts a front perspective view of FIG. 1 box bottom dual head w/venturi system pump G, from the embodiment of the present invention.

FIG. 86 depicts a front plan view of FIG. 1 box bottom dual head w/venturi system pump G, from the embodiment of the present invention.

FIG. 87 depicts a right side plan view of FIG. 1 box bottom dual head w/venturi system pump G, from the embodiment of the present invention.

FIG. 88 depicts a top plan view of FIG. 1 box bottom dual head w/venturi system pump G, from the embodiment of the present invention.

FIG. 89 depicts a bottom plan view of FIG. 1 box bottom dual head w/venturi system pump G, from the embodiment of the present invention.

FIG. 90 depicts a front assembly perspective view of FIG. 1 box bottom dual head w/venturi system pump G, mounted in place on FIG. 1 box bottom enclosure housing A, from the embodiment of the present invention.

FIG. 91 depicts a top plan assembly view of FIG. 1 box bottom dual head w/venturi system pump G, mounted in place on FIG. 1 box bottom enclosure housing A, from the embodiment of the present invention.

FIG. 92 depicts a bottom plan assembly view of FIG. 1 box bottom dual head w/venturi system pump G, mounted in place on FIG. 1 box bottom enclosure housing A, from the embodiment of the present invention.

FIG. 93 depicts a front perspective view of FIG. 1 optional box bottom sponge media pre-filter H, from the embodiment of the present invention.

FIG. 94 depicts a front assembly perspective view of FIG. 1 optional box bottom sponge media pre-filter H, mounted in place in front of FIG. 1 box bottom dual head w/venturi system pump G, and FIG. 1 box bottom biotower generator drip tray pipe BC (removable), from the embodiment of the present invention.

FIG. 95 depicts a front plan view of FIG. 1 optional box bottom sponge media pre-filter H, from the embodiment of the present invention.

FIG. 96 depicts a back plan view of FIG. 1 optional box bottom sponge media pre-filter H, from the embodiment of the present invention.

FIG. 97 depicts a left side plan view of FIG. 1 optional box bottom sponge media pre-filter H, from the embodiment of the present invention.

FIG. 98 depicts a right side plan view of FIG. 1 optional box bottom sponge media pre-filter H, from the embodiment of the present invention.

FIG. 99 depicts a top plan view of FIG. 1 optional box bottom sponge media pre-filter H, from the embodiment of the present invention.

FIG. 100 depicts a bottom plan view of FIG. 1 optional box bottom sponge media pre-filter H, from the embodiment of the present invention.

FIG. 101 depicts a top plan view of FIG. 1 optional box bottom sponge media pre-filter H, with the location of (Section M-M), from the embodiment of the present invention shown.

FIG. 102 depicts a (Section M-M view), of FIG. 1 optional box bottom sponge media pre-filter H, from the embodiment of the present invention.

FIG. 103 depicts a front perspective view of FIG. 1 optional box bottom mesh media pre-filter carbon I, from the embodiment of the present invention.

FIG. 104 depicts a front assembly perspective view of FIG. 1 optional box bottom mesh media pre-filter carbon I, mounted in place in front of FIG. 1 box bottom dual head w/venturi system pump G, FIG. 1 box bottom biotower generator drip tray pipe BC (removable), and atop FIG. 1 optional box bottom sponge media pre-filter H, from the embodiment of the present invention.

FIG. 105 depicts a front plan view of FIG. 1 optional box bottom mesh media pre-filter carbon I, from the embodiment of the present invention.

FIG. 106 depicts a back plan view of FIG. 1 optional box bottom mesh media pre-filter carbon I, from the embodiment of the present invention.

FIG. 107 depicts a left side plan view of FIG. 1 optional box bottom mesh media pre-filter carbon I, from the embodiment of the present invention.

FIG. 108 depicts a right side plan view of FIG. 1 optional box bottom mesh media pre-filter carbon I, from the embodiment of the present invention.

FIG. 109 depicts a top plan view of FIG. 1 optional box bottom mesh media pre-filter carbon I, from the embodiment of the present invention.

FIG. 110 depicts a bottom plan view of FIG. 1 optional box bottom mesh media pre-filter carbon I, from the embodiment of the present invention.

FIG. 111 depicts a top plan view of FIG. 1 optional box bottom mesh media pre-filter carbon I, with the location of (Section N-N), from the embodiment of the present invention shown.

FIG. 112 depicts a (Section N-N view), of FIG. 1 optional box bottom mesh media pre-filter carbon I, from the embodiment of the present invention.

FIG. 113 depicts a front perspective view of FIG. 1 optional box bottom skim only bypass port plug J, shown below FIG. 1 box bottom enclosure housing A, from the embodiment of the present invention.

FIG. 114 depicts a back bottom perspective view of FIG. 1 box bottom enclosure housing A, shown without FIG. 1 optional box bottom skim only bypass port plug J, in place, from the embodiment of the present invention.

FIG. 115 depicts a back bottom perspective view of FIG. 1 box bottom enclosure housing A, shown with FIG. 1 optional box bottom skim only bypass port plug J, in place, from the embodiment of the present invention.

FIG. 116 depicts a top plan view of FIG. 1 optional box bottom skim only bypass port plug J, with the location of (Section O-O), from the embodiment of the present invention shown.

FIG. 117 depicts a bottom plan view of FIG. 1 optional box bottom skim only bypass port plug J, from the embodiment of the present invention.

FIG. 118 depicts a side plan view of FIG. 1 optional box bottom skim only bypass port plug J, from the embodiment of the present invention.

FIG. 119 depicts a right side view of (Section O-O), of FIG. 1 optional box bottom skim only bypass port plug J, from the embodiment of the present invention.

FIG. 120 depicts a front perspective view of FIG. 1 optional box bottom deep pull down pipe K1, with FIG. 1 optional box bottom deep pull down pipe extension K2, and K3 being typical, from the embodiment of the present invention.

FIG. 121 depicts a front plan view of FIG. 1 optional box bottom deep pull down pipe K1, with FIG. 1 optional box bottom deep pull down pipe extension K2, and K3 being typical, from the embodiment of the present invention.

FIG. 122 depicts a top plan view of FIG. 1 optional box bottom deep pull down pipe K1, with FIG. 1 optional box bottom deep pull down pipe extension K2, and K3 being typical, and with the location of (Section P-P), from the embodiment of the present invention shown.

FIG. 123 depicts a (Section P-P view), of FIG. 1 optional box bottom deep pull down pipe K1, with FIG. 1 optional box bottom deep pull down pipe extension K2, and K3 being typical, from the embodiment of the present invention.

FIG. 124 depicts a front perspective view of FIG. 1 optional box bottom deep pull down pipe K1, with FIG. optional box bottom deep pull down pipe extension K2, and K3 being typical, from the embodiment of the present invention.

FIG. 125 depicts a front plan view of FIG. 1 optional box bottom deep pull down pipe K1, with FIG. 1 optional box bottom deep pull down pipe extension K2, and K3 being typical, from the embodiment of the present invention.

FIG. 126 depicts a top plan view of FIG. 1 optional box bottom deep pull down pipe K1, with FIG. 1 optional box bottom deep pull down pipe extension K2, and K3 being typical, with the location of (Section Q-Q), from the embodiment of the present invention shown.

FIG. 127 depicts a (Section Q-Qview), of FIG. 1 optional box bottom deep pull down pipe K1, with FIG. 1 optional box bottom deep pull down pipe extension K2, and K3 being typical, from the embodiment of the present invention.

FIG. 128 depicts a front perspective view of FIG. 1 optional box bottom deep pull down pipe strainer L, from the embodiment of the present invention.

FIG. 129 depicts a front plan view of FIG. 1 optional box bottom deep pull down pipe strainer L, from the embodiment of the present invention.

FIG. 130 depicts a top plan view of FIG. 1 optional box bottom deep pull down pipe strainer L, and with the location of (Section R-R), from the embodiment of the present invention shown.

FIG. 131 depicts a (Section R-R view), of FIG. 1 optional box bottom deep pull down pipe strainer L, from the embodiment of the present invention.

FIG. 132 depicts a front perspective view of FIG. 1 optional box bottom deep pull down pipe strainer L, mounted to FIG. 1 optional box bottom deep pull down pipe K1, with FIG. 1 optional box bottom deep pull down pipe extension K2, and K3 being typical, from the embodiment of the present invention.

FIG. 133 depicts a front plan view of FIG. 1 optional box bottom deep pull down pipe strainer L, mounted to FIG. 1 optional box bottom deep pull down pipe K1, with FIG. 1 optional box bottom deep pull down pipe extension K2, and K3 being typical, from the embodiment of the present invention.

FIG. 134 depicts a top plan view of FIG. 1 optional box bottom deep pull down pipe strainer L, mounted to FIG. 1 optional box bottom deep pull down pipe K1, with FIG. 1 optional box bottom deep pull down pipe extension K2, and K3 being typical, and the location of (Section S-S) from the embodiment of the present invention shown.

FIG. 135 depicts a (Section S-S view) of FIG. 1 optional box bottom deep pull down pipe strainer L, mounted to FIG. 1 optional box bottom deep pull down pipe K1, with FIG. 1 optional box bottom deep pull down pipe extension K2, and K3 being typical, from the embodiment of the present invention shown.

FIG. 136 depicts a front perspective view of FIG. 1 optional box bottom deep pull down pipe strainer pre-filter M, from the embodiment of the present invention.

FIG. 137 depicts a front plan view of FIG. 1 optional box bottom deep pull down pipe strainer pre-filter M, from the embodiment of the present invention.

FIG. 138 depicts a top plan view of FIG. 1 optional box bottom deep pull down pipe strainer pre-filter M, and with the location of (Section T-T), from the embodiment of the present invention shown.

FIG. 139 depicts a (Section T-T view), of FIG. 1 optional box bottom deep pull down pipe strainer pre-filter M, from the embodiment of the present invention.

FIG. 140 depicts a front perspective view of FIG. 1 optional box bottom deep pull down pipe strainer pre-filter M, mounted to FIG. 1 optional box bottom deep pull down pipe K1, with FIG. 1 optional box bottom deep pull down pipe extension K2, and K3 being typical, and FIG. 1 optional box bottom deep pull down pipe strainer L, from the embodiment of the present invention.

FIG. 141 depicts a front plan view of FIG. 1 optional box bottom deep pull down pipe strainer pre-filter M, mounted to FIG. 1 optional box bottom deep pull down pipe K1, with FIG. 1 optional box bottom deep pull down pipe extension K2, and K3 being typical, and FIG. 1 optional box bottom deep pull down pipe strainer L, from the embodiment of the present invention.

FIG. 142 depicts a top plan view of FIG. 1 optional box bottom deep pull down pipe strainer pre-filter M, mounted to FIG. 1 optional box bottom deep pull down pipe K1, with FIG. 1 optional box bottom deep pull down pipe extension K2, and K3 being typical, and FIG. 1 optional box bottom deep pull down pipe strainer L, with the location of (Section U-U), from the embodiment of the present invention shown.

FIG. 143 depicts a (Section U-U view), of FIG. 1 optional box bottom deep pull down pipe strainer pre-filter M, mounted to FIG. 1 optional box bottom deep pull down pipe K1, with FIG. 1 optional box bottom deep pull down pipe extension K2, and K3 being typical, and FIG. 1 optional box bottom deep pull down pipe strainer L, from the embodiment of the present invention shown.

FIG. 144 depicts a front perspective view of FIG. 1 box bottom enclosure housing A, from the embodiment of the present invention.

FIG. 145 depicts a back bottom perspective view of FIG. 1 optional box bottom deep pull down pipe K1, with FIG. 1 optional box bottom deep pull down pipe extension K2, and K3 being typical, and FIG. 1 optional box bottom deep pull down pipe strainer L, mounted in position on FIG. 1 box bottom enclosure housing A, from the embodiment of the present invention.

FIG. 146, 147, 148, 149 depict a front perspective view of various optional box bottom deep pull down pipe K1, with FIG. 1 optional box bottom deep pull down pipe extension K2, and K3 being typical, and FIG. 1 optional box bottom deep pull down pipe strainer L and FIG. 1 box optional box bottom deep pull down pipe strainer pre-filter M, configurations from the embodiment of the present invention.

FIG. 150 depicts a front perspective view of FIG. 1 optional box bottom deep pull down pipe K1, with FIG. 1 optional box bottom deep pull down pipe extension K2, and K3 being typical, and FIG. 1 optional box bottom deep pull down pipe strainer L, mounted in position on FIG. 1 box bottom dual head with venturi system pump G, from the embodiment of the present invention.

FIG. 151 depicts a front perspective view of FIG. 1 optional box bottom deep pull down pipe K1, with FIG. optional box bottom deep pull down pipe extension K2, and K3 being typical, and FIG. 1 optional box bottom deep pull down pipe strainer L, mounted in position on FIG. 1 box bottom box bottom dual head with venturi system pump G, and mounted in position through FIG. 1 box bottom enclosure housing A, from the embodiment of the present invention.

FIG. 152 depicts a front perspective view of FIG. 1 optional box bottom deep pull down pipe K1, with FIG. optional box bottom deep pull down pipe extension K2, and K3 being typical, and FIG. 1 optional box bottom deep pull down pipe strainer L, mounted in position on FIG. 1 box bottom box bottom dual head with venturi system pump G, and mounted in position through FIG. 1 box bottom enclosure housing A, and with FIG. 1 box bottom elevation stand w/c.o.d. diffuser C, in position, and FIG. 1 optional box bottom deep pull down pipe strainer pre-filter M, shown in relevance, from the embodiment of the present invention.

FIG. 153 depicts a bottom back perspective view of FIG. 1 optional box bottom deep pull down pipe K1, with FIG. 1 optional box bottom deep pull down pipe extension K2, and K3 being typical, and FIG. 1 optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, from the embodiment of the present invention.

FIG. 154 depicts a front perspective view of FIG. 1 optional box bottom short pull vacation down pipe N, from the embodiment of the present invention.

FIG. 155 depicts a front plan view of FIG. 1 optional box bottom short pull vacation down pipe N, from the embodiment of the present invention.

FIG. 156 depicts a top plan view of FIG. 1 optional box bottom short pull vacation down pipe N, with the location of (Section V-V), from the embodiment of the present invention shown.

FIG. 157 depicts a (Section V-V view), of FIG. 1 optional box bottom short pull vacation down pipe N, from the embodiment of the present invention shown.

FIG. 158 depicts a front perspective view of FIG. 1 optional box bottom short pull vacation down pipe skimbob O, from the embodiment of the present invention.

FIG. 159 depicts a front plan view of FIG. 1 optional box bottom short pull vacation down pipe skimbob O, from the embodiment of the present invention.

FIG. 160 depicts a top plan view of FIG. 1 optional box bottom short pull vacation down pipe skimbob O, with the location of (Section W-W), from the embodiment of the present invention shown.

FIG. 161 depicts a (Section W-W view), of FIG. 1 optional box bottom short pull vacation down pipe skimbob O, from the embodiment of the present invention shown.

FIG. 162 depicts a bottom back perspective view of FIG. 1 box bottom enclosure housing A, from the embodiment of the present invention.

FIG. 163 depicts a front perspective view of the optional box bottom short pull vacation down pipe skimbob assembly, and which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, from the embodiment of the present invention.

FIG. 164 depicts a bottom back perspective assembly view of FIG. 1 optional box bottom short pull vacation down pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and mounted in position through FIG. 1 box bottom enclosure housing A, from the embodiment of the present invention.

FIG. 165 depicts a front perspective assembly view of FIG. 1 optional box bottom short pull vacation down pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, from the embodiment of the present invention.

FIG. 166 depicts a front perspective assembly view of FIG. 1 optional box bottom short pull vacation down pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and mounted in position on FIG. 1 box bottom dual head with venturi system pump G, and mounted in position through FIG. 1 box bottom enclosure housing A, from the embodiment of the present invention.

FIG. 167 depicts a front perspective assembly view of FIG. 1 optional box bottom short pull vacation down pipe skimbob assembly, which consists of FIG. 1 optional box bottom short pull vacation down pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, from the embodiment of the present invention.

FIG. 168 depicts a front perspective assembly view of FIG. 1 optional box bottom short pull vacation down pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, from the embodiment of the present invention.

FIG. 169 depicts a front perspective assembly view of FIG. 1 optional box bottom short pull vacation down pipe N, and optional box bottom short pull vacation down pipe skimbob O, and optional box bottom deep pull down pipe strainer L, and FIG. 1 optional box bottom deep pull down pipe strainer pre-filter M, from the embodiment of the present invention.

FIG. 170 depicts a back bottom perspective assembly view of FIG. 1 bottom pull flow down extension vac pipe skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, from the embodiment of the present invention.

FIG. 171 depicts a front plan view of FIG. 1 optional box bottom short pull vacation down pipe/skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, from the embodiment of the present invention.

FIG. 172 depicts a front plan view of FIG. 1 optional box bottom short pull vacation down pipe/skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, and FIG. 1 optional box bottom elevation stand light D in position, from the embodiment of the present invention.

FIG. 173 depicts a front plan view of FIG. 1 optional box bottom short pull vacation down pipe/skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, and FIG. 1 optional box bottom elevation stand light D, and FIG. 1 optional box bottom elevation stand regular E in position, from the embodiment of the present invention.

FIG. 174 depicts a front plan view of quantity (4), of FIG. 1 bottom pull flow down pipe extensions K1, and FIG. 1 optional box bottom short pull vacation down pipe/skimbob assembly, which consists of FIG. 1 optional box bottom short pull vacation down pipe N, and optional box top bioskimmer/skimbob air injection tubing P2, and optional box bottom short pull vacation down pipe skimbob O, and optional box bottom deep pull down pipe strainer L, and FIG. 1 optional box bottom deep pull down pipe strainer pre-filter M, mounted in position on FIG. 1 box bottom dual head with venturi system pump G, and mounted in position through FIG. 1 box bottom enclosure housing A, and with FIG. 1 box bottom elevation stand w/c.o.d. diffuser C, in position, and FIG. 1 optional box bottom elevation stand light D, atop FIG. 1 optional box bottom elevation stand regular E, and quantity (2), of FIG. 1 optional box bottom elevation stand tall F1, and F2 in position, from the embodiment of the present invention.

FIG. 175 depicts front perspective view of FIG. 1 box bottom high flow cyclonic bioskimmer evaporative foam protein generator body Q, from the embodiment of the present invention.

FIG. 176 depicts front plan view of FIG. 1 box bottom high flow cyclonic bioskimmer evaporative foam protein generator body Q, from the embodiment of the present invention.

FIG. 177 depicts left side plan view of FIG. 1 box bottom high flow cyclonic bioskimmer evaporative foam protein generator body Q, from the embodiment of the present invention.

FIG. 178 depicts back plan view of FIG. 1 box bottom high flow cyclonic bioskimmer evaporative foam protein generator body Q, from the embodiment of the present invention.

FIG. 179 depicts right side plan view of FIG. 1 box bottom high flow cyclonic bioskimmer evaporative foam protein generator body Q, from the embodiment of the present invention.

FIG. 180 depicts top plan view of FIG. 1 box bottom high flow cyclonic bioskimmer evaporative foam protein generator body Q, from the embodiment of the present invention.

FIG. 181 depicts bottom plan view of FIG. 1 box bottom high flow cyclonic bioskimmer evaporative foam protein generator body Q, from the embodiment of the present invention.

FIG. 182 depicts front perspective view of FIG. 1 box bottom high flow cyclonic bioskimmer evaporative foam protein generator body Q, from the embodiment of the present invention.

FIG. 183 depicts a top plan view of FIG. 1 box bottom high flow cyclonic bioskimmer evaporative foam protein generator body Q, with the location of (Section X-X), from the embodiment of the present invention shown.

FIG. 184 depicts a (Section X-X view), of FIG. 1 box bottom high flow cyclonic bioskimmer evaporative foam protein generator body Q, from the embodiment of the present invention shown.

FIG. 185 depicts a front plan view of FIG. 1 box bottom high flow cyclonic bioskimmer evaporative foam protein generator body Q, with the location of (Section Y-Y), from the embodiment of the present invention shown.

FIG. 186 depicts a (Section Y-Y view), of FIG. 1 box bottom high flow cyclonic bioskimmer evaporative foam protein generator body Q, from the embodiment of the present invention shown.

FIG. 187 depicts a front plan view of FIG. 1 box bottom high flow cyclonic bioskimmer evaporative foam protein generator body Q, with the location of (Section Z-Z), from the embodiment of the present invention shown.

FIG. 188 depicts a (Section Z-Z view), of FIG. 1 box bottom high flow cyclonic bioskimmer evaporative foam protein generator body Q, from the embodiment of the present invention shown.

FIG. 189 depicts front perspective view of FIG. 1 box bottom high flow cyclonic bioskimmer evaporative foam protein generator body Q, from the embodiment of the present invention.

FIG. 190 depicts a front perspective view of FIG. 1 box bottom high flow cyclonic bioskimmer evaporative foam protein generator body Q, mounted in position on FIG. 1 box bottom dual head with venturi system pump G, and mounted in position in FIG. 1 box bottom enclosure housing A, and with FIG. 1 box bottom elevation stand w/c.o.d. diffuser C shown, from the embodiment of the present invention.

FIG. 191 depicts a top plan view of FIG. 1 box bottom high flow cyclonic bioskimmer evaporative foam protein generator body Q, mounted in position on FIG. 1 box bottom dual head with venturi system pump G, and mounted in position in FIG. 1 box bottom enclosure housing A, from the embodiment of the present invention.

FIG. 192 depicts a front plan view of FIG. 1 box bottom high flow cyclonic bioskimmer evaporative foam protein generator body Q, mounted in position on FIG. 1 box bottom dual head with venturi system pump G, from the embodiment of the present invention.

FIG. 193 depicts a top plan view of FIG. 1 box bottom high flow cyclonic bioskimmer evaporative foam protein generator body Q, mounted in position on FIG. 1 box bottom dual head with venturi system pump G, from the embodiment of the present invention.

FIG. 194 depicts a bottom plan view of FIG. 1 box bottom high flow cyclonic bioskimmer evaporative foam protein generator body Q, mounted in position on FIG. 1 box bottom dual head with venturi system pump G, from the embodiment of the present invention.

FIG. 195 depicts front perspective view of FIG. 1 box bottom high flow cyclonic bioskimmer evaporative foam protein generator body Q, mounted in position on FIG. 1 box bottom dual head with venturi system pump G, and FIG. 1 box bottom deep pull extension pipe K1, and FIG. 1 box bottom deep pull extension pipe strainer L, from the embodiment of the present invention.

FIG. 196 depicts front perspective view of FIG. 1 cyclonic bioskimmer easy clean evaporative foam collection cup R, from the embodiment of the present invention.

FIG. 197 depicts front plan view of FIG. 1 cyclonic bioskimmer easy clean evaporative foam collection cup R, from the embodiment of the present invention.

FIG. 198 depicts top plan view of FIG. 1 cyclonic bioskimmer easy clean evaporative foam collection cup R, from the embodiment of the present invention.

FIG. 199 depicts bottom plan view of FIG. 1 cyclonic bioskimmer easy clean evaporative foam collection cup R, from the embodiment of the present invention.

FIG. 200 depicts a top plan view of FIG. 1 cyclonic bioskimmer easy clean evaporative foam collection cup R, with the location of (Section AA-AA), from the embodiment of the present invention shown.

FIG. 201 depicts a (Section AA-AA view), of FIG. 1 cyclonic bioskimmer easy clean evaporative foam collection cup R, from the embodiment of the present invention shown.

FIG. 202 depicts a front perspective view, of FIG. 1 box bottom high flow cyclonic bioskimmer evaporative foam protein generator body Q, from the embodiment of the present invention shown.

FIG. 203 depicts a front plan view of FIG. 1 box bottom high flow cyclonic bioskimmer evaporative foam protein generator body Q, and FIG. 1 cyclonic bioskimmer easy clean evaporative foam collection cup R, with the location of (Section AB-AB), from the embodiment of the present invention shown.

FIG. 204 depicts a (Section AB-AB view), of FIG. 1 box bottom high flow cyclonic bioskimmer evaporative foam protein generator body Q, and FIG. 1 cyclonic bioskimmer easy clean evaporative foam collection cup R, from the embodiment of the present invention shown.

FIG. 205 depicts front perspective view of FIG. 1 cyclonic bioskimmer foam catch cup high flow conners bridge S, from the embodiment of the present invention.

FIG. 206 depicts front plan view of FIG. 1 cyclonic bioskimmer foam catch cup high flow conners bridge S, from the embodiment of the present invention.

FIG. 207 depicts top plan view of FIG. 1 cyclonic bioskimmer foam catch cup high flow conners bridge S, from the embodiment of the present invention.

FIG. 208 depicts left side plan view of FIG. 1 cyclonic bioskimmer foam catch cup high flow conners bridge S, from the embodiment of the present invention.

FIG. 209 depicts bottom plan view of FIG. 1 cyclonic bioskimmer foam catch cup high flow conners bridge S, from the embodiment of the present invention.

FIG. 210 depicts a top plan view of FIG. 1 cyclonic bioskimmer foam catch cup high flow conners bridge S, with the location of (Section AC-AC), from the embodiment of the present invention shown.

FIG. 211 depicts a (Section AC-AC) view, of FIG. 1 cyclonic bioskimmer foam catch cup high flow conners bridge S, from the embodiment of the present invention shown.

FIG. 212 depicts a front perspective view of FIG. 1 box bottom high flow cyclonic bioskimmer evaporative foam protein generator body Q, and FIG. 1 cyclonic bioskimmer easy clean evaporative foam collection cup R, from the embodiment of the present invention.

FIG. 213 depicts a top plan view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, with the location of (Section AD-AD), from the embodiment of the present invention shown.

FIG. 214 depicts a (Section AD-AD view), of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, from the embodiment of the present invention shown.

FIG. 215 depicts front perspective view of FIG. 1 cyclonic bioskimmer foam collection cup lid float level indicator T, and FIG. 1 cyclonic bioskimmer foam collection cup lid float level indicator ball V, from the embodiment of the present invention.

FIG. 216 depicts front plan view of FIG. 1 cyclonic bioskimmer foam collection cup lid float level indicator T, from the embodiment of the present invention.

FIG. 217 depicts a top plan view of FIG. 1 cyclonic bioskimmer foam collection cup lid float level indicator T, with the location of (Section AE-AE), from the embodiment of the present invention shown.

FIG. 218 depicts a (Section AE-AE view), of FIG. 1 cyclonic bioskimmer foam collection cup lid float level indicator T, from the embodiment of the present invention shown.

FIG. 219 depicts bottom plan view of FIG. 1 cyclonic bioskimmer foam collection cup lid float level indicator T, from the embodiment of the present invention.

FIG. 220 depicts a top plan view of FIG. 1 cyclonic bioskimmer foam collection cup lid float level indicator ball V, with the location of (Section AF-AF), from the embodiment of the present invention shown.

FIG. 221 depicts a (Section AF-AF vie), of FIG. 1 cyclonic bioskimmer foam collection cup lid float level indicator ball V, from the embodiment of the present invention shown.

FIG. 222 depicts a front perspective view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, from the embodiment of the present invention.

FIG. 223 depicts a front perspective view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, from the embodiment of the present invention.

FIG. 224 depicts a top plan view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, with the location of (Section AG-AG), from the embodiment of the present invention shown.

FIG. 225 depicts a (Section AG-AG view), of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, from the embodiment of the present invention shown.

FIG. 226 depicts front perspective view of FIG. 1 cyclonic bioskimmer easy clean evaporative foam collection cup lid U, and FIG. 1 cyclonic bioskimmer foam collection cup lid float level indicator ball V, from the embodiment of the present invention.

FIG. 227 depicts front plan view of FIG. 1 cyclonic bioskimmer easy clean evaporative foam collection cup lid U, from the embodiment of the present invention.

FIG. 228 depicts a top plan view of FIG. 1 cyclonic bioskimmer easy clean evaporative foam collection cup lid U, with the location of (Section AH-AH), from the embodiment of the present invention shown.

FIG. 229 depicts bottom plan view of FIG. 1 cyclonic bioskimmer easy clean evaporative foam collection cup lid U, from the embodiment of the present invention.

FIG. 230 depicts a (Section AH-AH view), of FIG. 1 cyclonic bioskimmer easy clean evaporative foam collection cup lid U, from the embodiment of the present invention shown.

FIG. 231 depicts a front perspective view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 cyclonic bioskimmer foam collection cup lid float level indicator T, from the embodiment of the present invention.

FIG. 232 depicts a front perspective view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, from the embodiment of the present invention.

FIG. 233 depicts a top plan view of FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, with the location of (Section AI-AI), from the embodiment of the present invention shown.

FIG. 234 depicts a (Section AI-AI view), of FIG. 1 cyclonic bioskimmer foam catch cup high flow conners bridge S, and FIG. 1 cyclonic bioskimmer foam collection cup lid float level indicator T, and FIG. 1 cyclonic bioskimmer foam collection cup lid float level indicator ball V, from the embodiment of the present invention shown.

FIG. 235 depicts front perspective view of FIG. 1 box top high flow cyclonic bioskimmer/skimbob/tidal air control valve AK, from the embodiment of the present invention.

FIG. 236 depicts front perspective view of FIG. 1 box bottom high flow cyclonic bioskimmer/skimbob/tidal air control valve tubing P1, from the embodiment of the present invention.

FIG. 237 depicts a front plan view of FIG. 1 box top high flow cyclonic bioskimmer/skimbob/tidal air control valve AK, from the embodiment of the present invention shown.

FIG. 238 depicts a top plan view of FIG. 1 box top high flow cyclonic bioskimmer/skimbob/tidal air control valve AK, with the location of (Section AJ-AJ), from the embodiment of the present invention shown.

FIG. 239 depicts left side plan view of FIG. 1 box top high flow cyclonic bioskimmer/skimbob/tidal air control valve AK, from the embodiment of the present invention.

FIG. 240 depicts bottom plan view of FIG. 1 box top high flow cyclonic bioskimmer/skimbob/tidal air control valve AK, from the embodiment of the present invention.

FIG. 241 depicts a (Section AJ-AJ view), of FIG. 1 box top high flow cyclonic bioskimmer/skimbob/tidal air control valve AK, from the embodiment of the present invention shown.

FIG. 242 depicts a front perspective view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer foam catch cup high flow conners bridge S, and FIG. 1 box bottom high flow cyclonic bioskimmer/skimbob/tidal air control valve tubing P1, from the embodiment of the present invention.

FIG. 243 depicts a front perspective view of FIG. 1 cyclonic bioskimmer easy clean evaporative foam collection cup lid U, and FIG. 1 cyclonic bioskimmer foam collection cup lid float level indicator T, and FIG. 1 cyclonic bioskimmer foam collection cup lid float level indicator ball V, and FIG. 1 box top high flow cyclonic bioskimmer/skimbob/tidal air control valve AK, from the embodiment of the present invention.

FIG. 244 depicts a front plan view of FIG. 1 box bottom dual head with venturi system pump G, and FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer easy clean evaporative foam collection cup lid U, and FIG. 1 cyclonic bioskimmer foam collection cup lid float level indicator ball V, and FIG. 1 box top high flow cyclonic bioskimmer/skimbob/tidal air control valve AK, and FIG. 1 box bottom high flow cyclonic bioskimmer/skimbob/tidal air control valve tubing P1, from the embodiment of the present invention shown.

FIG. 245 depicts a top plan view of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer easy clean evaporative foam collection cup lid U, and FIG. 1 cyclonic bioskimmer foam collection cup lid float level indicator ball V, and FIG. 1 box top high flow cyclonic bioskimmer/skimbob/tidal air control valve AK, and FIG. 1 box bottom high flow cyclonic bioskimmer/skimbob/tidal air control valve tubing P1, with the location of (Section AK-AK), from the embodiment of the present invention shown.

FIG. 246 depicts a (Section AK-AK view), of FIG. 1 box bottom high flow cyclonic bioskimmer evaporative foam protein generator body Q, and FIG. 1 cyclonic bioskimmer easy clean evaporative foam collection cup R, and FIG. 1 cyclonic bioskimmer easy clean evaporative foam collection cup lid U, and FIG. 1 cyclonic bioskimmer foam collection cup lid float level indicator ball V, and FIG. 1 box top high flow cyclonic bioskimmer/skimbob/tidal air control valve AK, and FIG. 1 box bottom high flow cyclonic bioskimmer/skimbob/tidal air control valve tubing P1, from the embodiment of the present invention.

FIG. 247 depicts a front perspective view of FIG. 1 single position flow control manifold W1, and FIG. 1 flow control manifold nozzle AA1, from the embodiment of the present invention.

FIG. 248 depicts front plan view of FIG. 1 single position flow control manifold W1, from the embodiment of the present invention.

FIG. 249 depicts a top plan view of FIG. 1 single position flow control manifold W1, with the location of (Section AL-AL), from the embodiment of the present invention shown.

FIG. 250 depicts a (Section AL-AL view), of FIG. 1 single position flow control manifold W1, from the embodiment of the present invention shown.

FIG. 251 depicts bottom plan view of FIG. 1 single position flow control manifold W1, from the embodiment of the present invention.

FIG. 252 depicts a top plan view of FIG. 1 single position flow control manifold nozzle AA1, from the embodiment of the present invention.

FIG. 253 depicts a bottom plan view of FIG. 1 single position flow control manifold nozzle AA1, from the embodiment of the present invention.

FIG. 254 depicts a left side plan view of FIG. 1 single position flow control manifold nozzle AA1, from the embodiment of the present invention.

FIG. 255 depicts a right side plan view of FIG. 1 single position flow control manifold nozzle AA1, from the embodiment of the present invention.

FIG. 256 depicts a top plan view of FIG. 1 single position flow control manifold W1, and FIG. 1 single position flow control manifold nozzle AA1, with the location of (Section AM-AM), from the embodiment of the present invention shown.

FIG. 257 depicts a (Section AM-AM view), of FIG. 1 single position flow control manifold W1, and FIG. 1 single position flow control manifold nozzle AA1, from the embodiment of the present invention shown.

FIG. 258 depicts a front perspective view of FIG. 1 single position flow control manifold W1, and FIG. 1 flow control manifold nozzle AA1, mounted in position on FIG. 1 box bottom enclosure housing A, from the embodiment of the present invention.

FIG. 259 depicts a front perspective view of FIG. 1 two position flow control manifold X, and FIG. 1 flow control manifold nozzles AA1, AA2, from the embodiment of the present invention.

FIG. 260 depicts front plan view of FIG. 1 two position flow control manifold X, from the embodiment of the present invention.

FIG. 261 depicts a top plan view of FIG. 1 two position flow control manifold X, from the embodiment of the present invention shown.

FIG. 262 depicts a left side plan view, of FIG. 1 two position flow control manifold X, from the embodiment of the present invention shown.

FIG. 263 depicts bottom plan view of FIG. 1 two position flow control manifold X, from the embodiment of the present invention.

FIG. 264 depicts a front plan view of FIG. 1 two position flow control manifold X, and FIG. 1 flow control manifold nozzles AA1, AA2, with the location of (Section AN-AN), from the embodiment of the present invention shown.

FIG. 265 depicts a (Section AN-AN view), of FIG. 1 two position flow control manifold X, and FIG. 1 flow control manifold nozzles AA1, AA2, from the embodiment of the present invention shown.

FIG. 266 depicts a front perspective view of FIG. 1 two position flow control manifold X, and FIG. 1 flow control manifold nozzles AA1, AA2, mounted in position on FIG. 1 box bottom enclosure housing A, from the embodiment of the present invention.

FIG. 267 depicts a front perspective view of FIG. 1 two-Y position flow control manifold Y, and FIG. 1 flow control manifold nozzles AA1, AA2, from the embodiment of the present invention.

FIG. 268 depicts front plan view of FIG. 1 two-Y position flow control manifold Y, from the embodiment of the present invention.

FIG. 269 depicts a top plan view of FIG. 1 two-Y position flow control manifold X, from the embodiment of the present invention shown.

FIG. 270 depicts a left side plan view, of FIG. 1 two-Y position flow control manifold Y, from the embodiment of the present invention shown.

FIG. 271 depicts bottom plan view of FIG. 1 two-Y position flow control manifold Y, from the embodiment of the present invention.

FIG. 272 depicts a front plan view of FIG. 1 two-Y position flow control manifold Y, and FIG. 1 flow control manifold nozzles AA1, AA2, with the location of (Section AO-AO), from the embodiment of the present invention shown.

FIG. 273 depicts a (Section AO-AO view), of FIG. 1 two-Y position flow control manifold Y, and FIG. 1 flow control manifold nozzles AA1, AA2, from the embodiment of the present invention shown.

FIG. 274 depicts a front perspective view of FIG. 1 two-Y position flow control manifold Y, and FIG. 1 flow control manifold nozzles AA1, AA2, mounted in position on FIG. 1 box bottom enclosure housing A, from the embodiment of the present invention.

FIG. 275 depicts a front perspective view of FIG. 1 four position flow control manifold Z, and FIG. 1 flow control manifold nozzles AA1, AA2, AA3, AA4, from the embodiment of the present invention.

FIG. 276 depicts front plan view of FIG. 1 four position flow control manifold Z, from the embodiment of the present invention.

FIG. 277 depicts a top plan view of FIG. 1 four position flow control manifold Z, from the embodiment of the present invention shown.

FIG. 278 depicts a left side plan view, of FIG. 1 four position flow control manifold Z, from the embodiment of the present invention shown.

FIG. 279 depicts a front plan view of FIG. 1 four position flow control manifold Z, and FIG. 1 flow control manifold nozzles AA1, AA2, AA3, AA4, with the location of (Section AP-AP), from the embodiment of the present invention shown.

FIG. 280 depicts a (Section AP-AP view), of FIG. 1 four position flow control manifold Z, and FIG. 1 flow control manifold nozzles AA1, AA2, AA3, AA4, from the embodiment of the present invention shown.

FIG. 281 depicts a front perspective view of FIG. 1 four position flow control manifold Z, and FIG. 1 flow control manifold nozzles AA1, AA2, AA3, AA4, mounted in position on FIG. 1 box bottom enclosure housing A, from the embodiment of the present invention.

FIG. 282 depicts a front perspective view of FIG. 1 flow control manifold 45 degree extension AB, and FIG. single position flow control manifold W2, from the embodiment of the present invention.

FIG. 283 depicts front plan view of FIG. 1 flow control manifold 45 degree extension AB, from the embodiment of the present invention.

FIG. 284 depicts a top plan view of FIG. 1 flow control manifold 45 degree extension AB, from the embodiment of the present invention shown.

FIG. 285 depicts a left side plan view, of FIG. 1 flow control manifold 45 degree extension AB, from the embodiment of the present invention shown.

FIG. 286 depicts a bottom plan view, of FIG. 1 flow control manifold 45 degree extension AB, from the embodiment of the present invention shown.

FIG. 287 depicts a front plan view of FIG. 1 flow control manifold 45 degree extension AB, and FIG. 1 single position flow control manifold W2, with the location of (Section AQ-AQ), from the embodiment of the present invention shown.

FIG. 288 depicts a (Section AQ-AQ view), of FIG. 1 flow control manifold 45 degree extension AB, and FIG. 1 single position flow control manifold W2, from the embodiment of the present invention shown.

FIG. 289 depicts a front perspective view of FIG. 1 flow control manifold 45 degree extension AB, and FIG. single position flow control manifold W2, mounted in position on FIG. 1 box bottom enclosure housing A, from the embodiment of the present invention.

FIG. 290 depicts an exploded perspective view of a thermostatic control interface assembly, which consists of FIG. 1 thermostatic control interface housing battery AC2, and FIG. 1 thermostatic control interface housing rear housing AD, and FIG. 1 thermostatic control interface housing gasket AE, and FIG. thermostatic control interface housing diode sensor array AF, and FIG. 1 thermostatic control interface housing front cover AG, along with a front perspective view of the thermostatic control interface assembly, assembled, from the embodiment of the present invention.

FIG. 291 depicts a front perspective view of a thermostatic control interface assembly, which consists of FIG. 1 thermostatic control interface housing battery AC2, and FIG. 1 thermostatic control interface housing rear cover AD, and FIG. 1 thermostatic control interface housing gasket AE, and FIG. 1 thermostatic control interface housing diode sensor array AF, and FIG. 1 thermostatic control interface housing front cover AG, from the embodiment of the present invention.

FIG. 292 depicts a left side perspective view of a thermostatic control interface assembly, which consists of FIG. 1 thermostatic control interface housing battery AC2, and FIG. 1 thermostatic control interface housing rear cover AD, and FIG. 1 thermostatic control interface housing gasket AE, and FIG. 1 thermostatic control interface housing diode sensor array AF, and FIG. 1 thermostatic control interface housing front cover AG, from the embodiment of the present invention.

FIG. 293 depicts a back perspective view of a thermostatic control interface assembly, which consists of FIG. 1 thermostatic control interface housing battery AC2, and FIG. 1 thermostatic control interface housing rear cover AD, and FIG. 1 thermostatic control interface housing gasket AE, and FIG. 1 thermostatic control interface housing diode sensor array AF, and FIG. 1 thermostatic control interface housing front cover AG, from the embodiment of the present invention.

FIG. 294 depicts a front perspective view of FIG. 1 box top doser additive tube AH, with FIG. 1 bottom pull flow down extension pipe K2 and K3, being typical, and FIG. 1 bottom pull flow down pipe extension strainer L, mounted in position on FIG. 1 box bottom dual head with venturi system pump G, and mounted in position through FIG. 1 box bottom enclosure housing A, from the embodiment of the present invention.

FIG. 295 depicts a front perspective view of FIG. 1 box top dosing additive tube AH, and FIG. 1 box top dosing additive tube seal AI, and FIG. 1 box top dosing additive tube cap/stand AJ, from the embodiment of the present invention.

FIG. 296 depicts a front plan view of FIG. 1 box top dosing additive tube AH, from the embodiment of the present invention.

FIG. 297 depicts a top plan view of FIG. 1 box top dosing additive tube AH, from the embodiment of the present invention.

FIG. 298 depicts a bottom plan view of FIG. 1 box top dosing additive tube AH, from the embodiment of the present invention.

FIG. 299 depicts a front plan view of FIG. 1 box top dosing additive tube AH, with the location of (Section AR-AR), from the embodiment of the present invention shown.

FIG. 300 depicts a (Section AR-AR view), of FIG. 1 box top dosing additive tube AH, from the embodiment of the present invention shown.

FIG. 301 depicts a front perspective view of FIG. 1 box top dosing additive tube AH, mounted in position on FIG. 1 box bottom enclosure housing A, from the embodiment of the present invention.

FIG. 302 depicts a front perspective view of FIG. 1 box top dosing additive tube AH, and FIG. 1 box top dosing additive tube seal AI, and FIG. 1 box top dosing additive tube cap/stand AJ, shown separately, along with the doser assembly, assembled upright, and also with the doser assembly rearranged with the cap/stand depicted in the stand position, from the embodiment of the present invention.

FIG. 303 depicts front plan view of FIG. 1 box top dosing additive tube seal AI, from the embodiment of the present invention.

FIG. 304 depicts a top plan view of FIG. 1 box top dosing additive tube seal AI, from the embodiment of the present invention shown.

FIG. 305 depicts a bottom plan view, of FIG. 1 box top dosing additive tube seal AI, from the embodiment of the present invention shown.

FIG. 306 depicts a front plan view of FIG. 1 box top dosing additive tube cap/stand AJ, from the embodiment of the present invention.

FIG. 307 depicts a top plan view of FIG. 1 box top dosing additive tube cap/stand AJ, from the embodiment of the present invention.

FIG. 308 depicts a bottom plan view of FIG. 1 box top dosing additive tube cap/stand AJ, from the embodiment of the present invention.

FIG. 309 depicts a front plan view of FIG. 1 box top dosing additive tube AH, and FIG. 1 box top dosing additive tube seal AI, and FIG. 1 box top dosing additive tube cap/stand AJ, with the location of (Section AS-AS), from the embodiment of the present invention shown.

FIG. 310 depicts a (Section AS-AS view), of FIG. 1 box top dosing additive tube AH, and FIG. 1 box top dosing additive tube seal AI, and FIG. 1 box top dosing additive tube cap/stand AJ, from the embodiment of the present invention shown.

FIG. 311 depicts a front perspective view of FIG. 1 box top dosing additive tube AH, and FIG. 1 box top dosing additive tube seal AI, and FIG. 1 box top dosing additive tube cap/stand AJ, mounted in position on FIG. 1 box bottom enclosure housing A, from the embodiment of the present invention.

FIG. 312 depicts a front perspective view of an optional FIG. 2 manual soak feeder reservoir body AL, and an optional manual soak feeder assembly, which consists of FIG. 2 manual soak feeder reservoir body AL, and FIG. 2 manual soak feeder transfer paddle AM, and FIG. 2 Dual soak feeder dispenser body cap AN, from the embodiment of the present invention.

FIG. 313 depicts a front plan view of an optional FIG. 2 manual soak feeder reservoir body AL, from the embodiment of the present invention.

FIG. 314 depicts a top plan view of an optional FIG. 2 manual soak feeder reservoir body AL, from the embodiment of the present invention.

FIG. 315 depicts a left side plan view of an optional FIG. 2 manual soak feeder reservoir body AL, from the embodiment of the present invention.

FIG. 316 depicts a bottom plan view of an optional FIG. 2 manual soak feeder reservoir body AL, from the embodiment of the present invention.

FIG. 317 depicts a front plan view of FIG. 2 manual soak feeder reservoir body AL, with the location of (Section AT-AT), from the embodiment of the present invention shown.

FIG. 318 depicts a (Section AT-AT view), of FIG. 2 manual soak feeder reservoir body AL, from the embodiment of the present invention shown.

FIG. 319 depicts a front perspective view of FIG. 2 manual soak feeder reservoir body AL, mounted in position on FIG. 1 box bottom enclosure housing A, and FIG. 1 box top enclosure housing B, from the embodiment of the present invention.

FIG. 320 depicts a front perspective view of an optional FIG. 2 manual soak feeder transfer paddle AM, and an optional FIG. 2 manual soak feeder transfer paddle AM, and FIG. 2 manual soak feeder body cap AN, assembled, from the embodiment of the present invention.

FIG. 321 depicts a front plan view of an optional FIG. 2 manual soak feeder transfer paddle AM, from the embodiment of the present invention.

FIG. 322 depicts a top plan view of an optional FIG. 2 manual soak feeder transfer paddle AM, from the embodiment of the present invention.

FIG. 323 depicts a left side plan view of an optional FIG. 2 manual soak feeder body paddle AM, from the embodiment of the present invention.

FIG. 324 depicts a bottom plan view of an optional FIG. 2 manual soak feeder transfer paddle AM, from the embodiment of the present invention.

FIG. 325 depicts a front plan view of an optional FIG. 2 manual soak feeder reservoir body AL, and manual soak feeder transfer paddle AM, with the location of (Section AU-AU), from the embodiment of the present invention shown.

FIG. 326 depicts a (Section AU-AU view), of an optional FIG. 2 manual soak feeder reservoir body AL, and manual soak feeder transfer paddle AM, from the embodiment of the present invention shown.

FIG. 327 depicts a front perspective view of an optional FIG. 2 manual soak feeder reservoir body AL, and manual soak feeder transfer paddle AM, mounted in position on FIG. 1 box bottom enclosure housing A, and FIG. 1 box top enclosure housing B, from the embodiment of the present invention.

FIG. 328 depicts a front perspective view of an optional FIG. 2 Dual soak feeder dispenser body cap AN, and an optional FIG. 2 manual soak feeder reservoir body AL, and an optional FIG. 2 manual soak feeder transfer paddle AM, assembled, from the embodiment of the present invention.

FIG. 329 depicts a front plan view of an optional FIG. 2 Dual soak feeder dispenser body cap AN, from the embodiment of the present invention.

FIG. 330 depicts a top plan view of an optional FIG. 2 Dual soak feeder dispenser body cap AN, from the embodiment of the present invention.

FIG. 331 depicts a left side plan view of an optional FIG. 2 Dual soak feeder dispenser body cap AN, from the embodiment of the present invention.

FIG. 332 depicts a bottom plan view of an optional FIG. 2 Dual soak feeder dispenser body cap AN, from the embodiment of the present invention.

FIG. 333 depicts a front plan view of an optional manual soak feeder assembly which consists of FIG. 2 Dual soak feeder dispenser body cap AN, and an optional FIG. 2 manual soak feeder reservoir body AL, and manual soak feeder transfer paddle AM, with the location of (Section AV-AV), from the embodiment of the present invention shown.

FIG. 334 depicts a (Section AV-AV view), of an optional manual soak feeder assembly which consists of FIG. 2 Dual soak feeder dispenser body cap AN, and an optional FIG. 2 manual soak feeder reservoir body AL, and manual soak feeder transfer paddle AM, from the embodiment of the present invention shown.

FIG. 335 depicts a front perspective view of an optional manual soak feeder assembly which consists of FIG. 2 Dual soak feeder dispenser body cap AN, and an optional FIG. 2 manual soak feeder reservoir body AL, and manual soak feeder transfer paddle AM, mounted in position on FIG. 1 box bottom enclosure housing A, and FIG. 1 box top enclosure housing, from the embodiment of the present invention.

FIG. 336 depicts a front perspective view of an optional FIG. 3 automatic soak feeder reservoir body AO, which is part of an optional automatic soak feeder assembly which consists of an optional FIG. 3 automatic soak feeder reservoir body AO, and an optional FIG. 3 automatic soak feeder reservoir body gasket AP, and an optional FIG. 3 automatic soak feeder body motor AQ, and an optional FIG. 3 automatic soak feeder transfer paddle AR, and an optional FIG. 3 automatic soak feeder body top section AS, and an optional FIG. 2 Dual soak feeder dispenser body cap AN, and an optional FIG. 3 automatic soak feeder battery AC1, and an optional FIG. 3 automatic soak feeder body snap cap AT, assembled, from the embodiment of the present invention.

FIG. 337 depicts a front plan view of an optional FIG. 3 automatic soak feeder reservoir body AO, from the embodiment of the present invention.

FIG. 338 depicts a top plan view of an optional FIG. 3 automatic soak feeder reservoir body AO, from the embodiment of the present invention.

FIG. 339 depicts a left side plan view of an optional FIG. 3 automatic soak feeder reservoir body AO, from the embodiment of the present invention.

FIG. 340 depicts a bottom plan view of an optional FIG. 3 automatic soak feeder reservoir body AO, from the embodiment of the present invention.

FIG. 341 depicts a front plan view of an optional automatic soak feeder assembly which consists of FIG. 3 automatic soak feeder reservoir body AO, with the location of (Section AW-AW), from the embodiment of the present invention shown.

FIG. 342 depicts a (Section AW-AW view), of an optional FIG. 3 automatic soak feeder reservoir body AO, from the embodiment of the present invention shown.

FIG. 343 depicts a front perspective view of an optional FIG. 3 automatic soak feeder reservoir body AO, mounted in position on FIG. 1 box bottom enclosure housing A, and FIG. 1 box top enclosure housing B, from the embodiment of the present invention.

FIG. 344 depicts a front perspective view of an optional FIG. 3 automatic soak feeder reservoir body gasket AP, and FIG. 3 automatic soak feeder battery AC1, and FIG. 3 automatic soak feeder body motor AQ, which are part of an optional automatic soak feeder assembly which consists of an optional FIG. 3 automatic soak feeder reservoir body AO, and an optional FIG. 3 automatic soak feeder reservoir body gasket AP, and an optional FIG. 3 automatic soak feeder body motor AQ, and an optional FIG. 3 automatic soak feeder transfer paddle AR, and an optional FIG. 3 automatic soak feeder reservoir body top section AS, and an optional FIG. 2 dual soak feeder dispenser body cap AN, and an optional FIG. 3 automatic soak feeder battery AC1, and an optional FIG. 3 automatic soak feeder reservoir body snap cap AT, with FIG. 3 automatic soak feeder reservoir body AO, and automatic soak feeder battery AC1, and automatic soak feeder body motor AQ, also shown assembled, from the embodiment of the present invention.

FIG. 345 depicts a front plan view of an optional FIG. 3 automatic soak feeder reservoir body gasket AP, from the embodiment of the present invention.

FIG. 346 depicts a top plan view of an optional FIG. 3 automatic soak feeder reservoir body gasket AP, from the embodiment of the present invention.

FIG. 347 depicts a bottom plan view of an optional FIG. 3 automatic soak feeder reservoir body gasket AP, from the embodiment of the present invention.

FIG. 348 depicts a front plan view of an optional FIG. 3 automatic soak feeder reservoir body AO, and FIG. 3 automatic soak feeder reservoir body gasket AP, with the location of (Section AX-AX), from the embodiment of the present invention shown.

FIG. 349 depicts a (Section AX-AX view), of an optional FIG. 3 automatic soak feeder reservoir body AO, and FIG. 3 automatic soak feeder reservoir body gasket AP, from the embodiment of the present invention shown.

FIG. 350 depicts a front perspective view of an optional FIG. 3 automatic soak feeder reservoir body gasket AP, with FIG. 3 automatic soak feeder reservoir body AO, and automatic soak feeder battery AC1, and automatic soak feeder body motor AQ, also shown assembled mounted in position on FIG. 1 box bottom enclosure housing A, and FIG. 1 box top enclosure housing B, from the embodiment of the present invention.

FIG. 351 depicts a front perspective view of an optional FIG. 3 automatic soak feeder transfer paddle AR, and FIG. 3 dual soak feeder dispenser body cap AN, which are part of an optional automatic soak feeder assembly which consists of an optional FIG. 3 automatic soak feeder reservoir body AO, and an optional FIG. 3 automatic soak feeder reservoir body gasket AP, and an optional FIG. 3 automatic soak feeder body motor AQ, and an optional FIG. 3 automatic soak feeder transfer paddle AR, and an optional FIG. 3 automatic soak feeder reservoir body top section AS, and an optional FIG. 2 dual soak feeder dispenser body cap AN, and an optional FIG. 3 automatic soak feeder battery AC1, and an optional FIG. 3 automatic soak feeder reservoir body snap cap AT, with FIG. 3 automatic soak feeder transfer paddle AR, and FIG. 3 dual soak feeder dispenser body cap AN, also shown assembled, from the embodiment of the present invention.

FIG. 352 depicts a front plan view of an optional FIG. 3 automatic soak feeder transfer paddle AR, from the embodiment of the present invention.

FIG. 353 depicts a top plan view of an optional FIG. 3 automatic soak feeder transfer paddle AR, from the embodiment of the present invention.

FIG. 354 depicts a left side plan view of an optional FIG. 3 automatic soak feeder transfer paddle AR, from the embodiment of the present invention.

FIG. 355 depicts a bottom plan view of an optional FIG. 3 automatic soak feeder transfer paddle AR, from the embodiment of the present invention.

FIG. 356 depicts a front plan view of an optional FIG. 3 automatic soak feeder reservoir body AO, and FIG. automatic soak feeder transfer paddle AR, and FIG. 3 automatic soak feeder reservoir body gasket AP, and with the location of (Section AY-AY), from the embodiment of the present invention shown.

FIG. 357 depicts a (Section AY-AY view), of an optional FIG. 3 automatic soak feeder reservoir body AO, and FIG. 3 automatic soak feeder transfer paddle AR, and FIG. 3 automatic soak feeder reservoir body gasket AP, from the embodiment of the present invention shown.

FIG. 358 depicts a front perspective view of an optional FIG. 3 automatic soak feeder transfer paddle AR, and FIG. 3 dual soak feeder dispenser body cap AN, and FIG. 3 automatic soak feeder reservoir body gasket AP, with FIG. 3 automatic soak feeder reservoir body AO, and automatic soak feeder battery AC1, and automatic soak feeder body motor AQ, also shown assembled mounted in position on FIG. 1 box bottom enclosure housing A, and FIG. 1 box top enclosure housing B, from the embodiment of the present invention.

FIG. 359 depicts a front perspective view of an optional FIG. 3 automatic soak feeder reservoir body snap cap AT, and FIG. 3 automatic soak feeder reservoir body top section AS, which are part of an optional automatic soak feeder assembly which consists of an optional FIG. 3 automatic soak feeder reservoir body AO, and an optional FIG. 3 automatic soak feeder reservoir body gasket AP, and an optional FIG. 3 automatic soak feeder body motor AQ, and an optional FIG. 3 automatic soak feeder transfer paddle AR, and an optional FIG. 3 automatic soak feeder reservoir body top section AS, and an optional FIG. 2 dual soak feeder dispenser body cap AN, and an optional FIG. 3 automatic soak feeder battery AC1, and an optional FIG. 3 automatic soak feeder reservoir body snap cap AT, also shown assembled, from the embodiment of the present invention.

FIG. 360 depicts a front plan view of an optional FIG. 3 automatic soak feeder reservoir body top section AS, from the embodiment of the present invention.

FIG. 361 depicts a top plan view of an optional FIG. 3 automatic soak feeder reservoir body top section AS, from the embodiment of the present invention.

FIG. 362 depicts a left side plan view of an optional FIG. 3 automatic soak feeder reservoir body top section AS, from the embodiment of the present invention.

FIG. 363 depicts a bottom plan view of an optional FIG. 3 automatic soak feeder reservoir body top section AS, from the embodiment of the present invention.

FIG. 364 depicts a front plan view of an optional FIG. 3 automatic soak feeder reservoir body snap cap AT, from the embodiment of the present invention.

FIG. 365 depicts a top plan view of an optional FIG. 3 automatic soak feeder reservoir body snap cap AT, from the embodiment of the present invention.

FIG. 366 depicts a left side plan view of an optional FIG. 3 automatic soak feeder reservoir body snap cap AT, from the embodiment of the present invention.

FIG. 367 depicts a bottom plan view of an optional FIG. 3 automatic soak feeder reservoir body snap cap AT, from the embodiment of the present invention.

FIG. 368 depicts a front plan view of an optional FIG. 3 automatic soak feeder reservoir body AO, and FIG. 3 automatic soak feeder transfer paddle AR, and FIG. 3 automatic soak feeder reservoir body gasket AP, and FIG. 3 automatic soak feeder reservoir body top section AS, and FIG. 2 dual soak feeder dispenser body cap AN, and FIG. 3 automatic soak feeder reservoir body snap cap AT, with the location of (Section AZ-AZ), from the embodiment of the present invention shown.

FIG. 369 depicts a (Section AZ-AZ view), of an optional FIG. 3 automatic soak feeder reservoir body AO, and FIG. 3 automatic soak feeder transfer paddle AR, and FIG. 3 automatic soak feeder reservoir body gasket AP, and FIG. 3 automatic soak feeder reservoir body top section AS, and FIG. 2 dual soak feeder dispenser body cap AN, and FIG. 3 automatic soak feeder reservoir body snap cap AT, from the embodiment of the present invention shown.

FIG. 370 depicts a front perspective view of an optional automatic soak feeder assembly which consists of an optional FIG. 3 automatic soak feeder reservoir body AO, and an optional FIG. 3 automatic soak feeder reservoir body gasket AP, and an optional FIG. 3 automatic soak feeder body motor AQ, and an optional FIG. 3 automatic soak feeder transfer paddle AR, and an optional FIG. 3 automatic soak feeder reservoir body top section AS, and an optional FIG. 2 dual soak feeder dispenser body cap AN, and an optional FIG. 3 automatic soak feeder battery AC1, and an optional FIG. 3 automatic soak feeder reservoir body snap cap AT, also shown assembled mounted in position on FIG. 1 box bottom enclosure housing A, and FIG. 1 box top enclosure housing B, from the embodiment of the present invention.

FIG. 371 depicts a front perspective view of an optional FIG. 3 top-off and fill, sliding soak feeder tank wall clip AU, and FIG. 2 optional manual soak feeder assembly and also FIG. 3 optional automatic soak feeder, shown assembled, from the embodiment of the present invention.

FIG. 372 depicts a front plan view of an optional FIG. 3 top-off and fill, sliding soak feeder tank wall clip AU, from the embodiment of the present invention.

FIG. 373 depicts a top plan view of an optional FIG. 3 top-off and fill, sliding soak feeder tank wall clip AU, with the location of (Section BA-BA), from the embodiment of the present invention shown.

FIG. 374 depicts a left side plan view of an optional FIG. 3 top-off and fill, sliding soak feeder tank wall clip AU, from the embodiment of the present invention.

FIG. 375 depicts a bottom plan view of an optional FIG. 3 top-off and fill, sliding soak feeder tank wall clip AU, from the embodiment of the present invention.

FIG. 376 depicts a (Section BA-BA view), of an optional FIG. 3 top-off and fill, sliding soak feeder tank wall clip AU, from the embodiment of the present invention shown.

FIG. 377 depicts a back perspective view of an optional FIG. 3 top-off and fill, sliding soak feeder tank wall clip AU, with FIG. 2 optional manual soak feeder assembly and also FIG. 3 optional automatic soak feeder assembly, both shown assembled, from the embodiment of the present invention.

FIG. 378 depicts a front perspective view of an optional FIG. 1 biotower two stage, three phase, bacteria storage generators AV, AW, and AX, and also FIG. 1 biotower two stage, three phase, bacteria storage generators AV, AW, and AX, shown assembled mounted in position on FIG. 1 box bottom enclosure housing A, from the embodiment of the present invention.

FIG. 379 depicts a front plan view of an optional FIG. 1 biotower two stage, three phase, bacteria storage generators AV, AW, and AX, and with the location of (Section BB-BB), from the embodiment of the present invention shown.

FIG. 380 depicts a top plan view of an optional FIG. 1 biotower two stage, three phase, bacteria storage generators AV, AW, and AX, from the embodiment of the present invention.

FIG. 381 depicts a bottom plan view of an optional FIG. 1 biotower two stage, three phase, bacteria storage generators AV, AW, and AX, from the embodiment of the present invention.

FIG. 382 depicts a (Section BB-BB view), of an optional FIG. 1 biotower two stage, three phase, bacteria storage generator AV, with FIG. 1 biotower two stage, three phase, bacteria storage generators AW, and AX being typical, from the embodiment of the present invention shown.

FIG. 383 depicts a top plan view of FIG. 1 box bottom enclosure housing A, from the embodiment of the present invention.

FIG. 384 depicts a top plan view of FIG. 1 box bottom enclosure housing A, with optional FIG. 1 biotower two stage, three phase, bacteria storage generators AV, AW, and AX, shown mounted in place, from the embodiment of the present invention.

FIG. 385 depicts a top plan view of FIG. 1 box bottom enclosure housing A, with optional FIG. 1 box bottom biotower two stage, three phase, bacteria storage generators AV, AW, and AX, shown mounted in place under FIG. 1 box bottom bio stack generator drip tray pipe BC, from the embodiment of the present invention.

FIG. 386 depicts a front perspective view of an optional FIG. 1 box bottom bio-media storage drip tray AY, and also FIG. 1 box bottom bio-media storage drip tray AY, shown assembled mounted in position on FIG. 1 box bottom enclosure housing A, from the embodiment of the present invention.

FIG. 387 depicts a front plan view of an optional FIG. 1 box bottom bio-media storage drip tray AY, and with the location of (Section BC-BC), from the embodiment of the present invention shown.

FIG. 388 depicts a top plan view of an optional FIG. 1 box bottom bio-media storage drip tray AY, from the embodiment of the present invention.

FIG. 389 depicts a bottom plan view of an optional FIG. 1 box bottom bio-media storage drip tray AY, from the embodiment of the present invention.

FIG. 390 depicts a (Section BC-BC vie), of an optional FIG. 1 box bottom bio-media storage drip tray AY, from the embodiment of the present invention shown.

FIG. 391 depicts a top plan view of FIG. 1 box bottom enclosure housing A, from the embodiment of the present invention.

FIG. 392 depicts a top plan view of FIG. 1 box bottom enclosure housing A, with optional FIG. 1 box bottom bio-media storage drip tray AY, shown mounted in place, from the embodiment of the present invention.

FIG. 393 depicts a top plan view of FIG. 1 box bottom enclosure housing A, with optional FIG. 1 box bottom bio-media storage drip tray AY, shown mounted in place under FIG. 1 box bottom biotower generator drip tray pipe BC, from the embodiment of the present invention.

FIG. 394 depicts a front perspective view of FIG. 1 box bottom biotower generator drip tray AZ, and also FIG. 1 box bottom biotower generator drip tray AZ, shown assembled and in position atop optional FIG. 1 box bottom biotower two stage, three phase, bacteria storage generators AV, AW, and AX, and mounted in position on FIG. 1 box bottom enclosure housing A, from the embodiment of the present invention.

FIG. 395 depicts a front plan view of FIG. 1 box bottom biotower generator drip tray AZ, and with the location of (Section BD-BD), from the embodiment of the present invention shown.

FIG. 396 depicts a top plan view of FIG. 1 box bottom biotower generator drip tray AZ, from the embodiment of the present invention.

FIG. 397 depicts a bottom plan view of FIG. 1 box bottom biotower generator drip tray AZ, from the embodiment of the present invention.

FIG. 398 depicts a (Section BD-BD view), of FIG. 1 box bottom biotower generator drip tray AZ, from the embodiment of the present invention shown.

FIG. 399 depicts a top plan view of FIG. 1 box bottom enclosure housing A, from the embodiment of the present invention.

FIG. 400 depicts a top plan view of FIG. 1 box bottom enclosure housing A, with FIG. 1 box bottom biotower generator drip tray AZ, shown assembled and in position atop optional FIG. 1 box bottom biotower two stage, three phase, bacteria storage generators AV, AW, and AX, and mounted in position on FIG. 1 box bottom enclosure housing A, from the embodiment of the present invention.

FIG. 401 depicts a front elevation view of FIG. 1 box bottom enclosure housing A, with optional FIG. 1 box bottom bio-media storage drip tray AY, shown assembled and in position atop optional FIG. 1 box bottom biotower two stage, three phase, bacteria storage generators AV, AW, and AX, and mounted in position on FIG. 1 box bottom enclosure housing A, and shown mounted in place under FIG. 1 box bottom biotower generator drip tray pipe BC, from the embodiment of the present invention.

FIG. 402 depicts a front perspective view of an optional FIG. 1 box bottom biotower generator drip tray carbon media pre-filter BA, and also FIG. 1 box bottom biotower generator drip tray carbon media pre-filter BA, shown assembled and in position atop FIG. 1 box bottom bio-tower generator drip tray AZ, and optional FIG. 1 box bottom biotower two stage, three phase, bacteria storage generators AV, AW, and AX, and mounted in position on FIG. 1 box bottom enclosure housing A, from the embodiment of the present invention.

FIG. 403 depicts a front plan view of an optional FIG. 1 box bottom biotower generator drip tray carbon media pre-filter BA, and with the location of (Section BE-BE), from the embodiment of the present invention shown.

FIG. 404 depicts a top plan view of an optional FIG. 1 box bottom biotower generator drip tray carbon media pre-filter BA, from the embodiment of the present invention.

FIG. 405 depicts a bottom plan view of an optional FIG. 1 box bottom biotower generator drip tray carbon media pre-filter BA, from the embodiment of the present invention.

FIG. 406 depicts a (Section BE-BE view), of an optional FIG. 1 box bottom biotower generator drip tray carbon media pre-filter BA, from the embodiment of the present invention shown.

FIG. 407 depicts a top plan view of FIG. 1 box bottom enclosure housing A, from the embodiment of the present invention.

FIG. 408 depicts a top plan view of FIG. 1 box bottom enclosure housing A, with optional FIG. 1 box bottom biotower generator drip tray carbon media pre-filter BA, shown assembled and in position atop optional FIG. 1 box bottom bio-media storage drip tray AY, and optional FIG. 1 box bottom biotower two stage, three phase, bacteria storage generators AV, AW, and AX, and mounted in position on FIG. 1 box bottom enclosure housing A, from the embodiment of the present invention.

FIG. 409 depicts a front elevation view of FIG. 1 box bottom enclosure housing A, with FIG. 1 box bottom biotower generator drip tray carbon media pre-filter BA, shown assembled and in position atop FIG. 1 box bottom biotower generator drip tray AZ, and optional FIG. 1 box bottom biotower two stage, three phase, bacteria storage generators AV, AW, and AX, and mounted in position on FIG. 1 box bottom enclosure housing A, and shown mounted in place under FIG. 1 box bottom bio stack generator drip tray pipe BC, from the embodiment of the present invention.

FIG. 410 depicts a front perspective view of FIG. 1 box bottom biotower generator drip tray splash guard BB, and also FIG. 1 box bottom biotower generator drip tray splash guard BB, shown assembled and in position atop FIG. 1 optional box bottom biotower generator drip tray carbon media pre-filter BA, and FIG. 1 box bottom biotower generator drip tray AZ, and FIG. 1 optional box bottom biotower two stage, three phase, bacteria storage generators AV, AW, and AX, and mounted in position on FIG. 1 box bottom enclosure housing A, from the embodiment of the present invention.

FIG. 411 depicts a front plan view of FIG. 1 box bottom biotower generator drip tray splash guard BB, from the embodiment of the present invention.

FIG. 412 depicts a top plan view of FIG. 1 box bottom biotower generator drip tray splash guard BB, and with the location of (Section BF-BF), from the embodiment of the present invention shown.

FIG. 413 depicts a bottom plan view of FIG. 1 box bottom biotower generator drip tray splash guard BB, from the embodiment of the present invention.

FIG. 414 depicts a (Section BF-BF view), of FIG. 1 box bottom biotower generator drip tray splash guard BB, from the embodiment of the present invention shown.

FIG. 415 depicts a top plan view of FIG. 1 box bottom enclosure housing A, from the embodiment of the present invention.

FIG. 416 depicts a top plan view of FIG. 1 box bottom enclosure housing A, with optional FIG. 1 box bottom biotower generator drip tray splash guard BB, shown assembled and in position atop FIG. 1 optional box bottom biotower generator drip tray carbon media pre-filter BA, and FIG. 1 box bottom bio-media storage drip tray AY, and optional FIG. 1 box bottom biotower two stage, three phase, bacteria storage generators AV, AW, and AX, and mounted in position on FIG. 1 box bottom enclosure housing A, from the embodiment of the present invention.

FIG. 417 depicts a front elevation view of FIG. 1 biotower generator drip tray splash guard BB, and shown assembled and in position atop with FIG. 1 box bottom biotower generator drip tray carbon media pre-filter BA, FIG. 1 biotower generator drip tray AZ, and optional FIG. 1 biotower two stage, three phase, bacteria storage generators AV, AW, and AX, and mounted in position on FIG. 1 box bottom enclosure housing A, and shown mounted in place under FIG. 1 box bottom bio stack generator drip tray pipe BC, from the embodiment of the present invention.

FIG. 418 depicts a front perspective view of FIG. 1 box bottom biotower generator drip tray pipe BC, from the embodiment of the present invention.

FIG. 419 depicts a front perspective view of FIG. 1 box bottom biotower generator drip tray pipe BC, shown positioned through FIG. 1 box bottom media sponge pre-filter H, and FIG. 1 box bottom media carbon pre-filter I, and positioned in front of FIG. 1 box bottom dual head with venturi system pump G, from the embodiment of the present invention.

FIG. 420 depicts a top plan view of FIG. 1 box bottom biotower generator drip tray pipe BC, from the embodiment of the present invention.

FIG. 421 depicts a bottom plan view of FIG. 1 box bottom biotower generator drip tray pipe BC, from the embodiment of the present invention.

FIG. 422 depicts a top plan view of FIG. 1 box bottom biotower generator drip tray pipe BC, and FIG. 1 box bottom biotower generator drip tray splash guard BB, and optional FIG. 1 box bottom biotower generator drip tray carbon media pre-filter BA, FIG. 1 box bottom biotower generator drip tray AZ, and FIG. 1 box bottom biotower two stage, three phase, optional bacteria storage generators AV, AW, and AX, and mounted in position on FIG. 1 box bottom enclosure housing A, with the location of (Section BG-BG), from the embodiment of the present invention shown.

FIG. 423 depicts a (Section BG-BG view), of FIG. 1 box bottom biotower generator drip tray pipe BC, and FIG. 1 box bottom biotower generator drip tray splash guard BB, and optional FIG. 1 box bottom biotower generator drip tray carbon media pre-filter BA, FIG. 1 box bottom biotower generator drip tray AZ, and optional FIG. 1 box bottom biotower two stage, three phase, bacteria storage generators AV, AW, and AX, and mounted in position on FIG. 1 box bottom enclosure housing A, from the embodiment of the present invention shown.

FIG. 424 depicts a top plan view of FIG. 1 box bottom biotower generator drip tray pipe BC, shown positioned in FIG. 1 box bottom enclosure housing A, from the embodiment of the present invention.

FIG. 425 depicts a top plan view of FIG. 1 box bottom enclosure housing A, from the embodiment of the present invention.

FIG. 426 depicts a top plan view of FIG. 1 box bottom enclosure housing A, with FIG. 1 box bottom biotower generator drip tray pipe BC, shown assembled and in position atop FIG. 1 box bottom biotower generator drip tray splash guard BB, and FIG. 1 optional box bottom biotower generator drip tray carbon media pre-filter BA, and FIG. 1 box bottom bio-media storage drip tray AY, and optional FIG. 1 box bottom biotower two stage, three phase, bacteria storage generators AV, AW, and AX, and mounted in position on FIG. 1 box bottom enclosure housing A, from the embodiment of the present invention.

FIG. 427 depicts a front elevation view of FIG. 1 box bottom biotower generator drip tray pipe BC, and shown assembled and in position atop FIG. 1 box bottom biotower generator drip tray splash guard BB, and optional FIG. 1 box bottom biotower generator drip tray carbon media pre-filter BA, FIG. 1 box bottom biotower generator drip tray AZ, and optional FIG. 1 box bottom biotower two stage, three phase, bacteria storage generators AV, AW, and AX, and mounted in position on FIG. 1 box bottom enclosure housing A, from the embodiment of the present invention.

FIG. 428 depicts a front perspective view of FIG. 1 box bottom elevation stand stabilization cup BD1, from the embodiment of the present invention.

FIG. 429 depicts a front plan view of FIG. 1 box bottom elevation stand stabilization cup BD1, with FIG. 1 BD2, BD3, BD4 being typical, from the embodiment of the present invention.

FIG. 430 depicts a top plan view of FIG. 1 elevation stand stabilization cup BD1, with FIG. 1 BD2, BD3, BD4 being typical, and with the location of (Section BF-BF), from the embodiment of the present invention shown.

FIG. 431 depicts a left side plan view of FIG. 1 elevation stand stabilization cup BD1, with FIG. 1 BD2, BD3, BD4 being typical, from the embodiment of the present invention shown.

FIG. 432 depicts a back plan view of FIG. 1 elevation stand stabilization cup BD1, with FIG. 1 BD2, BD3, BD4 being typical, from the embodiment of the present invention.

FIG. 433 depicts a back elevation view of FIG. 1 elevation stand stabilization cups BD1, BD2, BD3, and BD4, shown positioned on FIG. 1 box bottom elevation stand regular E, and FIG. 1 box bottom elevation stand tall F1, and F2, from the embodiment of the present invention.

FIG. 434 depicts a left side elevation view of FIG. 1 box bottom elevation stand stabilization cups BD1, BD2, BD3, and BD4, shown positioned on FIG. 1 box bottom elevation stand regular E, and FIG. 1 box bottom elevation stand tall F1, and F2, from the embodiment of the present invention.

FIG. 435 depicts a front perspective view of FIG. 1 box top enclosure housing B, and box top viewing port window BE, from the embodiment of the present invention.

FIG. 436 depicts a front perspective view of FIG. 1 box top enclosure housing B, and FIG. 1 box top viewing window BE, and FIG. 1 box top doser additive tube cap/stand AJ, from the embodiment of the present invention.

FIG. 437 depicts a front perspective view of FIG. 1 box top enclosure housing B, and FIG. 1 box top viewing window BE, and FIG. 1 box bottom high flow cyclonic evaporative bioskimmer easy clean foam catch cup R, and FIG. 1 box bottom high flow cyclonic evaporative bioskimmer easy clean catch cup foam over flow conners bridge S, from the embodiment of the present invention.

FIG. 438 depicts a front perspective view of FIG. 1 box top enclosure housing B, and FIG. 1 box bottom high flow cyclonic evaporative bioskimmer easy clean foam catch cup lid U, and FIG. 1 box bottom high flow cyclonic evaporative bioskimmer easy clean foam catch cup lid float ball V, and FIG. 1 box top high flow cyclonic evaporative bioskimmer/skimbob/tidal air-control valve AK, from the embodiment of the present invention.

FIG. 439 depicts a front perspective view of FIG. 1 box top enclosure housing B, and FIG. 1 box bottom high flow cyclonic evaporative bioskimmer easy clean foam catch cup lid U, and FIG. 1 box bottom high flow cyclonic evaporative bioskimmer easy clean foam catch cup lid float ball V, and FIG. 1 box top high flow cyclonic evaporative bioskimmer/skimbob/tidal air-control valve AK, and FIG. 2 optional manual soak feeder assembly, from the embodiment of the present invention.

FIG. 440 depicts a front perspective view of FIG. 1 box top enclosure housing B, and FIG. 1 box bottom high flow cyclonic evaporative bioskimmer easy clean foam catch cup lid U, and FIG. 1 box bottom high flow cyclonic evaporative bioskimmer easy clean foam catch cup lid float ball V, and FIG. 1 box top high flow cyclonic evaporative bioskimmer/skimbob/tidal air-control valve AK, and FIG. 3 optional electronic soak feeder assembly, from the embodiment of the present invention.

FIG. 441 depicts a front perspective view of FIG. 1 box bottom enclosure housing A, and optional FIG. 1 box bottom thermostatic control interface assembly AC2, AD, AE, AF, AG, from the embodiment of the present invention.

FIG. 442 depicts a front perspective view of FIG. 1 box bottom enclosure housing A, and FIG. 1 box bottom dual head system pump w/venturi G, and optional FIG. 1 box bottom thermostatic control interface assembly AC2, AD, AE, AF, AG, and FIG. 1 box bottom biotower generator drip tray supply pipe BC, and optional FIG. 1 box bottom bio-media storage drip tray AY, from the embodiment of the present invention.

FIG. 443 depicts a front perspective view of FIG. 1 box bottom enclosure housing A, and FIG. 1 box bottom dual head system pump w/venturi G, and optional FIG. 1 box bottom thermostatic control interface assembly AC2, AD, AE, AF, AG, and FIG. 1 box bottom biotower generator drip tray supply pipe BC, and optional FIG. 1 box bottom biotower two stage, three phase, bacteria storage generators AV, AW, and AX, and optional FIG. 1 box bottom single flow control manifold W2, and optional FIG. 1 box bottom deep pull extension pipe K1, and optional FIG. 1 box bottom deep pull extension pipe strainer L, from the embodiment of the present invention.

FIG. 444 depicts a front perspective view of FIG. 1 box bottom enclosure housing A, and FIG. 1 box bottom dual head system pump w/venturi G, and optional FIG. 1 box bottom thermostatic control interface assembly AC2, AD, AE, AF, AG, and FIG. 1 box bottom biotower generator drip tray supply pipe BC, and optional FIG. 1 box bottom biotower two stage, three phase, bacteria storage generators AV, AW, and AX, and FIG. 1 box bottom biotower generator drip tray AZ, and optional FIG. 1 box bottom single flow control manifold W2, and optional FIG. 1 box bottom single flow control manifold fourty-five degree adapter AB, and optional FIG. 1 box bottom deep pull extension pipe K1, and optional FIG. 1 box bottom deep pull extension pipe strainer L, from the embodiment of the present invention.

FIG. 445 depicts a front perspective view of FIG. 1 box bottom enclosure housing A, and FIG. 1 box bottom dual head system pump w/venturi G, and optional FIG. 1 box bottom thermostatic control interface assembly AC2, AD, AE, AF, AG, and FIG. 1 box bottom biotower generator drip tray supply pipe BC, and optional FIG. 1 box bottom biotower two stage, three phase, bacteria storage generators AV, AW, and AX, and FIG. 1 box bottom biotower generator drip tray AZ, and optional FIG. 1 box bottom biotower generator drip tray carbon media pre-filter BA, and optional FIG. 1 box bottom single flow control manifold W1, and optional FIG. 1 box bottom single flow control manifold nozzle AA1, and optional FIG. 1 box bottom deep pull extension pipe K1, and optional FIG. 1 box bottom deep pull extension pipe strainer L, from the embodiment of the present invention.

FIG. 446 depicts a front perspective view of FIG. 1 box bottom enclosure housing A, and FIG. 1 box bottom dual head system pump w/venturi G, and optional FIG. 1 box bottom thermostatic control interface assembly AC2, AD, AE, AF, AG, and FIG. 1 box bottom biotower generator drip tray supply pipe BC, and optional FIG. 1 box bottom biotower two stage, three phase, bacteria storage generators AV, AW, and AX, and FIG. 1 box bottom biotower generator drip tray AZ, and optional FIG. 1 box bottom biotower generator drip tray carbon media pre-filter BA, and FIG. 1 box bottom wet/dry bio stack generator drip tray splash guard BB, and optional FIG. 1 box bottom single flow control manifold nozzle AA1, and optional FIG. 1 box bottom deep pull extension pipe K1, and optional FIG. 1 box bottom deep pull extension pipe strainer L, from the embodiment of the present invention.

FIG. 447 depicts a front perspective view of FIG. 1 box bottom elevation stand c.o.d. diffuser C, from the embodiment of the present invention.

FIG. 448 depicts a front perspective view of optional FIG. 1 box bottom elevation stand light D, and optional FIG. 1 box bottom elevation stand stabilization cup BD1, from the embodiment of the present invention.

FIG. 449 depicts a front perspective view of FIG. 1 box bottom dual head system pump w/venturi G, and FIG. 1 box bottom high flow cyclonic bioskimmer/skimbob/tidal air control valve tubing P1, and FIG. 1 box bottom deep pull down pipe K1, and FIG. 1 box bottom deep pull down pipe strainer L, from the embodiment of the present invention.

FIG. 450 depicts a front perspective view of FIG. 1 box bottom dual head w/venturi system pump G, and FIG. 1 box bottom high flow cyclonic bioskimmer/skimbob/tidal air control valve tubing P1, and FIG. 1 box top high flow cyclonic evaporative bioskimmer/skimbob/tidal air-control valve AK, and FIG. 1 box bottom deep pull down pipe K1, and FIG. 1 box bottom deep pull down pipe strainer L, and FIG. 1 box bottom high flow cyclonic bioskimmer evaporative foam protein generator body Q, and FIG. 1 box bottom deep pull down pipe strainer L, and optional FIG. 1 box bottom sponge media pre-filter H, and optional FIG. 1 box bottom carbon media pre-filter I, and FIG. 1 box bottom biotower generator drip tray supply pipe BC, and FIG. 1 box bottom elevation stand with c.o.d. diffuser C, from the embodiment of the present invention.

FIG. 451 depicts a front perspective view of FIG. 1 box bottom enclosure housing A, and FIG. 1 box bottom dual head w/venturi system pump G, and FIG. 1 box bottom high flow cyclonic bioskimmer/skimbob/tidal air control valve tubing P1, and FIG. 1 box top high flow cyclonic bioskimmer/skimbob/tidal air control valve AK, and FIG. 1 box bottom deep pull down pipe K1, and FIG. 1 box bottom deep pull down pipe strainer L, and FIG. 1 box bottom high flow cyclonic bioskimmer evaporative foam protein generator body Q, and optional FIG. 1 high flow evaporative protein bioskimmer foam catch cup conners bridge S, and FIG. 1 high flow evaporative protein bioskimmer foam catch cup float level indicator T, and FIG. 1 high flow evaporative protein bioskimmer foam catch cup float level indicator ball V, and optional FIG. 1 box bottom deep pull down pipe strainer L, and optional FIG. 1 box bottom media sponge pre-filter H, and optional FIG. 1 box bottom carbon media pre-filter I, and FIG. 1 biotower generator drip tray supply pipe BC, and FIG. 1 wet/dry, biotower, media storage, drip tray assembly AV, AW, AX, AY, AZ, BA, BB, and optional FIG. 1 box bottom tidal flow dual Y-head control manifold assembly Y, AA1, AA2, and FIG. 1 box bottom elevation stand c.o.d. diffuser C, from the embodiment of the present invention.

FIG. 452 depicts a front perspective view of FIG. 1 box bottom enclosure housing A, and FIG. 1 box bottom dual head system pump w/venturi G, and FIG. 1 box bottom high flow cyclonic bioskimmer/skimbob/tidal air control valve tubing P1, and FIG. 1 box top high flow cyclonic bioskimmer/skimbob/tidal air control valve AK, and optional FIG. 1 box bottom deep pull down pipe K1, and optional FIG. 1 box bottom deep pull down pipe strainer L, and FIG. 1 box bottom high flow cyclonic bioskimmer evaporative foam protein generator body Q, and FIG. 1 high flow evaporative protein bioskimmer foam catch cup R, and optional FIG. 1 high flow evaporative protein bioskimmer foam catch cup conners bridge S, and FIG. 1 high flow evaporative protein bioskimmer foam catch cup float level indicator T, and FIG. 1 high flow evaporative protein bioskimmer foam catch cup float level indicator ball V, and optional FIG. 1 box bottom deep pull down pipe strainer L, and optional FIG. 1 box bottom media sponge pre-filter H, and optional FIG. 1 box bottom carbon media pre-filter I, and FIG. 1 biotower, media storage, drip tray assembly AV, AW, AX, AY, AZ, BA, BB, and optional FIG. 1 tidal flow four head control manifold assembly Z, AA1, AA2, AA3, AA4 and FIG. 1 box bottom elevation stand c.o.d. diffuser C, from the embodiment of the present invention.

FIG. 453 depicts a front perspective view of FIG. 1 box bottom enclosure housing A, and FIG. 1 box bottom dual head system pump w/venturi G, and FIG. 1 box bottom high flow cyclonic bioskimmer/skimbob/tidal air control valve tubing P1, and FIG. 1 box top high flow cyclonic bioskimmer/skimbob/tidal air control valve AK, and FIG. 1 box bottom deep pull extension pipe K1, and FIG. 1 box bottom deep pull extension pipe strainer L, and FIG. 1 box bottom high flow cyclonic bioskimmer evaporative foam protein generator body Q, and FIG. 1 high flow evaporative protein bioskimmer foam catch cup R, and FIG. 1 high flow evaporative protein bioskimmer foam catch cup lid U, and FIG. 1 high flow evaporative protein bioskimmer foam catch cup conners bridge S, and FIG. 1 high flow evaporative protein bioskimmer foam catch cup float level indicator T, and FIG. 1 high flow evaporative protein bioskimmer foam catch cup float level indicator ball V, and FIG. 1 media sponge pre-filter H, and FIG. 1 carbon media pre-filter I, and FIG. 1 biotower generator drip tray supply pipe BC, and FIG. 1 wet/dry, biotower, media storage, drip tray assembly AV, AW, AX, AY, AZ, BA, BB, and FIG. 1 box bottom elevation stand c.o.d. diffuser C, from the embodiment of the present invention.

FIG. 454 depicts a front perspective view of FIG. 1 box bottom elevation stand regular E, and FIG. 1 elevation stand stabilization cup BD2, from the embodiment of the present invention.

FIG. 455 depicts a front perspective view of FIG. 1 box bottom elevation stand tall F1, and FIG. 1 elevation stand stabilization cup BD3, from the embodiment of the present invention.

FIG. 456 depicts a top plan view of FIG. 1 box bottom enclosure housing A, from the embodiment of the present invention.

FIG. 457 depicts a top plan view of FIG. 1 box bottom enclosure housing A, and FIG. 1 box bottom dual head system pump w/venturi G, and FIG. 1 box bottom high flow cyclonic bioskimmer evaporative foam protein generator body Q, and FIG. 1 biotower generator drip tray supply pipe BC, and FIG. 1 wet/dry, biotower, media storage, drip tray assembly AV, AW, AX, AY, AZ, BA, BB, and FIG. 1 tidal flow single head control manifold assembly W1, AA1, from the embodiment of the present invention.

FIG. 458 depicts a front perspective view of FIG. 1 box bottom elevation stand light BF, and FIG. 1 box bottom elevation stand light remote control BG, from the embodiment of the present invention.

FIG. 459 depicts a left side plan view of FIG. 1 box bottom enclosure housing A, and FIG. 1 box top enclosure housing B, and and FIG. 1 box bottom high flow cyclonic bioskimmer/skimbob/tidal air control valve tubing P1, and FIG. 1 box top high flow cyclonic bioskimmer/skimbob/tidal air control valve AK, and FIG. 1 optional box bottom short pull vacation down pipe/skimbob assembly, which consists of FIG. 1 optional box bottom short pull vacation down pipe N, and FIG. 1 bottom pull flow down extension vac pipe airline P2, and FIG. 1 optional box bottom short pull vacation down pipe skimbob O, from the embodiment of the present invention.

FIG. 460 depicts assorted front perspective assembly views of FIG. 2 optional manual soak feeder assembly AL, AM, AN, from the embodiment of the present invention.

FIG. 461 depicts assorted assembly views of FIG. 3 optional electronic soak feeder assembly AO, AP, AQ, AR, AS, AN, AC1, AT, from the embodiment of the present invention.

FIG. 462 depicts assorted front perspective assembly views of FIG. 4 optional top-off, water fill, additive, and slide soak feeder tank wall clip AU, and FIG. 2 optional manual soak feeder assembly AL, AM, AN, and FIG. 3 optional electronic soak feeder assembly AO, AP, AQ, AR, AS, AN, AC1, AT, from the embodiment of the present invention.

FIG. 463 depicts assorted front perspective assembly views of doser additive tube assembly AH, AI, AJ, from the embodiment of the present invention.

FIG. 464 depicts a complete front perspective assembly view with options of FIG. 1 box filter w/c.o.d. diffuser and cyclonic high flow bioskimmer, from the embodiment of the present invention.

FIG. 465 depicts a complete back perspective assembly view with options of FIG. 1 box filter w/c.o.d. diffuser and cyclonic high flow bioskimmer, from the embodiment of the present invention.

FIG. 466 depicts a left side plan view of FIG. 1 box bottom enclosure housing A, and FIG. 1 box top enclosure housing B, and and FIG. 1 box bottom high flow cyclonic bioskimmer/skimbob/tidal air control valve tubing P1, and FIG. 1 box top high flow cyclonic bioskimmer/skimbob/tidal air control valve AK, and FIG. 1 box bottom deep pull extension pipe K1, K2, K3, and FIG. 1 bottom pull flow down pipe extension strainer L, and FIG. 1 bottom pull flow down pipe extension sponge pre-filter M, and FIG. 1 tidal flow single head control manifold assembly W1, AA1, from the embodiment of the present invention.

FIG. 467 depicts a front perspective assembly view of FIG. 1 box bottom high flow cyclonic bioskimmer evaporative foam protein generator body Q, and FIG. 1 box bottom high flow cyclonic bioskimmer/skimbob/tidal air control valve tubing P1, and FIG. 1 box top high flow cyclonic bioskimmer/skimbob/tidal air control valve AK, from the embodiment of the present invention.

FIG. 468 depicts a front perspective assembly view of FIG. 1 box bottom high flow cyclonic bioskimmer evaporative foam protein generator body Q, and FIG. 1 box bottom dual head system pump w/venturi G, and FIG. 1 box bottom high flow cyclonic bioskimmer/skimbob/tidal air control valve tubing P1, and FIG. 1 box top high flow cyclonic bioskimmer/skimbob/tidal air control valve AK, from the embodiment of the present invention.

FIG. 469 depicts a front perspective view of FIG. 1 box bottom dual head system pump w/venturi G, from the embodiment of the present invention.

FIG. 470 depicts a front perspective assembly view of FIG. 1 box bottom thermostatic control interface AC2, AD, AE, AF, AG, from the embodiment of the present invention.

FIG. 471 depicts a front perspective view of FIG. 1 box bottom deep pull down pipe strainer pre-filter M, from the embodiment of the present invention.

FIG. 472 depicts a front perspective view of FIG. 1 box bottom biotower generator drip tray carbon media pre-filter BA, from the embodiment of the present invention.

FIG. 473 depicts a bottom plan view of FIG. 1 box bottom enclosure housing B, from the embodiment of the present invention.

FIG. 474 depicts a front perspective view of FIG. 1 box bottom tidal flow single head control manifold W2, from the embodiment of the present invention.

FIG. 475 depicts a front perspective view of FIG. 1 box bottom single flow control manifold fourty-five degree adapter AB, from the embodiment of the present invention.

FIG. 476 depicts a front perspective view of FIG. 1 box bottom tidal flow single head control manifold assembly W1, and FIG. 1 box bottom tidal flow control manifold fourty-five degree adapter AB, from the embodiment of the present invention.

FIG. 477 depicts a front perspective view of FIG. 1 box bottom tidal flow single head control manifold assembly W1, AA1, from the embodiment of the present invention.

FIG. 478 depicts a front perspective view of FIG. 1 box bottom tidal flow two head control manifold assembly X, AA1, from the embodiment of the present invention.

FIG. 479 depicts a front perspective view of FIG. 1 box bottom tidal flow dual Y-head control manifold assembly Y, AA1, AA2, from the embodiment of the present invention.

FIG. 480 depicts a front perspective view of FIG. 1 box bottom tidal flow four head control manifold assembly Z, AA1, AA2, AA3, AA4, from the embodiment of the present invention.

FIG. 481 depicts a front perspective view of FIG. 1 sponge box bottom media pre-filter sponge H, from the embodiment of the present invention.

FIG. 482 depicts a front perspective view of FIG. 1 box bottom mesh media pre-filter carbon I, from the embodiment of the present invention.

FIG. 483 depicts a front perspective view of tank wall positioning for the FIG. 1 bio filter assembly, and FIG. 4 top-off, water fill, additive, and slide soak feeder tank wall clip AU, from the embodiment of the present invention.

FIG. 484 depicts a front perspective view of free standing and tank wall positioning for the FIG. 1 bio filter assembly, and FIG. 4 top-off, water fill, additive, and slide soak feeder tank wall clip AU, with manual soak feeder assembly, from the embodiment of the present invention.

FIG. 485 depicts a front perspective view of free standing in-tank positioning for the FIG. 1 bio filter assembly, from the embodiment of the present invention.

FIG. 486 depicts assorted front perspective views of the FIG. 1 bio filter assembly, in an alternate configuration, and shown positioned in an external single tower sump filter system, from the embodiment of the present invention.

FIG. 487 depicts assorted front perspective views of the FIG. 1 bio filter assembly, in an alternate configuration, and shown positioned in an external dual tower sump filter system, from the embodiment of the present invention.

FIG. 488 depicts assorted front perspective views of the FIG. 1 bio filter assembly, and shown positioned in an external quad tower sump filter system, from the embodiment of the present invention.

### DETAILED DESCRIPTION OF THE INVENTION

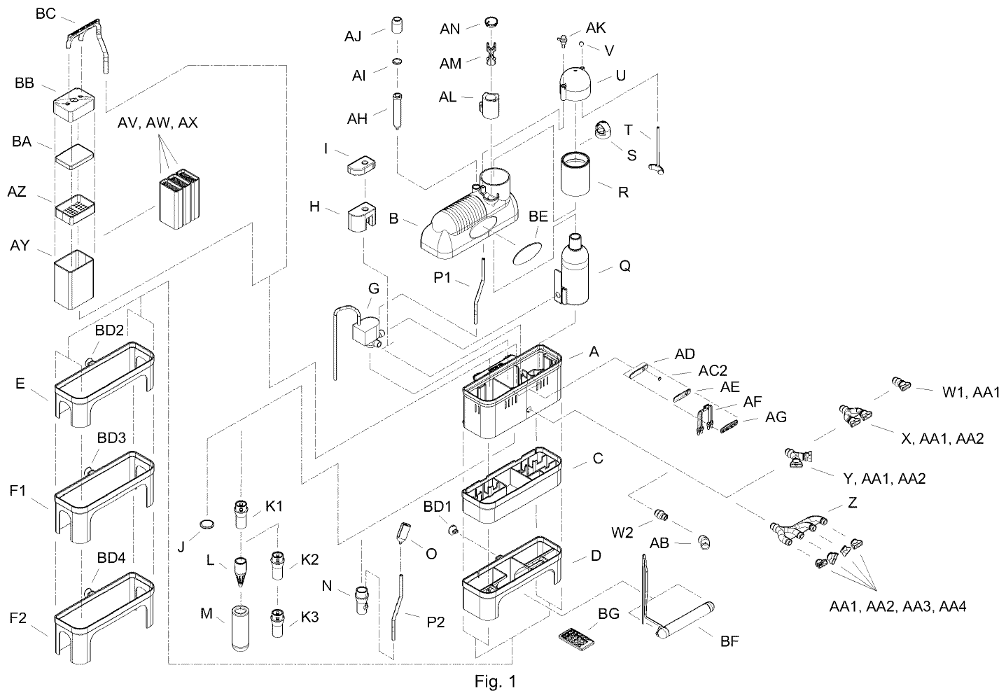

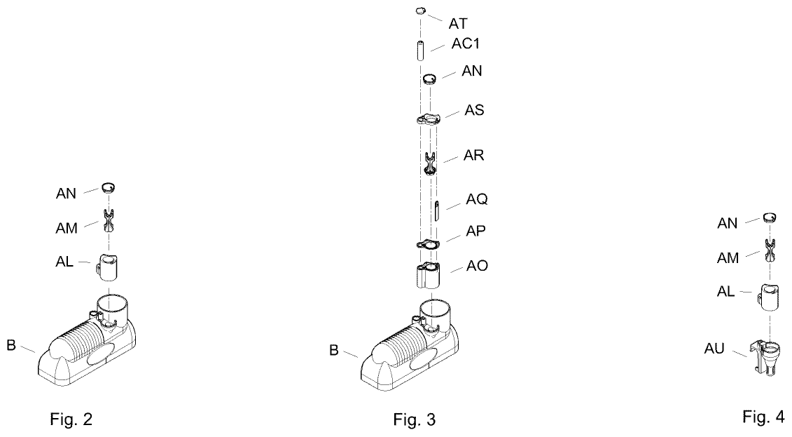

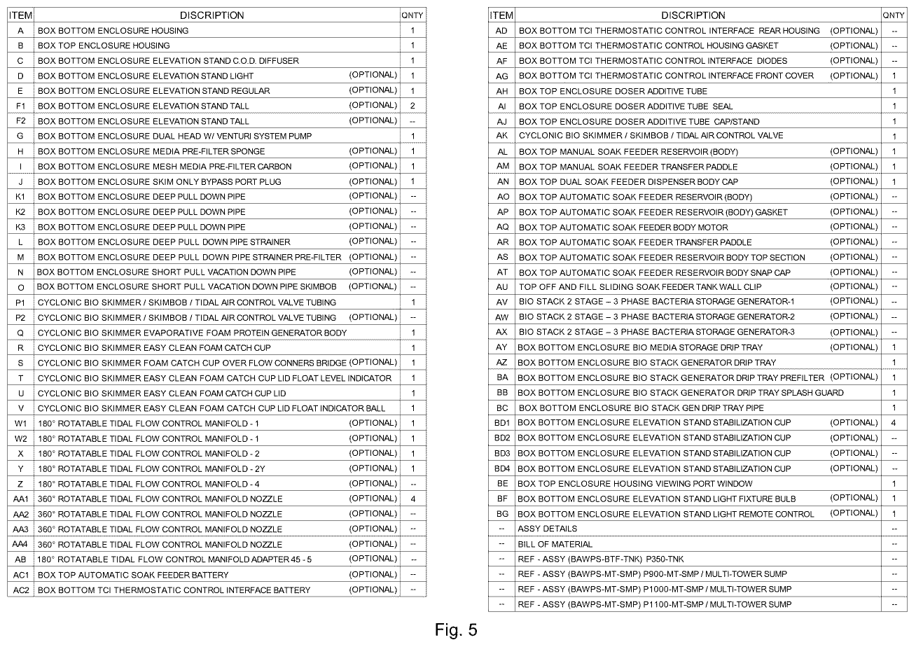

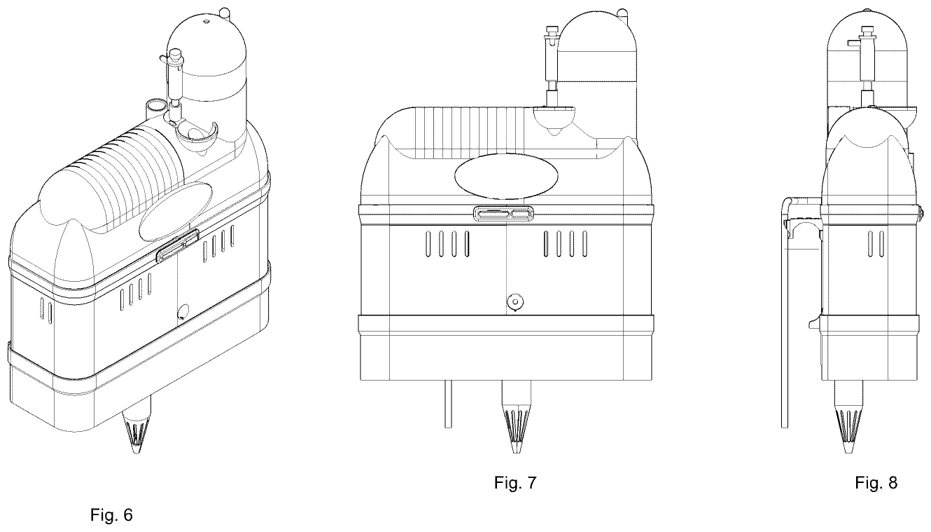

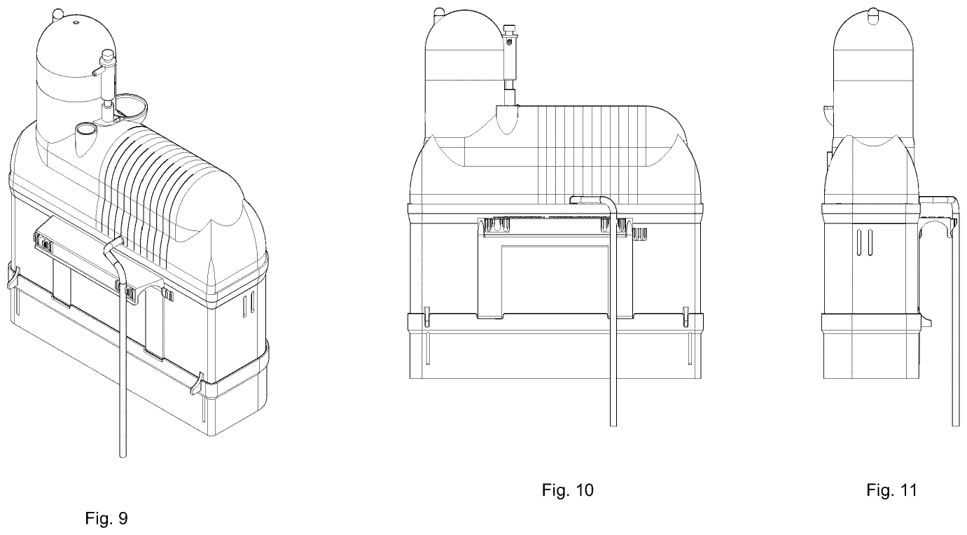

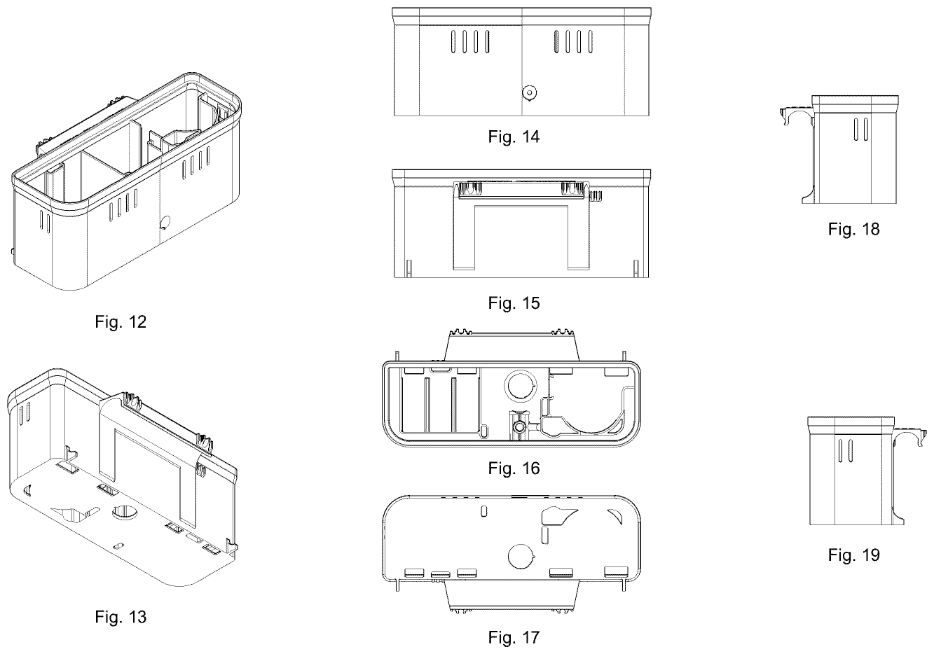

Referring first to all the embodiments in FIG. 1, FIG. 2, FIG. 3, and FIG. 4, which are made of a plastic material, preferably black in color, with FIG. 2 AL, AM, AND AN, FIG. 3 AO, AP, AR, AS, AN and AT, constructed of the same plastic material, but preferably red in color, this with the exception of embodiments such as internal electrical parts, motors, pumps, batteries and a clear viewing window.

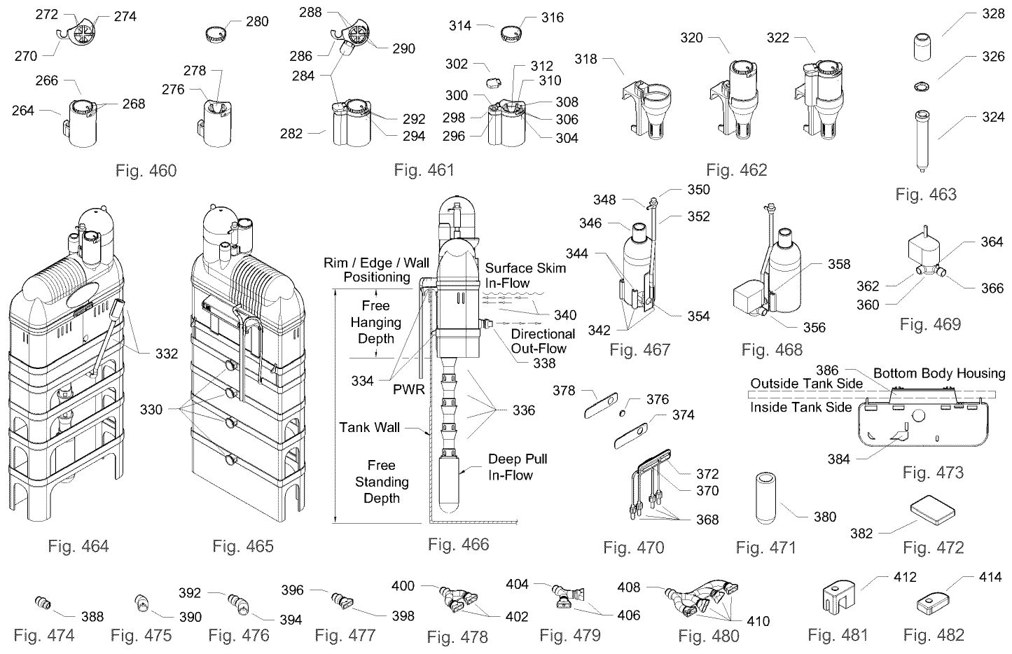

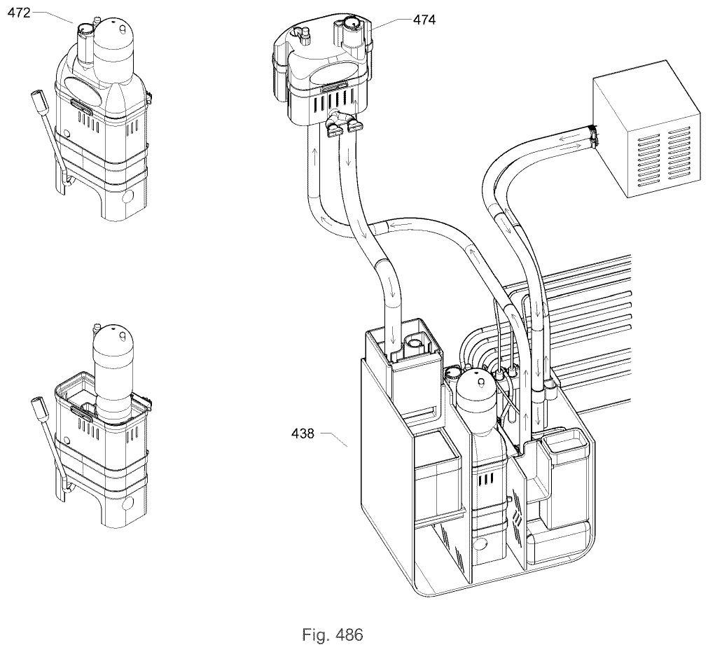

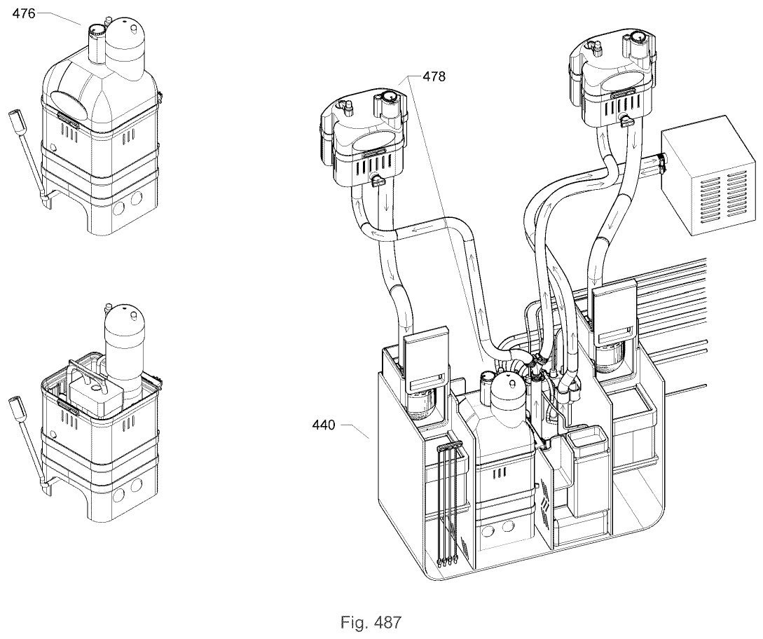

Before securing FIG. 1 box filter w/c.o.d., in a suitable location which provides access to the main tank/habitat chamber containment area, pond, sump, or aquarium, (usually at the water's edge), on a stand, bracket, or by hanging the specifically designed unit over the top back wall, or top side wall FIG. 466, 483, 484, using its FIG. 473 self-leveling edge/wall slide 386, and FIG. 448 elevation stand stabilization cups 166, FIG. 454 218, FIG. 455 222, FIG. 465 330, and FIG. 457 self-leveling support tabs 238, 244, FIG. 459 254, 256, FIG. 469 336, FIG. 457 238, 244 provide balance and stability while FIG. 473 self-leveling edge/wall slide 386, keeps FIG. 1, box filter w/c.o.d. automatically level on FIG. 466 any rim, tank or edge wall 334, 483, 484, or free standing FIG. 485, FIG. 486, FIG. 487, the unit on one of its FIG. 454 box frame elevation stand/(s) with hide and play zones 216, FIG. 455 220, and remove FIG. 435 top cover housing 102, this will include its FIG. 435 manual fill port 106, FIG. 453 foam collection cup lid 214 with its attached FIG. 451 foam collection cup float level indicator 204 and FIG. 439 foam collection cup float level indicator ball 116, FIG. 451 202, FIG. 452 foam collection cup 208, FIG. 436 dosing tube 108, FIG. 258, FIG. 463 324, dosing tube cap seal 326, FIG. 463 dosing tube cap/stand 328, FIG. 2 manual soak feeder attachment, FIG. 460 264, or FIG. 3 automatic soak feeder attachment, FIG. 461 282.

To remove FIG. 435 top cover housing 102, first lift off FIG. 453 foam collection cup lid 214 with its attached FIG. 451 foam collection cup float level indicator 204 and FIG. 451 foam collection cup float level indicator ball 202, and set them aside.

Next twist and pull-up simultaneously on FIG. 452 bioskimmer foam collection cup 208, this will unseat it from the top neck of FIG. 450 bioskimmer evaporative foam generator body 194, which resides under FIG. 435 box top enclosure housing 102, and allow for the separation of FIG. 435 box top enclosure housing 102 from FIG. 441 box bottom enclosure housing 120.

At this point, the entire FIG. 435 box top enclosure housing 102 can either be lifted off completely and set aside, (this same procedure can be used late for servicing the internals of the unit; but for general maintenance at start-up, the FIG. 435 box top enclosure housing 102 can be lifted up and clear of its internals and twisted sideways while stationed on the FIG. 450 bioskimmer evaporative foam generator body 194 to provide ease of access to the overall workings inside the unit without the need to remove it completely.

Next, with the inside of FIG. 441 box bottom enclosure housing 120 accessible, use a slight tug to verify that the FIG. 449 bioskimmer/skimbob air injection tubing 176 is secured in place on the small nipple and FIG. 469 air-tube venturi connection 364, FIG. 459 252, which is located midway out on the supply nozzle neck of FIG. 469 box bottom enclosure dual head system pump with venturi 366. The unit is supplied with enough FIG. 449 bioskimmer/skimbob air injection tubing 176 so that the FIG. 435 box top enclosure housing 102 can remain openly separated from the FIG. 441 box bottom enclosure housing 120 without the need to disconnect the FIG. 449 bioskimmer/skimbob air injection tubing 176 umbilical which ties the two together.

Visually inspect FIG. 450 media carbon pre-filter 188, FIG. 482 414, and FIG. 450 sponge media pre-filter 186, FIG. 481 412, to see that they are seated down low within the front inflow section of FIG. 441 box bottom enclosure housing 120 and positioned on FIG. 442 bio-tower generator drip tray supply pipe 132 and also that the FIG. 442 bio-tower generator drip tray supply pipe 132 is seated securely.

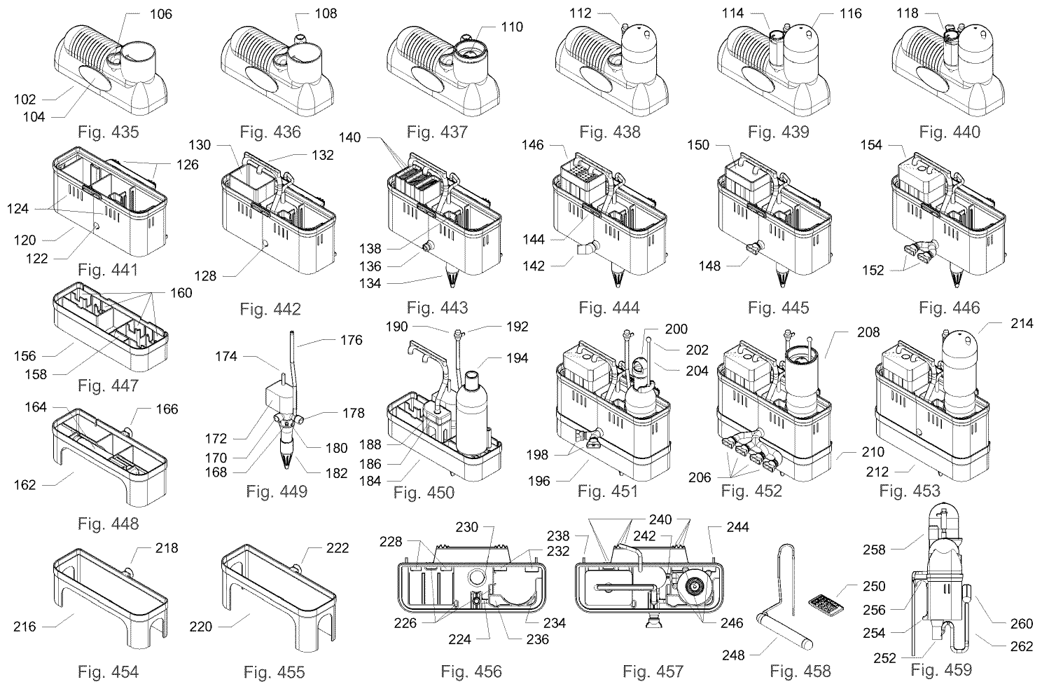

After clarification, verify that FIG. 443 bio-tower two phase, three stage, bacteria storage generators 140 are also seated snugly under FIG. 442 bio-tower generator drip tray supply pipe 132, FIG. 446 bio-tower generator drip tray splash guard 154 FIG. 445 bio-tower generator drip tray pre-filter 150, FIG. 444 bio-tower generator drip tray 146.

Next replace FIG. 435 top cover enclosure housing 102, this will include its FIG. 435 water top off, fill/feed port 106, FIG. 453 bioskimmer foam collection cup lid 214 with its attached FIG. 451 bioskimmer foam collection cup float level indicator 204 and FIG. 451 bioskimmer foam collection cup float level indicator ball 202, FIG. 452 bioskimmer foam collection cup 208, FIG. 436 dosing tube 108, 463 324, FIG. 463 dosing tube seal 326, FIG. 463 dosing tube cap/stand 328, FIG. 460 manual soak feeder attachment, or FIG. 461 automatic soak feeder attachment.

Referring next to the overall FIG. 1 biological trapping filter with c.o.d. and high flow bioskimmer, place the assembled unit so that it sits levelly on the inside of the habitat chamber area, (FIG. 441 front inflow slots 124, 466 340, residing seventy percent submerged within the habitat's upper water column while the unit faces forward so that the FIG. 466 in-flow skimmed surface water 340 of the habitat area can enter into the unit freely through the FIG. 441 in-flow skim surface water slots 124, FIG. 466 340, and initial water processing can begin to take place.

To prime the system, plug in and switch on FIG. 1 biological trapping filter with c.o.d. and high flow bioskimmer. Turn FIG. 438 box top high flow cyclonic bioskimmer/skimbob/tidal air control valve knob 112, FIG. 450 190, FIG. 467 350, which is mounted on FIG. 453 bioskimmer foam collection cup lid 214, and ties into FIG. 449 bioskimmer/skimbob air injection tubing 176, FIG. 457 242, counter-clockwise to the open position so that the valve is no longer seated.

Next, listen for the priming sound of FIG. 450 evaporative high flow bioskimmer 194, (a silent hum here signifies a pump impeller cavitation is taking place); if impeller cavitation is evident, power on and off the unit FIG. 449 174, to achieve full air release from FIG. 450 evaporative high flow bioskimmer 194 and the sound of water agitation is present for the completion of final priming.

Full priming of FIG. 450 evaporative high flow bioskimmer 194 can be confirmed by removing FIG. 453 bioskimmer foam collection cup lid 214 with its attached FIG. 451 bioskimmer foam collection cup float level indicator 204 and FIG. 451 bioskimmer foam collection cup float level indicator ball 202 and peering down through the center of FIG. 452 bioskimmer foam collection cup 208 to view inside the FIG. 450 high flow bioskimmer neck 194, FIG. 467 346. When primed properly, a steady flow of oxygen bubbles will be seen rapidly crossing over the FIG. 450 evaporative high flow bioskimmer 194, FIG. 186 first internal staging chamber 416, FIG. 184 418.

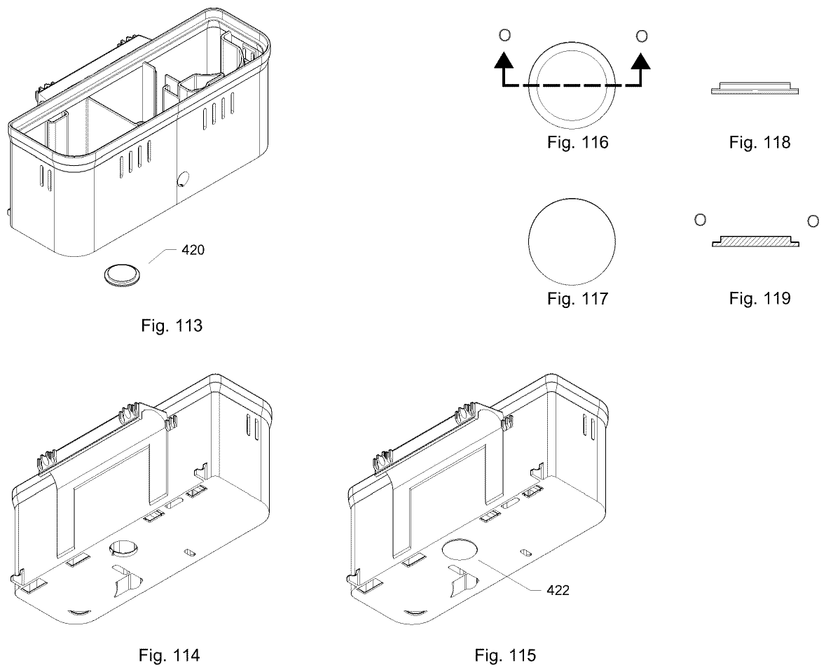

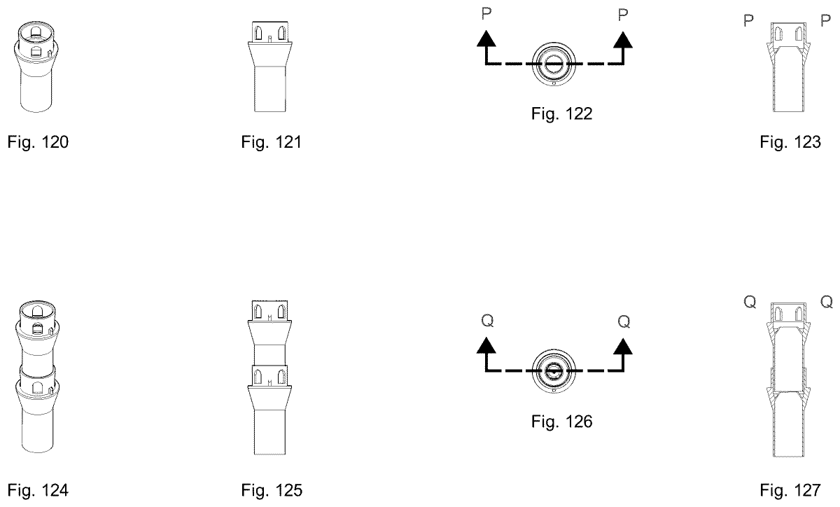

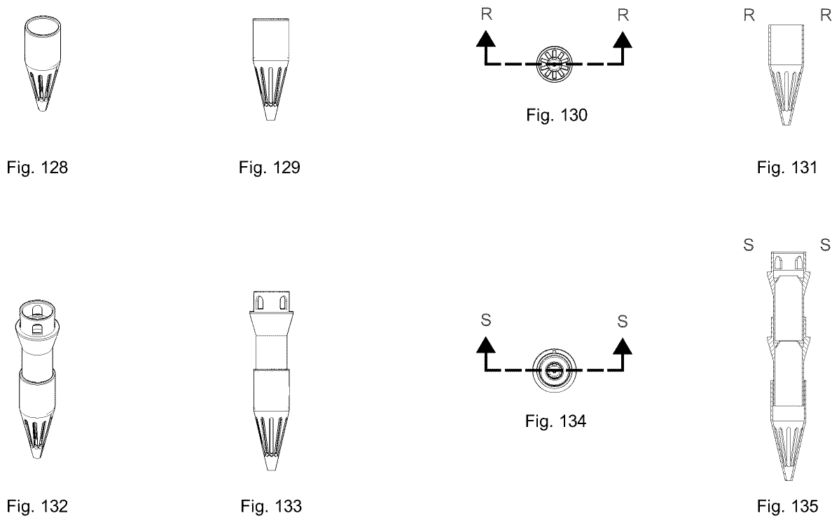

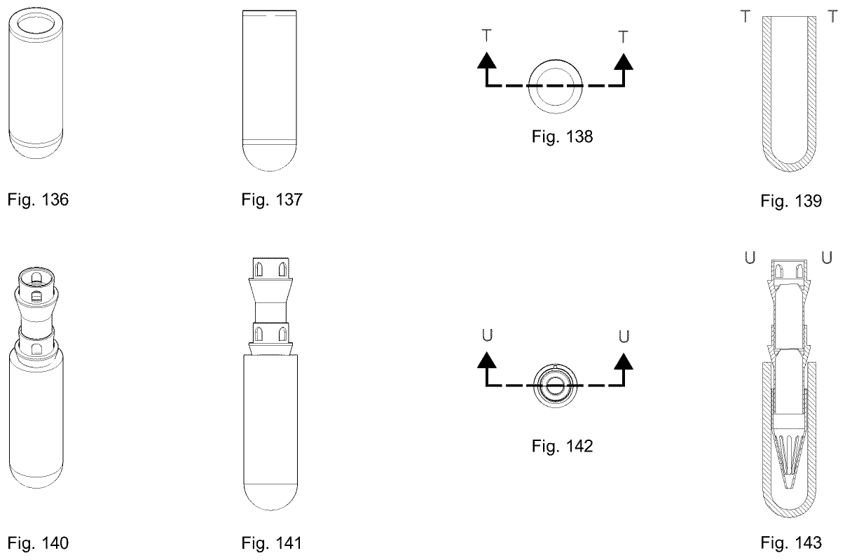

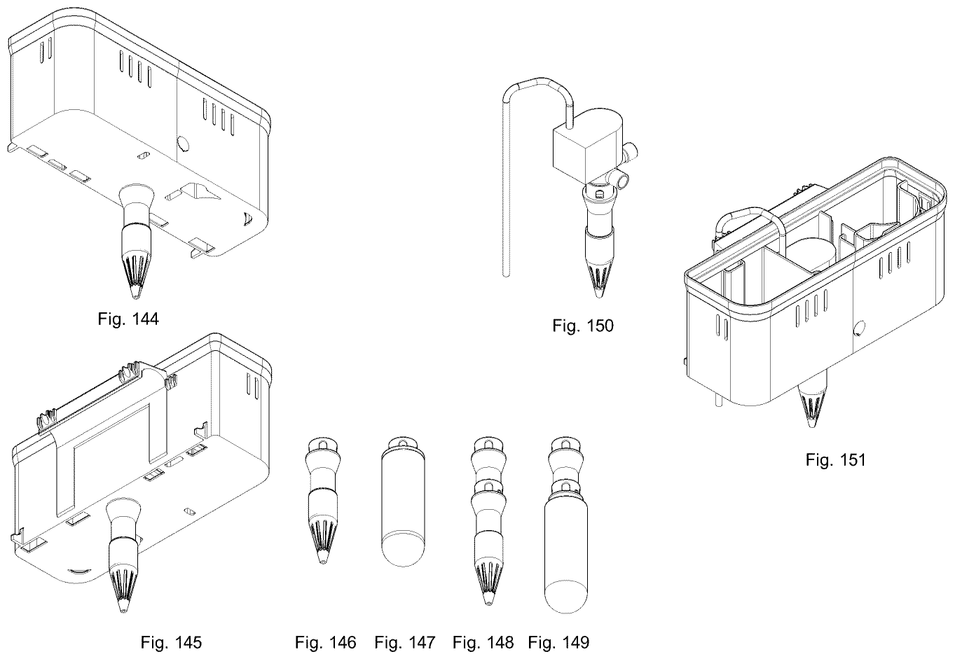

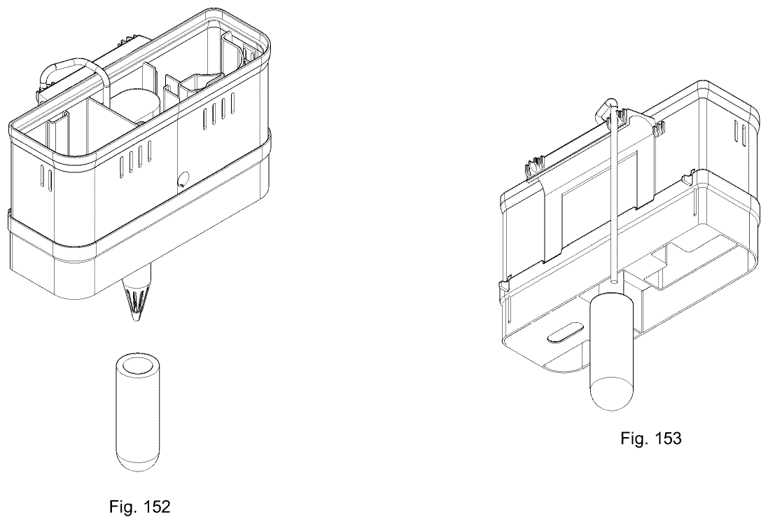

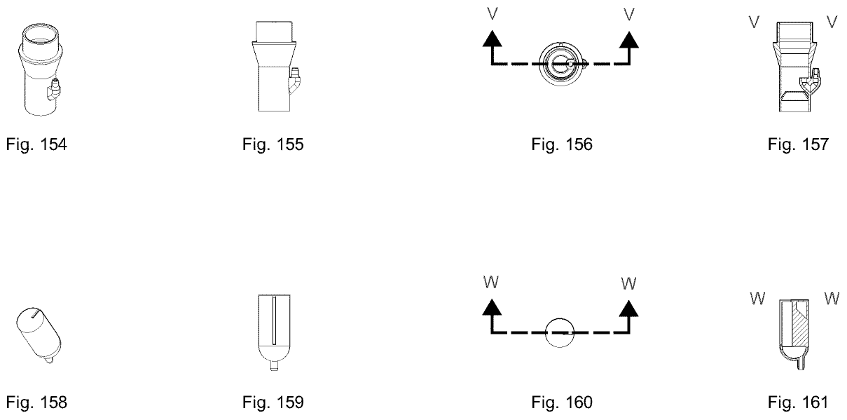

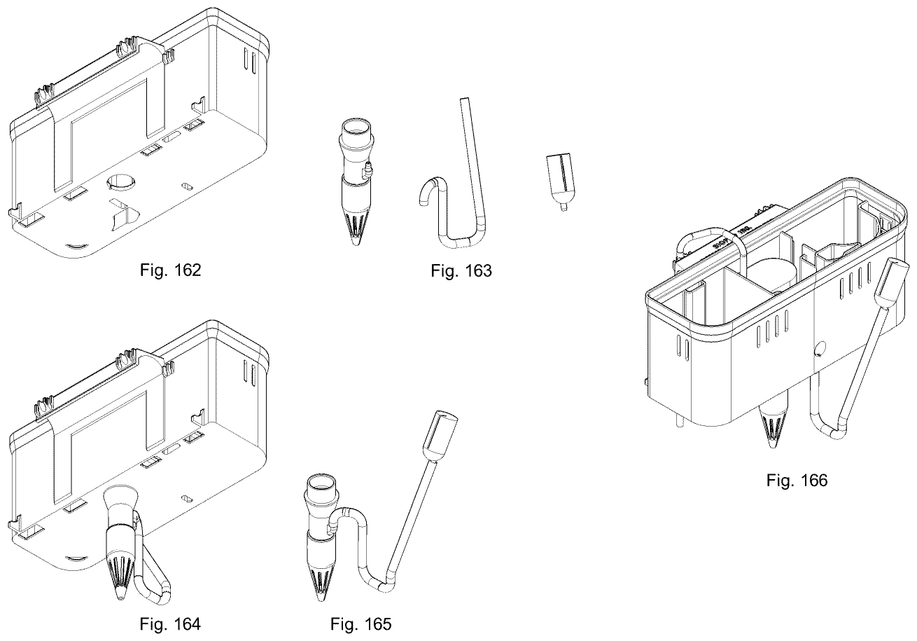

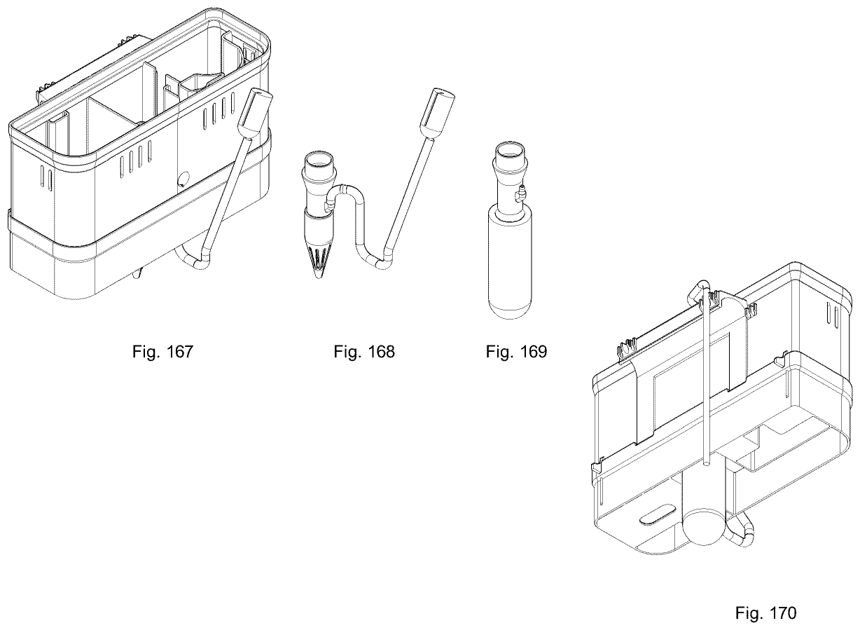

As FIG. 469 dual head system pump w/venturi 360 draws in water, the untreated liquid is drawn in from both the top and bottom of the habitat area's water column. Firstly, it arrives via FIG. 441 box bottom enclosure housing 120 lower FIG. 449 box bottom deep pull keyed extension down pipe in-flow slot 168 of FIG. 449 box bottom deep pull keyed extension down pipe 180, FIG. 456 230, FIG. 466 336, and FIG. 459 vac skimbob assembly 252, 260, 262, and the corresponding FIG. 443 deep pull extension down pipe strainer 134, FIG. 449 182, and FIG. 471 extension down pipe strainer sponge media pre-filter 380. (These being bypassed if FIG. 113 box bottom down pipe bypass plug 420, FIG. 115 422 is used which increases intake water flow at FIG. 441 top surface water skimming slots 124) and Secondly, it arrives via the same sets of FIG. 441 top surface water skimming slots 124, FIG. 466 340.

Referring next to FIG. 481 media sponge pre-filter 412 and FIG. 482 carbon media pre-filter 414 where the water is initially screened of detritus and debris before it enters into the pumping system by the FIG. down pipe strainer sponge pre-filter 380, the FIG. 482 carbon media pre-filter 414. This process incorporates both mechanical filtration and chemical filtration as methods for water purification.

Once pre-filtered and treated with carbon, the water flows from the FIG. 449 dual head system pump with venturi supply head 172, and FIG. 469 362, which is located low in the FIG. 441 box bottom enclosure housing 120 and is delivered (via the FIG. 442 biotower generator drip tray supply pipe 132) up and over to it's connection atop the FIG. 446 biotower generator drip tray supply pipe splash guard 154 before it then enters into the holding area provided within the FIG. 444 biotower generator drip tray body 146. Here, the FIG. 445 biotower generator drip tray carbon infused pre-filter media 150, FIG. 472 382, resides and adds some additional chemical filtration to the water purification process prior to it finally passing the water through to the specifically designed stream/trickle drip hole patterns of FIG. 444 biotower generator drip tray 146.

When water accumulates in the FIG. 444 biotower generator drip tray 146, the pre-filtered water quickly begins gravity dripping and creates a continuous trickle effect upon the FIG. 381 biotower top surface patterning 424, of the FIG. 381 biotower “bio-weave” 424 which also fills the inner body of FIG. 382 biotower two stage-three phase bacteria storage generators 426, FIG. 443 140, with the same inner tubular mesh.

During saturation, the upper levels of the inner tubular mesh on the FIG. 382 biotower two stage-three phase bacteria storage generators 426 immediately begins to convert any animal or plant load within it's “air/water mix” saturation column into a slowly growing “air/water type bacteria culture” which remains in place and increases in mass as it adheres to every surface of the biotower's inner upper tubular walls.

Here, in this area, the bacteria culture begins to balance the system, (more load, more bacteria-less load, less bacteria), and the bacteria culture continues to accumulate as it feeds on the growing waste load produced with the introduction of additional inhabitants. This process incorporates biological filtration as a method of water purification.

After traversing through the FIG. 382 biotower two stage-three phase bacteria storage generators 426 upper levels, the lower levels of the Biotowers' same inner tubular mesh becomes saturated with water and begins to retain, though in a gravity suspension submersion state (or soaking) environment, an additional batch of live bacteria culture which stays fully cloaked and submerged in water all of the time.

This type of living bacteria though similar in nature to the first, doesn't thrive as well in an “air/water mixed” environment but instead, it may be referred to as an “under-gravel” or “sub-plate” type-based bacteria. This new bacteria culture then also helps convert any animal or plant load within its own solid water column of inner tubular mesh into additional submerged water-based bacteria cultures. These then grow and spread as they feed on the leftovers of any waste load that has not yet been consumed by the upper level's “air/water mix” of cultured bacteria, (again the living culture-base expands and contracts to current load requirements). This process also incorporates biological filtration as a method of water purification. Hence, the (BAWPS)—biologic aquatic water purification system was created.

Since these types of bacteria cultures naturally build up and accrue on the surface layers their provided over time, a standard quantity of bio-balls or sponge-like media substrate or “bio-block” which is held stationary (as to not cause the bacteria to let free itself from the biomass substrate or surfaces that it has bonded to and contaminate the entire system) and stored within a single chamber/sump, current substrates for bio mass generation will eventually deplete their own efficiency over an extended period of time, (usually six months to a year). At this point, most existing biologic systems on the market will require the accumulated bacteria cultures to be removed from the system.

Unfortunately, this “cycling” affect or “bacteria build” requires months to take place. Once established, currently designed biological filter systems do not allow for the aquaculturist to touch, move or even clean in any way the cultured biomass surfaces created after the initial live bacteria load cultivation process has begun.

After a time, these types of generic systems which utilize more primitive forms of biological filtration will eventually, and in fact do, collapse under their own bacteria load. And shortly thereafter, if the older created or already existing dead and dying biomass cultures which are located under the newer top living layers of bacteria have not been removed, the water quality in the main habitat area will be forced into a “spiked” or “heavy load” state which will stress and often kill all of the inhabitants which are exposed to it.

Therefore, it is for this reason that the FIG. 1 box filter w/c.o.d. and high flow cyclonic bioskimmer comes with three FIG. 382 biotower two stage-three phase bacteria storage generators 426 already in place.

Sets of three or more FIG. 382 biotower two stage-three phase bacteria storage generators 426 makes it possible for the aquaculturist to now remove one FIG. 382 biotower two stage-three phase bacteria storage generator 426 at a timed interval (every 90 days) and then clean it (heavy rinsing), or replace it, before then re-inserting it back into it's original position within the FIG. 441 box bottom enclosure housing 120.

This process of continuously rotating and cleaning the FIG. 382 biotower two stage-three phase bacteria storage generators 426 assures that no individual section of the trapped biomass culture ever grows old or becomes fully cycled, (this renders the system “cycleless”), nor does it have a chance to accumulate too many of the consecutive surface layers of dead biological buildup over time which will cause a major decline in the overall system's stability and water quality.

Here, there is the option of switching out the FIG. 382 biotower two stage-three phase bacteria storage generators 426 with FIG. 442 bio media storage drip tray 130, FIG. 444 146, which can hold any preferred alternate bio media substrate material for its use in bacteria generation and storage.

Amazingly, the FIG. 1 box filter w/c.o.d. and high flow cyclonic bioskimmer is the first and only stand alone processing filter system on the market that offers the aquaculturist the ability to avoid spending up front time “pre-cycling” their systems at start up.

The FIG. 1 box filter w/c.o.d. and high flow cyclonic bioskimmer prevents any initial spike load from occurring in the first place. From the moment it is turned on, there is no longer the need to purchase or add costly products for “pre-cycling” to the system and then enduring a nail biting full month or longer to see if your newly arrived prized first fish will survive during the cycling process.

This type of filtration is considered state of the art and systems with c.o.d. are completely “cycle-less” which is something that up to this point has been unavailable to the average consumer. An aquaculturist can now add as many additional plants and animals as he or she likes to the habitat containment area on day one of start up, and the additional load the additional plants and animals create will be completely compensated for by the c.o.d. system until initial “bacteria load” or “pre-cycle” is achieved.

Referring next to the water's arrival past the FIG. 382 biotower two stage-three phase bacteria storage generators 426, the freshly pre-filtered and biologically processed water is then passed down through to the FIG. 441 box bottom enclosure housing 120 where it passes through and arrives within the separately attached FIG. 447 box bottom elevation stand with c.o.d. diffuser where it provides “Compressed Oxygen Diffusion” 156 to the system.

At the same time, air is also being sent from the FIG. 469 dual head system pump with venturi supply head 362, (this eliminates the need to purchase a separate external air pump to supply air to the system or high flow cyclonic bioskimmer), which is positioned there and into FIG. 467 cyclonic high flow evaporative protein bioskimmer bottom front inflow nozzle 354.

Next the newly created “air/water mix” of agitated diffusion travels past the inflow nozzle and outer chamber of the FIG. 467 cyclonic high flow evaporative protein bioskimmer bottom front inflow nozzle 354, before the water is then rapidly injected into the FIG. 186 cyclonic high flow evaporative protein bioskimmer's cyclonic-inner-chamber-tube partition 416 within the unit.

In this inner chamber, the “air/water mix” is spun in a circular fashion as it rises up and continuously fills the cyclonic chamber to the top. Small FIG. 188 holes which are located at the lower portion of the inner cyclonic chamber of the cyclonic high flow evaporative protein bioskimmer bottom 428, FIG. 184 430 provide a pathway for some of this highly oxygenated water to bypass the inner chamber completely and ease the overall system back-pressure as the flow of water enters the units outer most chamber.

Upon accumulating in the FIG. 186 cyclonic high flow evaporative protein bioskimmer's cyclonic-inner-chamber-tube portion 416, the proteins gathered up from the habitat chamber by the c.o.d. process are cycloned to the top. As a result, the high flow c.o.d. infusion flow begins piling up and slowing, the fusion mix is seemingly scrubbed clean while oxygen and protein molecules separate from the water column molecules and increase a rising white foam affect.

The rising foam created from the c.o.d. and bioskimming process then rises higher and higher until it breaches the top of the FIG. 467 cyclonic high flow evaporative protein bioskimmer tube-neck 346, with the rising protein based foam waist created then emerging out and over from the tube-neck to finally spill into and begin accumulating into the body of the FIG. 452 cyclonic high flow evaporative protein bioskimmer foam collection cup 208. (here there is also the optional FIG. 437 cyclonic high flow evaporative protein bioskimmer foam collection cup conners bridge 110, FIG. 451 200, which can be affixed to the inner neck of FIG. 450 cyclonic high flow evaporative protein bioskimmer foam collection cup inner neck 194 and redirect the protein foam growth sideways and prevent any potential heavy load increase or spike induced rise of foam waste from reaching the inside top of FIG. 453 cyclonic high flow evaporative protein bioskimmer foam collection cup lid 214.

As the accumulation of protein foam gathers in the cyclonic bioskimmer easy clean cup it begins to breakdown and liquefy. As the liquification process continues, the cyclonic bioskimmer easy clean cup begins to fill up with liquid which in turn raises the FIG. 451 cyclonic high flow evaporative protein bioskimmer collection cup float level indicator 204 and FIG. 451 cyclonic high flow evaporative protein bioskimmer float level indicator ball 202 assembly which rises up through the FIG. 453 cyclonic high flow evaporative protein bioskimmer collection cup lid 214 to indicate the current level of the internal cup's fill.

When filled, the FIG. 452 cyclonic high flow evaporative protein bioskimmer collection cup 208 can be removed, the accrued protein paste and wastewater residing inside emptied, and the cup then rinsed out before its re-installation back into its original position atop the FIG. 450 cyclonic high flow evaporative protein bioskimmer 194.

While the air injection and cyclonic protein skimming process are taking place in the inner chamber of the FIG. 450 cyclonic high flow evaporative protein bioskimmer 194, a likewise process is taking place as the spillover of mixed protein and oxygen water fusion clears the FIG. 186 cyclonic high flow evaporative protein bioskimmer inner chamber wall 416 and rapidly fills the unit's FIG. 184 cyclonic high flow evaporative protein bioskimmer outer chamber 430. Here, the larger bubbles which accumulate are displaced away from the rising upper foam mix. These larger bubbles are then drawn down and away from the FIG. 184 high flow evaporative protein bioskimmer outer chamber 430 along with the newly processed and skimmed inner and outer chamber water via weep holes that are situated at the base of FIG. 188 cyclonic high flow evaporative protein bioskimmer exterior chamber wall 432, FIG. 467 342, 344, FIG. 468 358, FIG. 457 246.

This “air/water mix” is then passed through FIG. 456 multiple ports in the box bottom enclosure housing 232 where they crash into FIG. 447 box bottom elevation stand with c.o.d.'s diffuser cup receptors 160. The c.o.d. diffuser cup receptors use the naturally occurring compression that this action generates to cultivate and disperse minute oxygen bubbles which are small enough to remain submerged as they travel out from FIG. 447 box bottom elevation stand w/c.o.d. 156 and are subtly released within the natural outflow of the underwater currents that the system generates. From here, the c.o.d. or “Compressed Oxygen Diffusion” mist begins to saturate and impregnate the entire water column of the habitat chamber area being treated.

As the “compressed oxygen diffusion” of tiny bubbles saturates the entire containment area, they act like magnets and adhere invisibly to nearly any minute proteins which are present. Waste, detritus, leftover food particles, and algae blooms, are all repeatedly paired together while the newly formed oxygen/protein mix, (or spike load), is then slowly and continuously floated up higher into the water column of the habitat area. Once in the vicinity, the load is gathered up and siphoned into FIG. 1 biological trapping box filter with c.o.d. and high flow bioskimmer for processing, this systematic removal of accumulating contaminants and harmful protein waist continues twenty-four-seven and incorporates mechanical filtration as a method of water purification.

Once accumulated, the ultra fine mist of the c.o.d. system rapidly converts the entire habitat area's water column into what's known as a “protein soaking chamber”, this allows the saturation of fine bubbles to have the additional time necessary to gather and adhere to ever greater loads of unwanted particles before then transferring them also higher up and into the water column where they are gathered by FIG. 1 biological trapping box filter with c.o.d. and cyclonic high flow evaporative protein bioskimmer for their introduction into the bioskimming system.

The process of c.o.d. is currently the only way available to aquaculturist which provides a completely “cycle-less” environment for aquatic system habitats. With the use of c.o.d., no start-up additives are ever needed, the c.o.d. on its own generates a highly oxygenated overall habitat environment which aids all types of aquatic plants and animals in their natural absorption of oxygen and thus creates a healthier, more colorful and livelier aquatic habitation for the aquaculturist and their families to enjoy.

Incorporating naturally occurring c.o.d. in any aquatic habitat insures the long term stability of that aquatic environment while at the same time, by removing contaminants, proteins, and algae blooms continuously. The treated system overall requires less cleaning, maintenance and repeated water changes. The bioskimming process of FIG. 1 biological trapping box filter with c.o.d. and high flow cyclonic bioskimmer incorporates mechanical filtration as a method for water purification.

Referring back to the bottom body area of FIG. 447 box bottom elevation stand with c.o.d. diffuser 156, the newly treated water being forwarded from FIG. 443 biotower two stage-three phase bacteria storage generators 140 and FIG. 450 cyclonic high flow evaporative protein bioskimmer 194 are combined as they pass through FIG. 456 box bottom enclosure c.o.d. supply ports 228, 232, before then entering FIG. 447 box bottom elevation stand with c.o.d.'s upper diffuser cup receptors 160, are compressed, and then become discharged out from the bottom of FIG. 447 box bottom elevation stand with c.o.d. 156 and are sent into the main habitat area where they are re-circulated again and again. The larger and excess oxygen bubbles being diverted out from the system via assorted FIG. 456 box bottom enclosure bubble traps 226, 234.

Referring next to FIG. 444 thermostatic control interface 144, FIG. 470 368, 370, 372, 374, 376, 378, an interactive readout device which provides a display of the active water quality conditions such as, but not limited to, temperature, salinity conductivity, redox-orp, and nitrite/nitrate levels. Current readings are available at the touch of a button, FIG. 470 370 via FIG. 470 digital status report screen 372, which are sent from signals provided by FIG. 470 sensors, diodes and probes 368.

The FIG. 470 thermostatic control interface, is powered by FIG. 470 battery 376 which can be replaced by (with FIG. 435 box top enclosure housing 102 still removed) use a sharp edge or fingernail to remove the embodiment's FIG. 470 thermostatic control interface rear snap cover 378 and pry free with the same sharp edge or fingernail, the old FIG. 470 battery 376, replacing it with a new FIG. 470 battery 376, before snapping FIG. 470 thermostatic control interface rear snap cover 378, back in place.

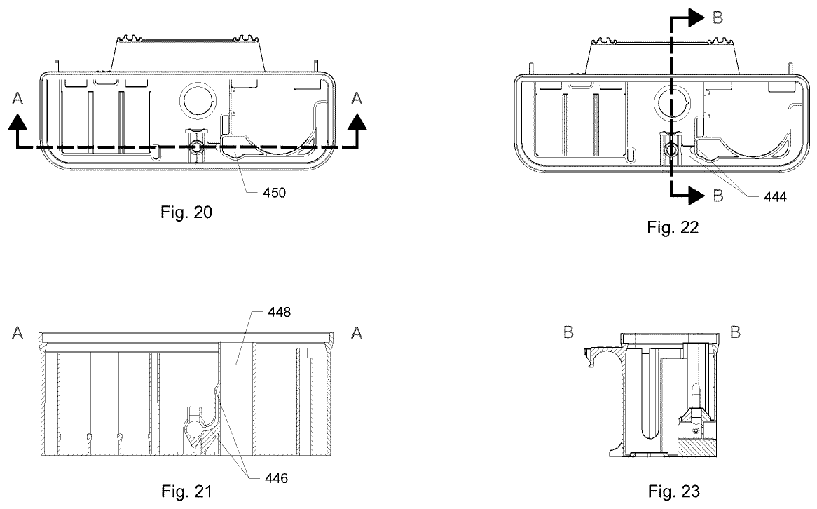

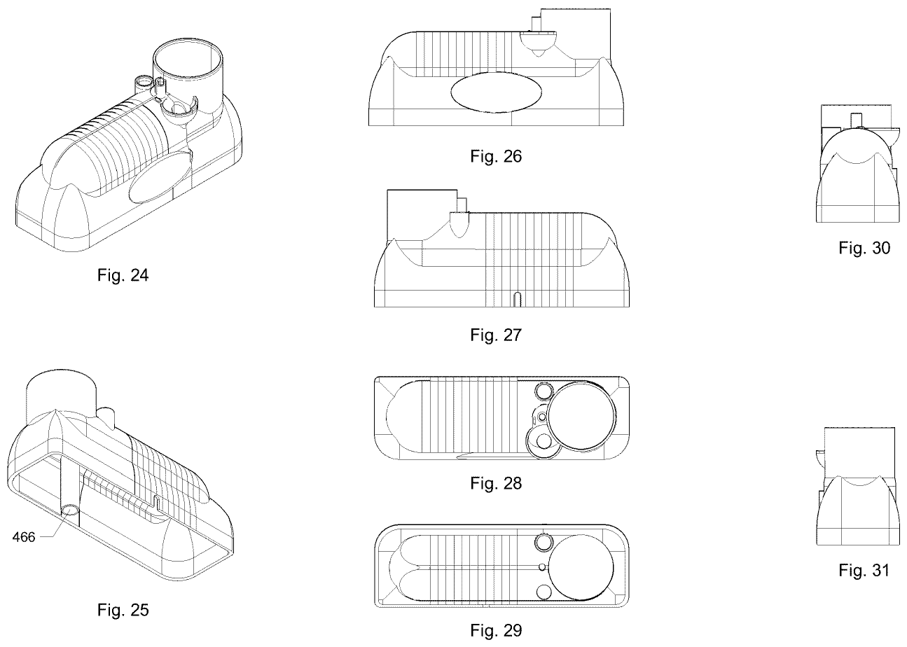

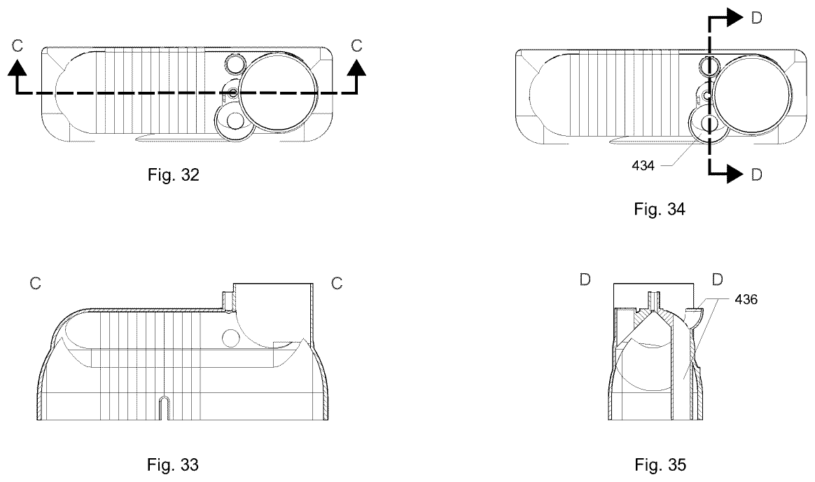

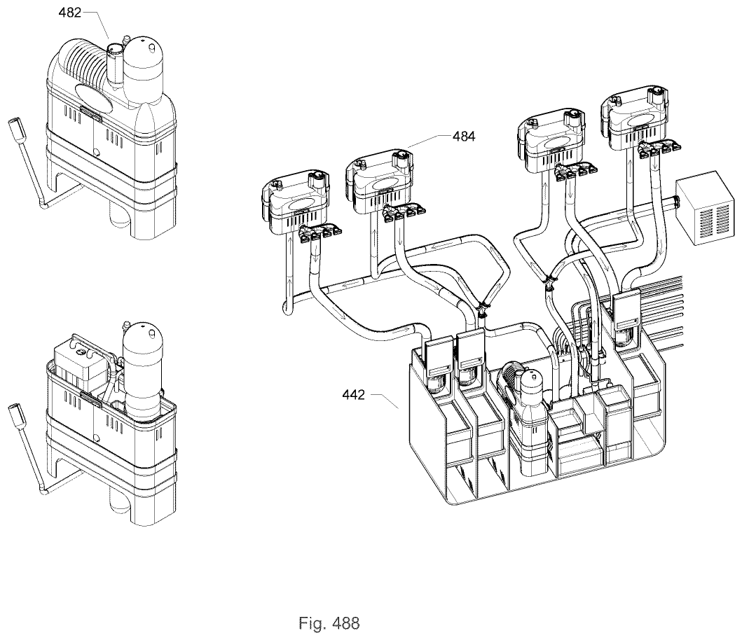

Referring next to FIG. 435 top-off, water fill, additive, and feeding port 106, FIG. 34 (Section D-D) 434, FIG. 35 (Section D-D) 436, which allows the aquarist to bypass pouring fill or top-off water, directly into FIG. main tank/habitat chamber containment area 340, FIG. 486 external filter system 438, FIG. 487 440, FIG. 488 442, (avoiding the locations of lights, filters and glass or acrylic tops), and add fill, top-off water, or water treatments and additives, directly into FIG. 466 main tank/habitat chamber containment area 340, via FIG. 435 box top enclosure housing 102, FIG. 435 top-off, water fill, additive, and feeding port 106, FIG. 34 (Section D-D) 434, FIG. 35 (Section D-D) 436, where they are premixed by direct water injection via FIG. 22 box bottom cyclonic chamber supply-in pipe head release port 444, FIG. 21 (Section A-A) 446, where they are spun and soaked prior to their release from FIG. 456 box bottom submerged top-off, water fill, additive, and food release port 236, FIG. 473 384, FIG. 20 (Section A-A) 450, and FIG. 21 (Section A-A) 448.

Referring next to FIG. 2 optional manual soak feeder attachment, FIG. 462 320 and FIG. 3 optional automatic soak feeder attachment, FIG. 462 322, of which both FIG. 2, and FIG. 3, embodiments can also be mounted entirely separately on FIG. 4 optional sliding soak feeder tank wall clip, FIG. 462 320, 322.

The later, FIG. 3 optional automatic soak feeder attachment, is powered by placing FIG. 461 battery 300, into the FIG. 461 automatic soak feeder attachment main body housing 282, by lifting FIG. 461 automatic soak feeder battery cover snap cap 284, 302, and sliding the FIG. 461 battery 300, into FIG. 461 automatic soak feeder attachment main body housing 282, and then returning FIG. 461 automatic soak feeder battery cover snap cap 284, 302, back into its closed position atop FIG. 461 automatic soak feeder attachment main body housing 282.

The FIG. 461 automatic soak feeder attachment main body housing 282, has two settings that are identified by FIG. 461 automatic soak feeder attachment main body housing power indicator lite setting one 294, 304, which provides food on a 12-hour cycle, or twice daily and FIG. 461 automatic soak feeder attachment main body housing power indicator lite setting two 292, 306, which provides food on an 8-hour cycle, or three time daily.

Either of the two automatic feeder settings can be activated by turning FIG. 461 automatic soak feeder attachment main body housing cap power indicator arrow 316, which is located on top of FIG. 461 automatic soak feeder attachment main body housing cap 314, to FIG. 461 automatic soak feeder attachment main body housing power indicator lite setting one 294, 304, or FIG. 461 automatic soak feeder attachment main body housing power indicator lite setting two 292, 306, respectfully, for the desired feeding schedule to be obtained.

The optional FIG. 460 soak feeder attachment main body housings of both soak feeder embodiments 264, 270, FIG. 461 282, 286, can be clipped onto, and rest upon FIG. 435 box top top-off, water fill, additive, and feeding port 106, FIG. 34 (Section D-D) 434, and FIG. 35 (Section D-D) 436, which allows the aquarist to bypass pouring food directly into FIG. 466 main tank/habitat chamber containment area 340, FIG. 486 external filter system 438, FIG. 487 440, FIG. 488 442, (avoiding the locations of lights, filters and glass or acrylic tops), and add food directly into FIG. 466 main tank/habitat chamber containment area 340, via FIG. 435 box top enclosure housing 102, FIG. 435 box top top-off, water fill, additive, and feeding port 106, FIG. 34 (Section D-D) 434, FIG. 35 (Section D-D) 436, where they are cyclonically premixed by direct water injection via FIG. 22 box bottom cyclonic supply-in pipe head release port 444, FIG. 21 (Section A-A) 446, where the food is spun and soaked prior to its release from FIG. 456 submerged top-off, water fill, additive, and food release port 236, FIG. 473 384, FIG. 20 (Section A-A) 450, and FIG. 21 (Section A-A) 448.

By removing the optional FIG. 460 soak feeder attachment main body caps 280, FIG. 461340, from their associated FIG. 460 optional soak feeder attachment main body housings 274, FIG. 461314, it is then possible to pour food directly into FIG. 460 soak feeder attachment main body housings 264, FIG. 461 282, chambers FIG. 460 274, 278, and FIG. 461 290, 312, with their optional FIG. 460 soak feeder attachment main body housing paddles 276, FIG. 461 310, still in place, until their FIG. 460 soak feeder attachment main body housing 264, FIG. 461 282, chambers FIG. 460 274, 278, and FIG. 461 290, 312, are full.

Allow room for the re-seating of FIG. 460 optional manual soak feeder attachment main body cap 280, or FIG. 461 optional automatic soak feeder attachment main body housing cap 340.

Referring back to FIG. 460 optional manual soak feeder attachment main body cap 280.

Once FIG. 460 optional manual soak feeder attachment main body housing chamber 274, 278, is full, and FIG. 460 optional manual soak feeder attachment main body housing cap 266 is replaced so that it clicks in place atop FIG. 460 optional manual soak feeder attachment main body housing paddles 276. The FIG. 460 optional manual soak feeder attachment main body housing cap 266, can be twisted back and forth, or rotated completely around 180 degrees, until FIG. 460 optional manual soak feeder attachment main body housing cap arrow 280, returns back to its original indicator position FIG. 460 268.

The twisting action of both optional FIG. 460 soak feeder attachment main body housing paddles 276, FIG. 461 310, dispenses a premeasured serving of food from either of the optional FIG. 460 soak feeder attachment main body housing food release holes 272, FIG. 461 288, which are located in the bottoms of optional FIG. 460 soak feeder attachment main body housings 264, FIG. 461 282.

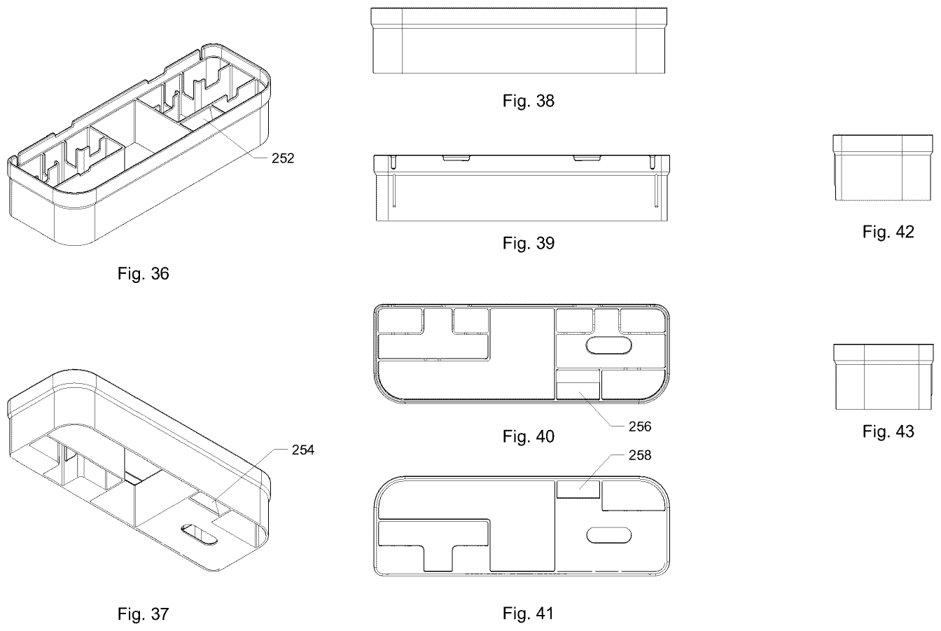

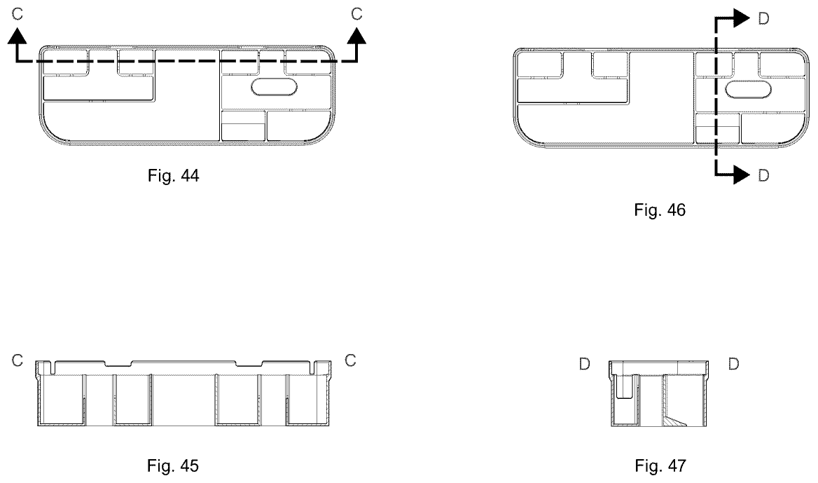

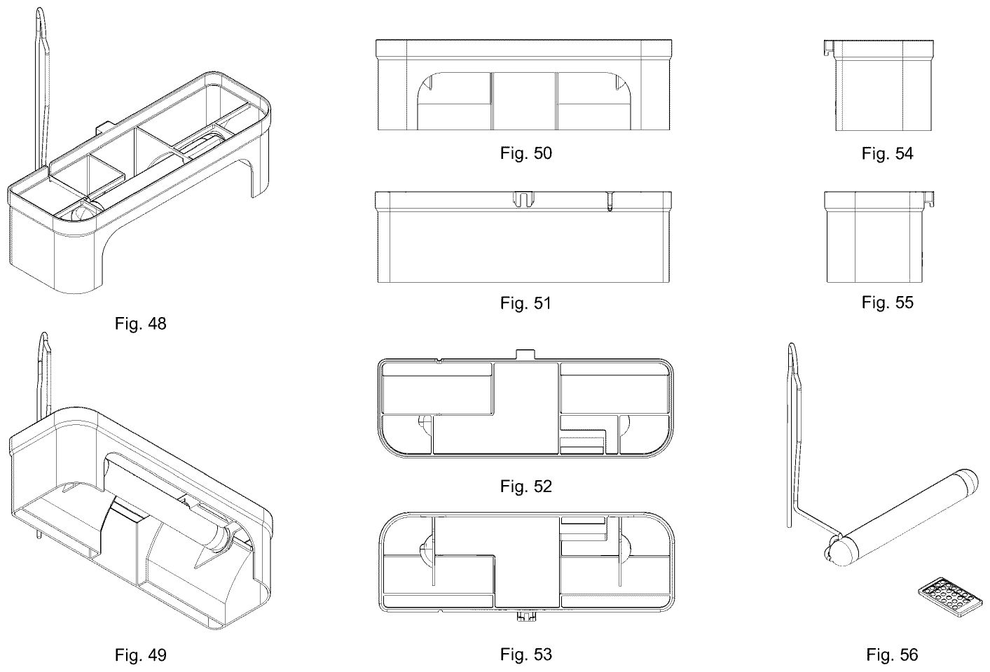

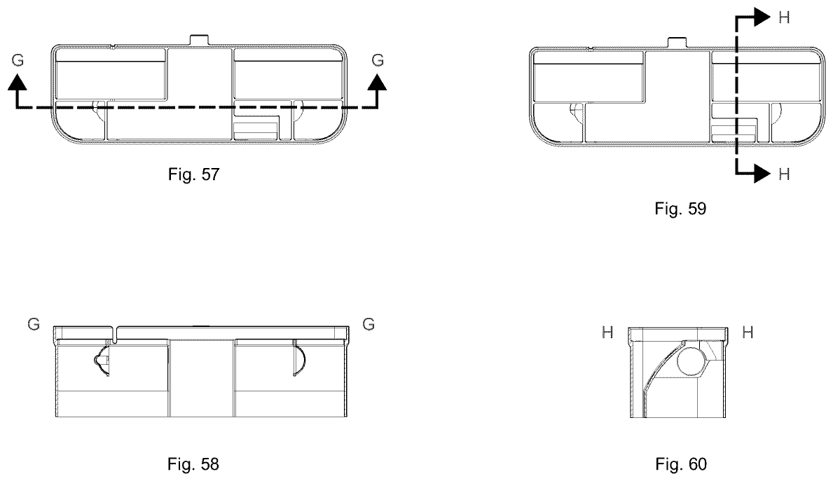

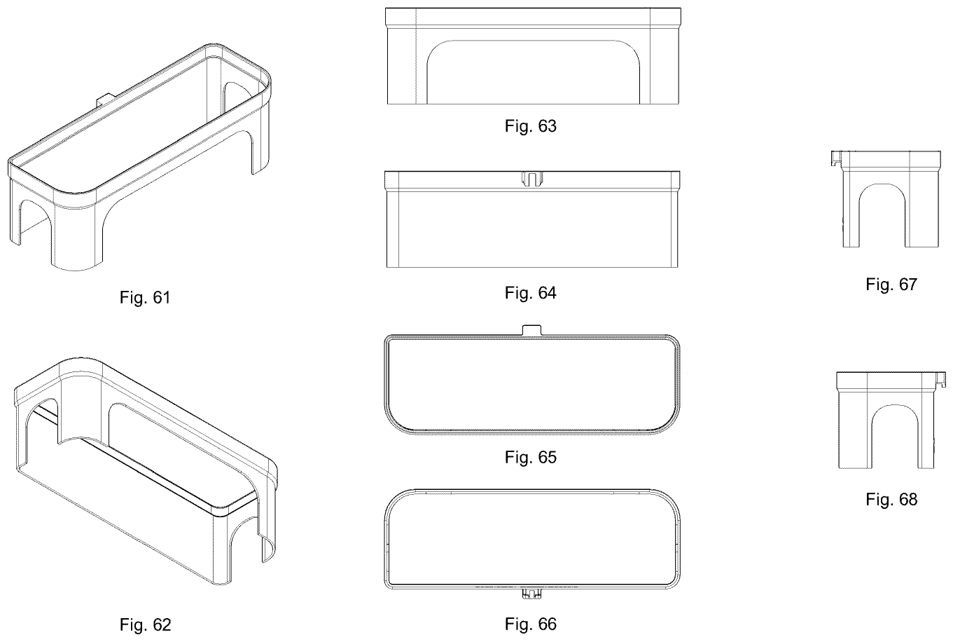

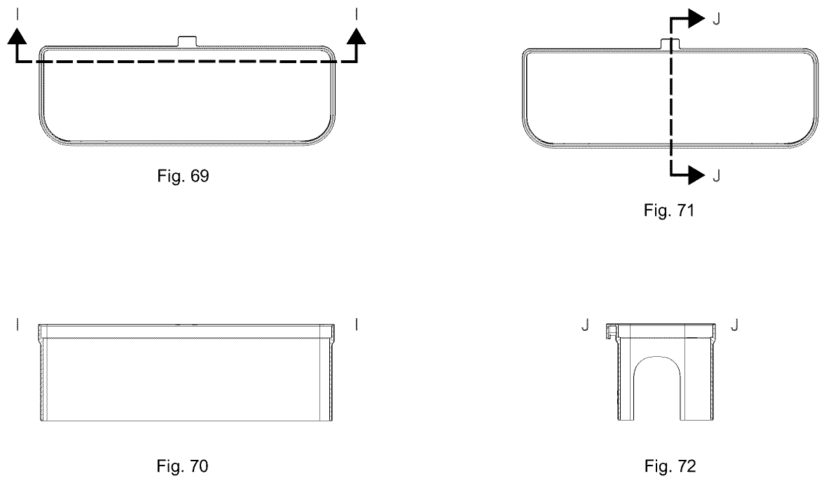

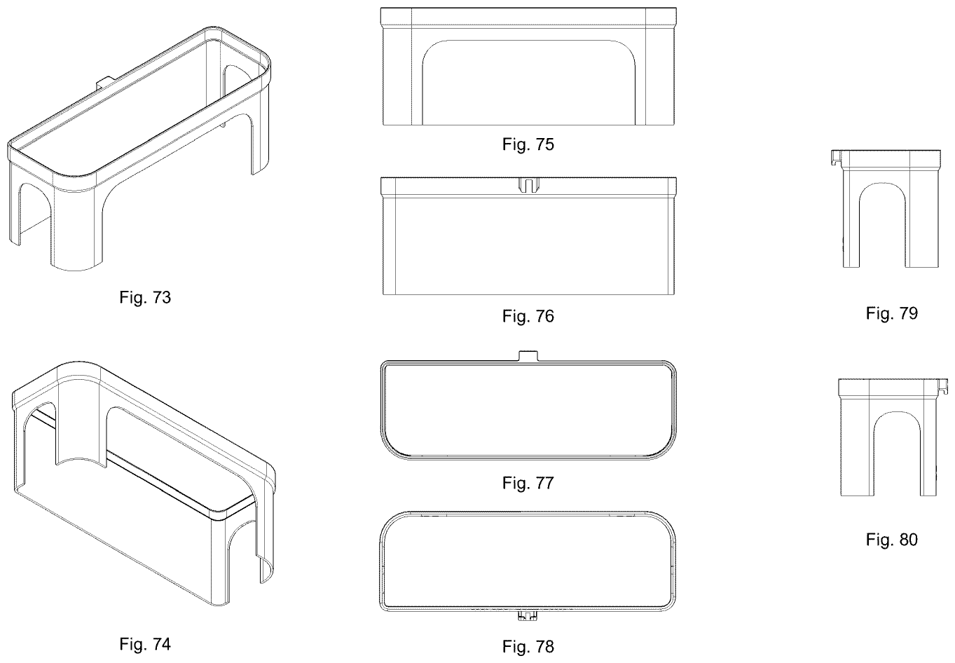

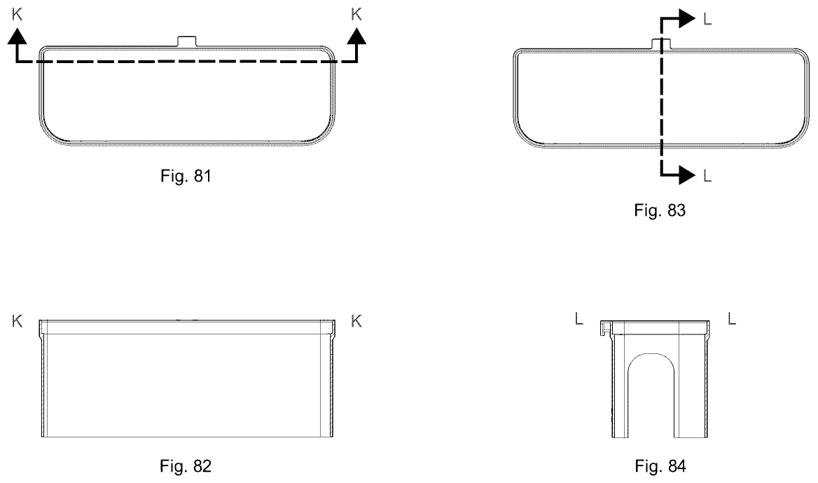

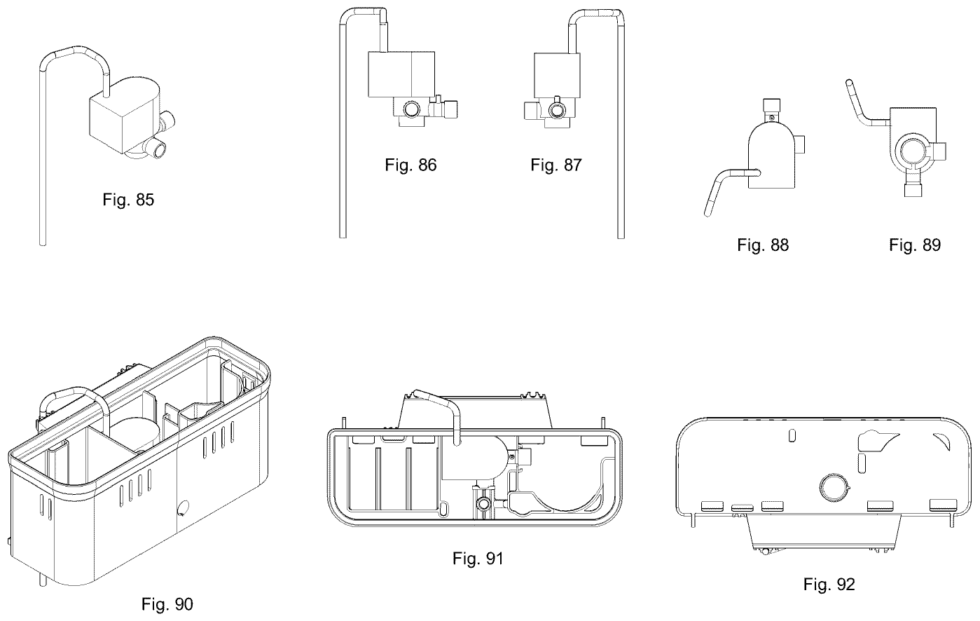

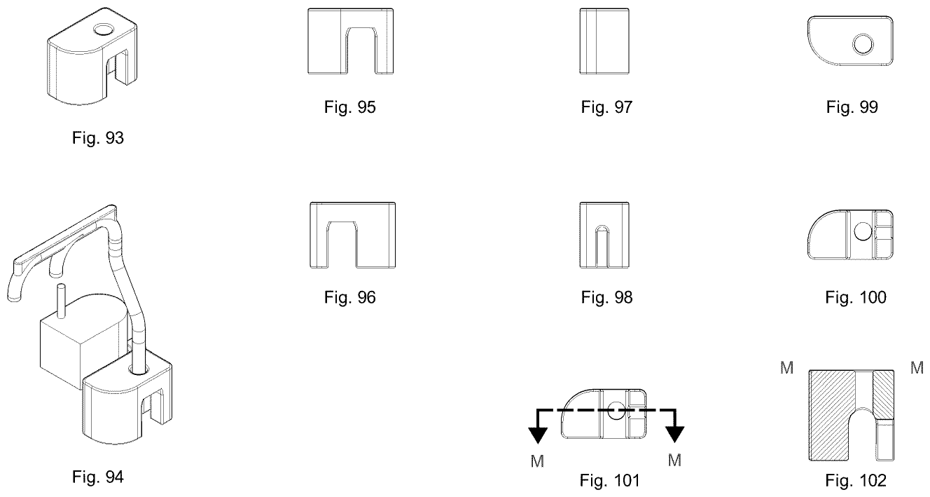

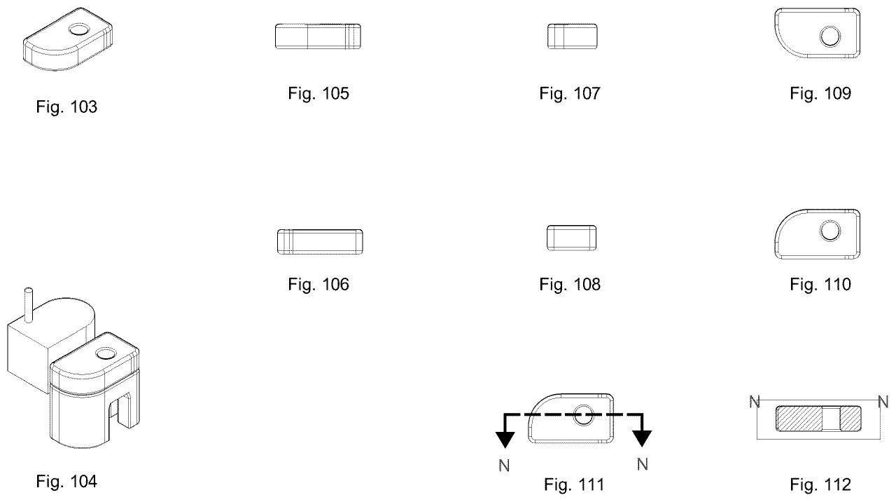

Once the premeasured food is released from optional FIG. 460 soak feeder attachment main body housing holes 272, FIG. 461 288, the food enters, and then falls down, to follow the same path through the FIG. 447 box filter w/c.o.d. bottoms' internal cyclonic pre-soak food and top-off water pre-release chamber 158, FIG. 36 252, FIG. 40 256, before reaching FIG. 1 box filter w/c.o.d. diffuser bottom's submerged FIG. 37 top-off, water fill, additive, and food pre-soak release port 254, FIG. 41 258, as the added top-off fill water does prior to its release into FIG. 466 main tank/habitat chamber containment area 340, FIG. 486 438, FIG. 487 440, FIG. 488 442.

Added science: The swim bladder, or air bladder, is a buoyancy organ which most fish have. The swim bladder is located in the body cavity of the fish, and is derived from an out-pocketing of the digestive tube. This organ contains oxygen and functions similarly to a hydrostatic, or ballast.

The organ also enables fish to maintain their depth within the main tank/habitat chamber containment area water column, without upward floating or the opposite, a slow sinking effect.

By using the submerged soak feeder features of FIG. 1 the box filter w/c.o.d. diffuser and cyclonic high flow bioskimmer, the aquarist can now reduce fluctuations in the buoyancy of their fish by eliminating the top water feeding habits which in many cases, causes the submerged feeding animals, (which normally feed mid-level or on the bottom), to gulp in excessive air when they are higher up in the water column and surface feeding. This extra air can then enter their bladders, become trapped, and cause buoyancy issues and stress.

By submerging and pre-soaking any added food prior to its delivery into the main habitat area, and the food being offered out to these types of lower feeding creatures, the overall health and nourishment of the animals is better guaranteed.

There is also the inherent benefit of having any food or additive which arrives pre-submerged into the main tank/habitat chamber containment area circulate down lower into the water column where most animals tend to feed. This being a much more practical application for feeding than having the food or additive float across the water column top surface where it can rapidly bypass the main tank/habitat chamber containment area altogether, and be introduced into top surface water skimmers, corner boxes, and/or other standard tank filters.

Referring back to FIG. 449 dual head system pump with venturi valve 170, water flow is also being diverted out through the front of FIG. 441 box bottom enclosure housing 122 as it feeds FIG. 442 keyed front mounting port 128, which is designed, keyed and sized to hold a variety of FIG. 474 keyed bi-directional powerhead manifold embodiments 388, FIG. 475 390, FIG. 477, 478, 479, 480, which can FIG. 451 key-lock in a level position 198, FIG. 452 206, or FIG. 480 rotated 360 degrees 410, as well as the ability of FIG. 442 keyed front mounting port 128, to hold other aftermarket powerhead assemblies.

Connected to FIG. 474 keyed bi-directional powerhead manifold 388, FIG. 476 392, 394, FIG. 477 396, FIG. 400 and FIG. 479 404, FIG. 480 408, are FIG. 477 adjustable powerhead manifold flow nozzles 398, FIG. 478 402, FIG. 479 406, and FIG. 480 410, that can FIG. 480 rotate 360 degrees 410, on their own, along with swiveling off at a multitude of offset directions which enable them to provide FIG. 466 main tank/habitat chamber containment area 340, with FIG. 466 incoming water flow 338, directed in the most preferred directions for the optimal support of fish, plant and coral growth.

By scaling down the overall system to a more user-friendly level, the average aquarist can now have access to one of the most powerful large scale filtration system platforms, and also acquire it in a host of versions which readily support the much smaller (nano type) mini aquatic environments that are so popular today.

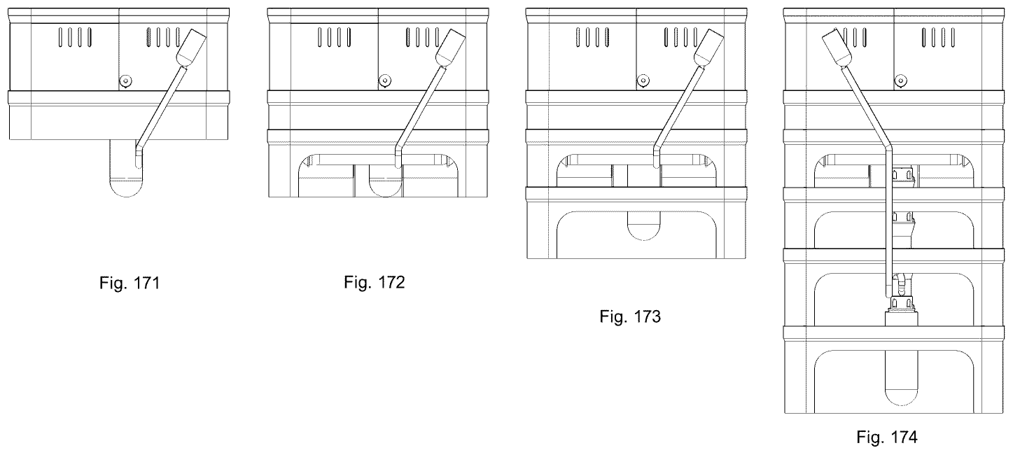

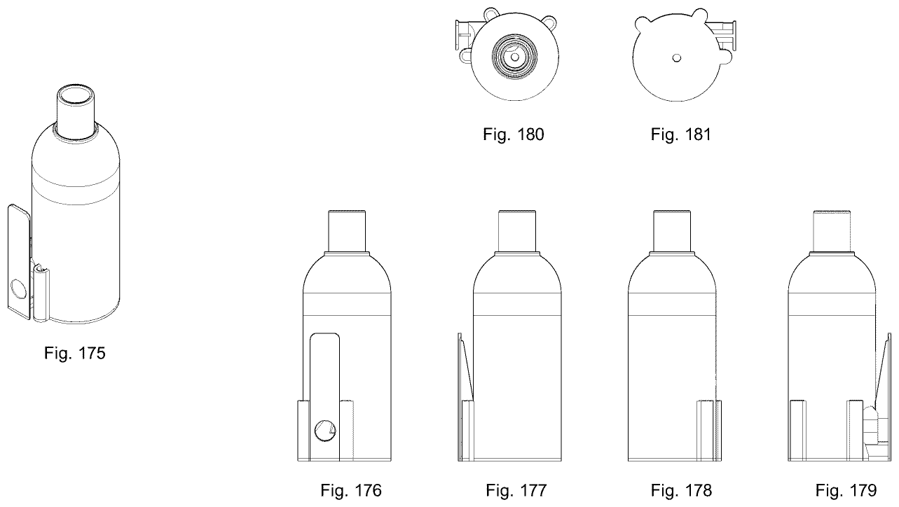

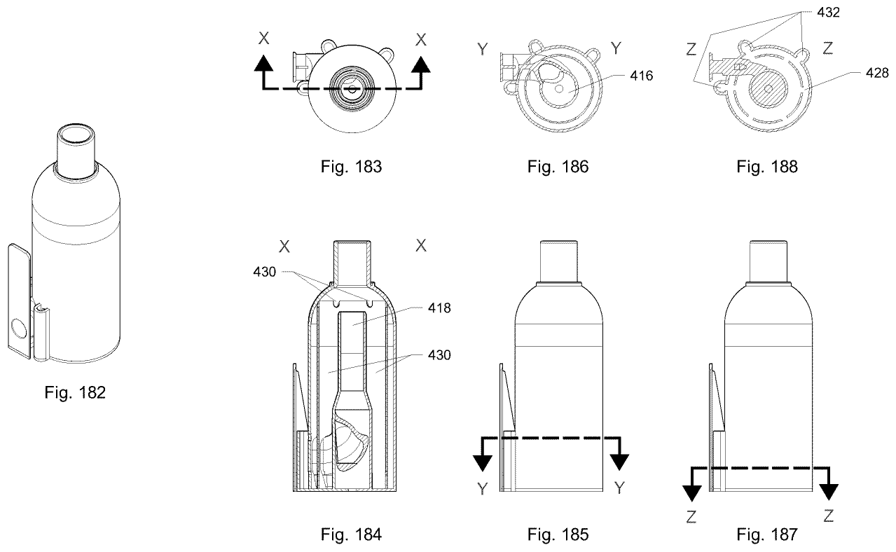

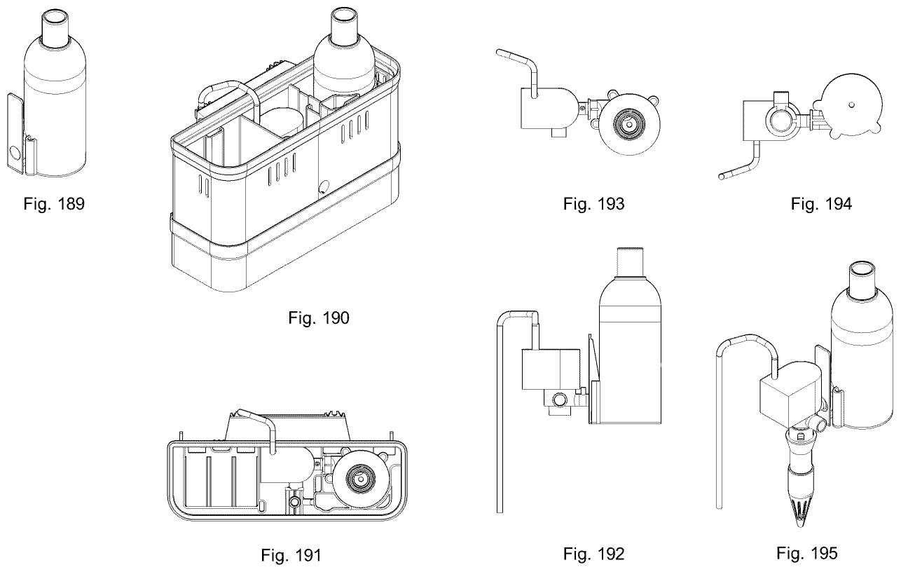

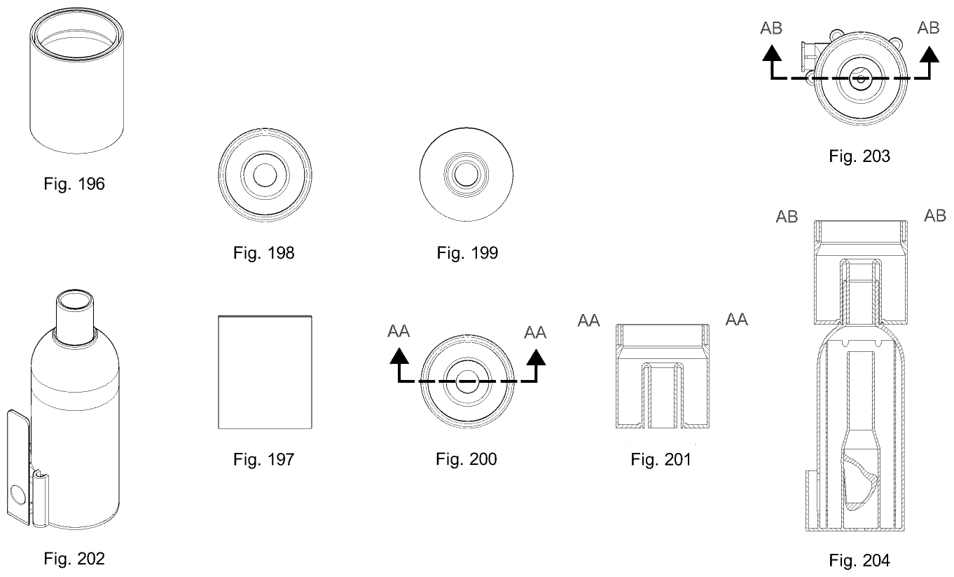

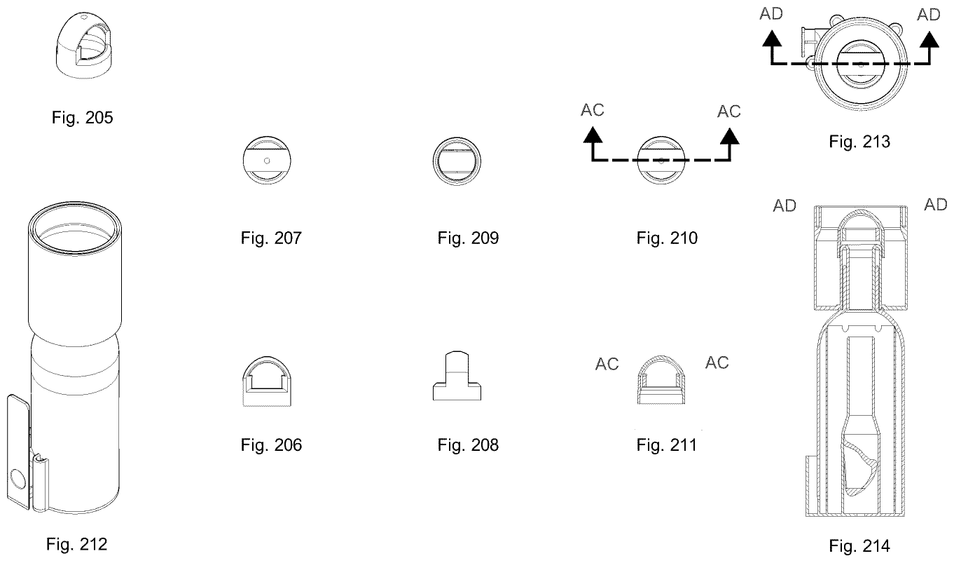

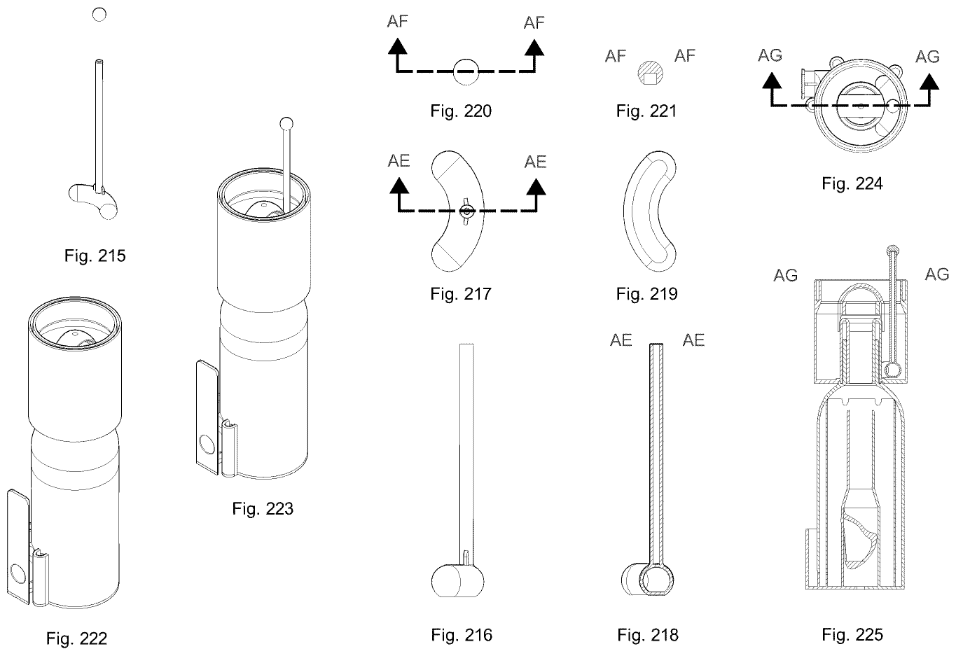

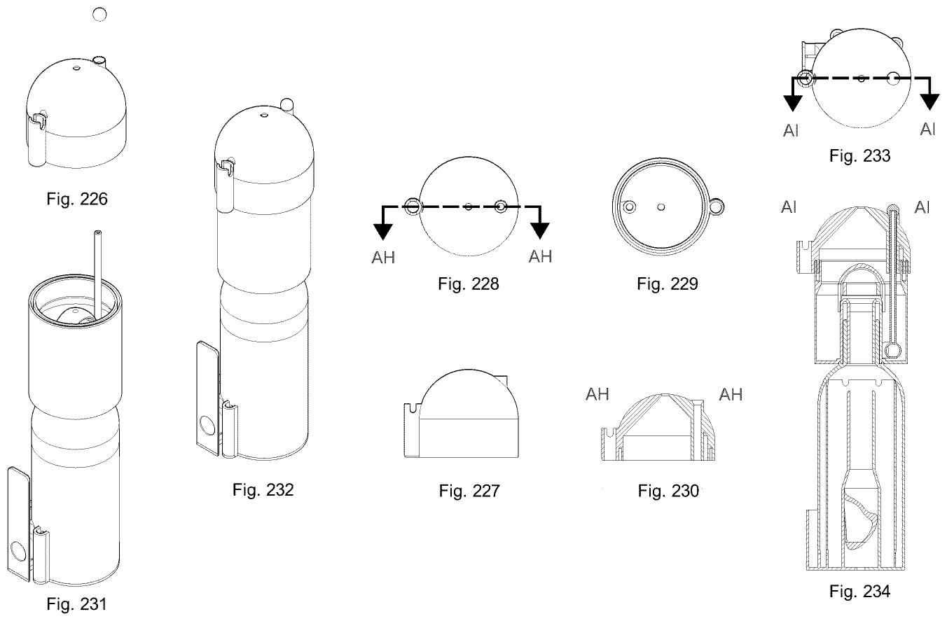

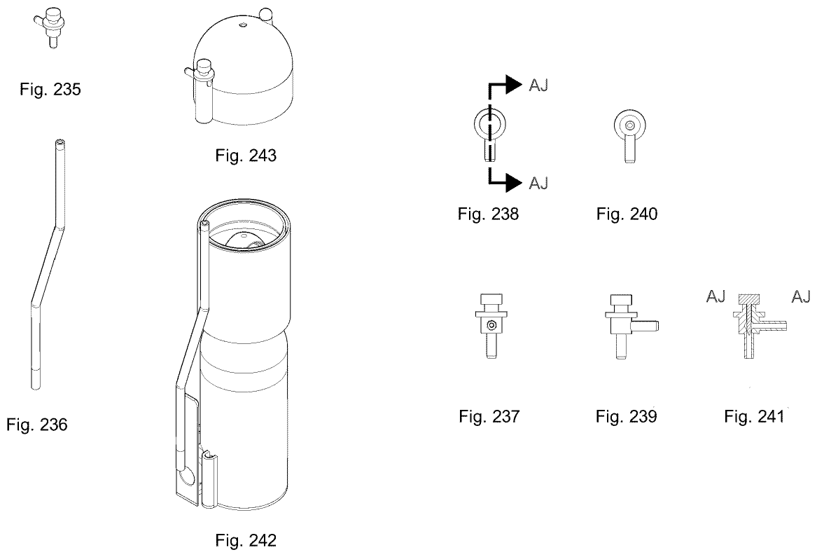

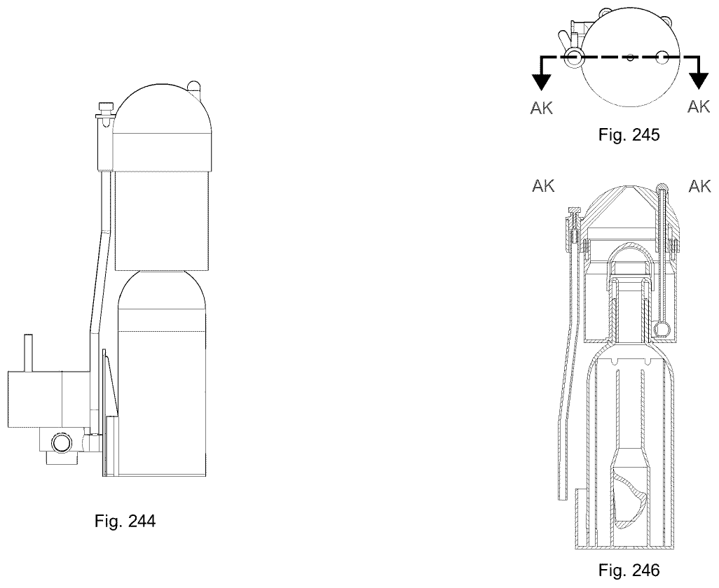

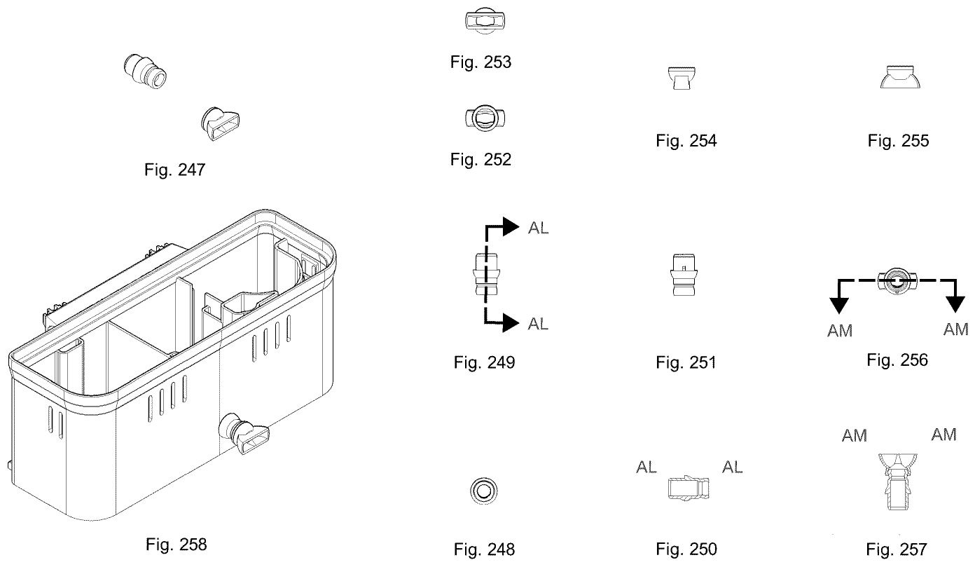

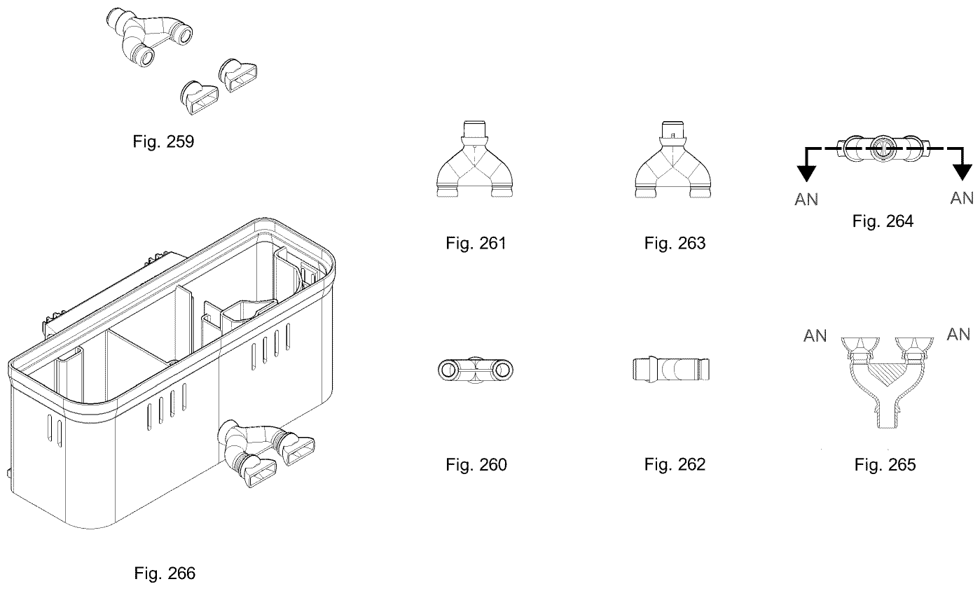

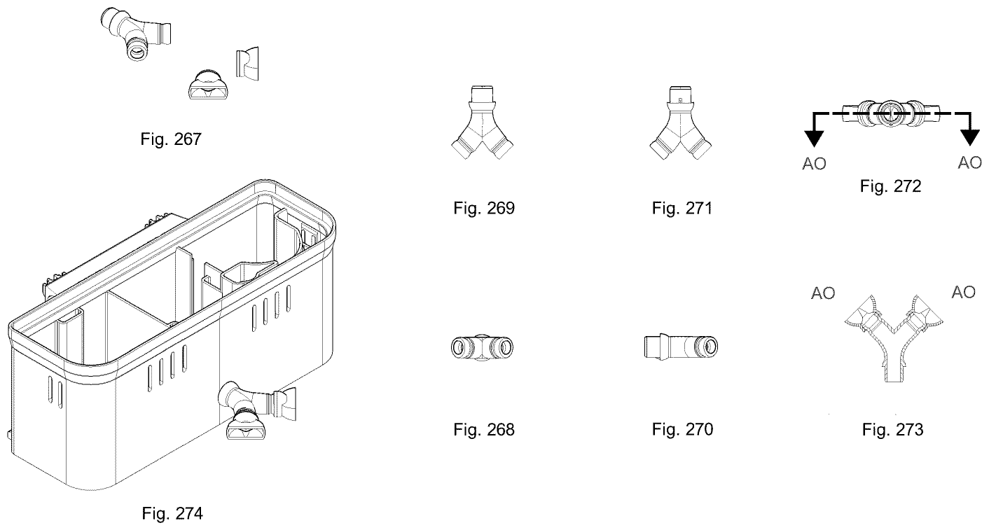

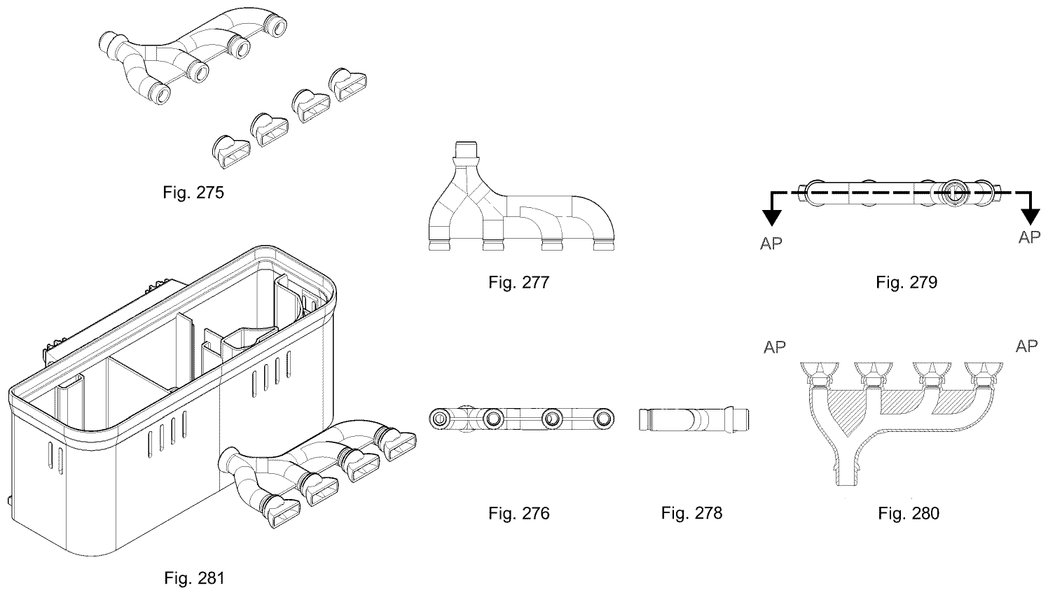

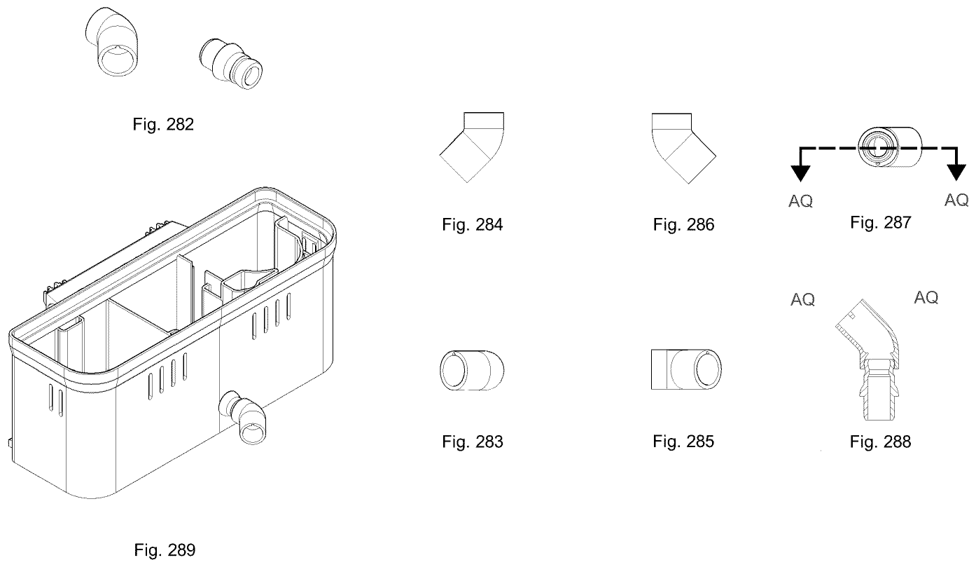

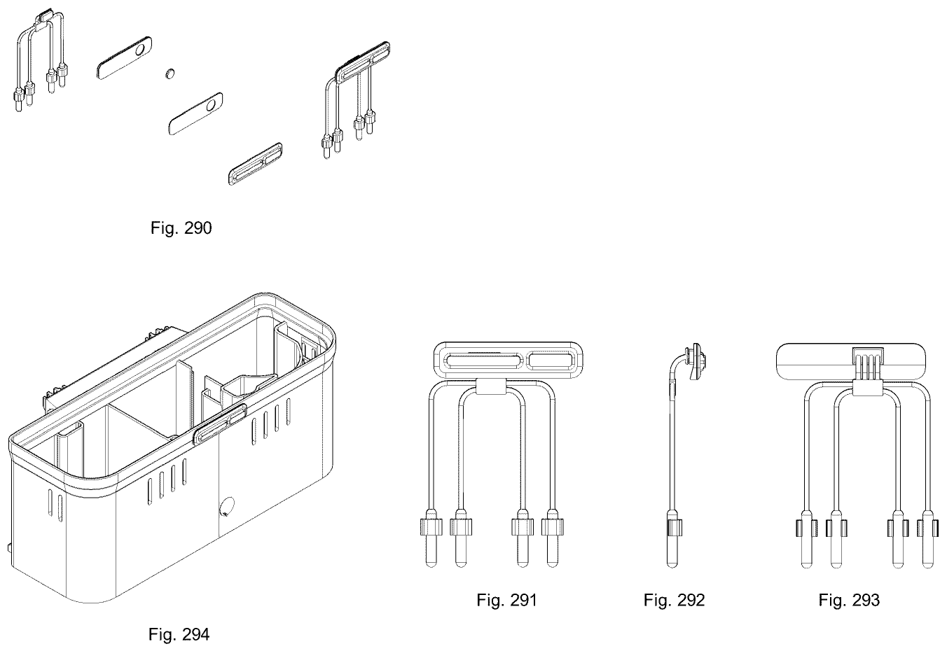

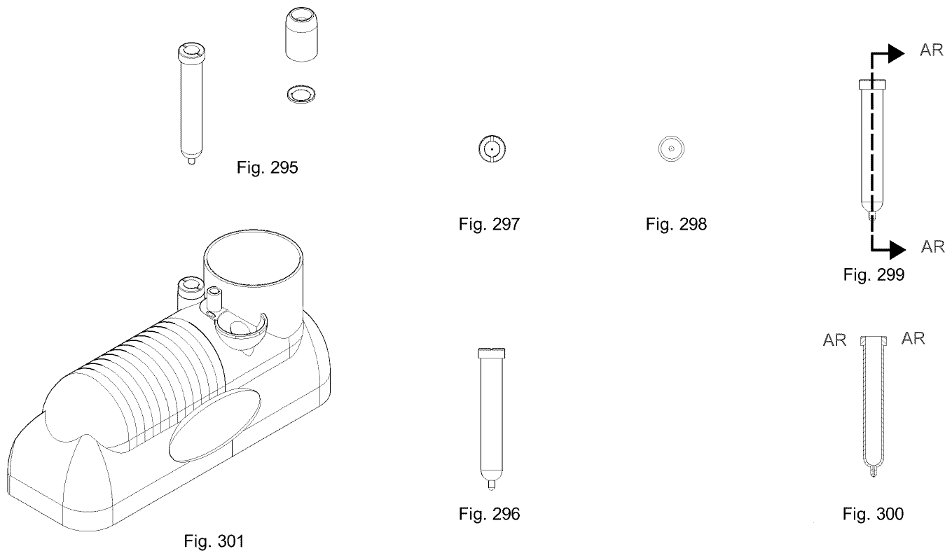

Modern “nano” environments may start off in as low as the five to ten-gallon range. Incorporating a FIG. 1 box filter w/c.o.d. diffuser and high flow cyclonic bioskimmer provides the end user with the ability to switch from FIG. 171 smaller sized unit, to a larger sized unit FIG. 172, 173, 174, as their overall filtration system and water volumes may vary.

Nearly hands free to operate, and produced with state-of-the-art construction and design, the box filter w/c.o.d. diffuser system includes all the built-in technology, hardware and science needed for the feeding, monitoring, top-off and internal transfer of water in the support of any plant or animal kept in a freshwater, brackish-water or saltwater containment area such as a pond, stream, sump tank, display tank, refugium and/or aquarium.

Referring back to FIG. 441 top surface water skimming slots 124, FIG. 466 340, which are capable of providing non-stop surface skimming twenty-four hours a day. This action in turn, continuously removes all the contaminants trapped within the upper layers of the FIG. 466 main tank/habitat chamber containment area 340, water column.

This process of continual water transference prevents any of the normal buildup of harmful contaminants such as algae blooms, nitrites, nitrates, PH imbalances, detritus and other biological waste that regularly accumulate within FIG. 466 main tank/habitat chamber containment area 340, and which can often offset the long-term stability of the water quality within the entire system.

The gain of aquatic load, (or cycle), as it takes place over time, frequently makes the FIG. 466 main tank/habitat chamber containment area 340, itself, detrimental to the plants and animals that reside within it.

Once the FIG. 1 box filter w/c.o.d. diffuser and high flow cyclonic bioskimmer system, completes its initial processing of the FIG. 466 main tank/habitat chamber containment area 340, and just as fast as the FIG. 469 dual head system pump w/venturi, can return the water flow back and into the box filter w/c.o.d. diffuser via FIG. 441 top surface water skimming slots 124, FIG. 466 340, FIG. 449 deep pull supply down pipe extension 180, FIG. 466 336, one of the FIG. 474 keyed bi-directional powerhead manifold assemblies 388, FIG. 476 392, 394, FIG. 477 396, FIG. 478 400 and FIG. 479 404, FIG. 480 408 can be mounted to provide the appropriate water intake and directional outflow within the FIG. 466 main tank/habitat chamber containment area 340.

Although the FIG. 1 biological trapping filter w/c.o.d. diffuser and cyclonic high flow bioskimmer is fully capable of running as a stand alone unit, it also comes equipped with additional accessories and features which make it extremely unique and versatile in a varied array of applications.

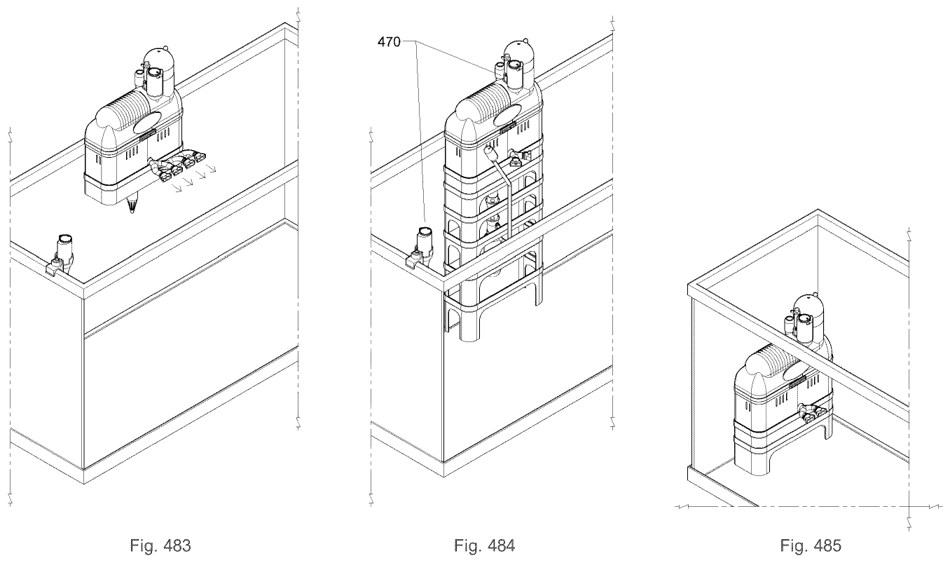

Next by clipping on the FIG. 448 box elevation stand w/submersible light 162 to the bottom of FIG. 447 box elevation stand w/c.o.d. diffuser 156, the aquaculturist can increase the overall elevation height of the filtration unit whether it be FIG. 466 hanging from an external wall 344, FIG. 483, FIG. 484, or free standing on the bottom in place FIG. 485.

With the use of FIG. 458 remote control 250 which comes standard with the FIG. 448 box elevation stand w/submersible light 162, FIG. 458 248, the aquaculturist can add additional internal lighting to the habitat area in a vast assortment of light spectrum configurations that mimic natural sunlight and/or moonlight patterns, these spectrum settings can then be fine tuned to support the aquaculturists' individualized selection of plant and animal inhabitants based on their region of origin or that region's current sun and moon cycles as well as current weather patterns.

Next by clipping on FIG. 454 box elevation stand/(s) regular with hide and play zones 216 and/or FIG. 455 box elevation stand/(s) tall with hide and play zones 220, to the bottom of the FIG. 447 box elevation stand w/c.o.d. diffuser 156 or to FIG. 448 box elevation stand w/submersible light 162, the aquaculturist can quickly (stack) or increase the overall elevation height of the filtration unit to match whatever depth the unit is placed in. This specific feature allows for the filter's adaptation into literally any new, pre-existing or future habitat filtration system whether the unit itself be hung from an external wall, or mounted free standing on its own when placed on the bottom of the habitat chamber.

With the addition of submerged sub-frame lighting and elevation stands, the aquaculturist can easily achieve any filter depth elevation requirement while at the same time providing underwater background lighting, versatility, and additional protective living spaces to the inhabitants of the aquatic environment.

Referring next to added dosing: incredibly, FIG. 1 box filter w/c.o.d. diffuser and cyclonic high flow bioskimmer comes with FIG. 463 doser additive tube 324 and FIG. 463 doser additive tube seal 326 and FIG. 463 doser additive tube cap/stand 328 which allows for the “mini-stream” or “trickle-in” affect of additives like liquid calcium or periodic treatments of liquid copper. Positioned high on the top of FIG. 435 box top enclosure housing 102 and just behind FIG. 439 manual soak feeder attachment 114, or FIG. electronic soak feeder attachment 118, the FIG. 463 doser additive assembly can be accessed.

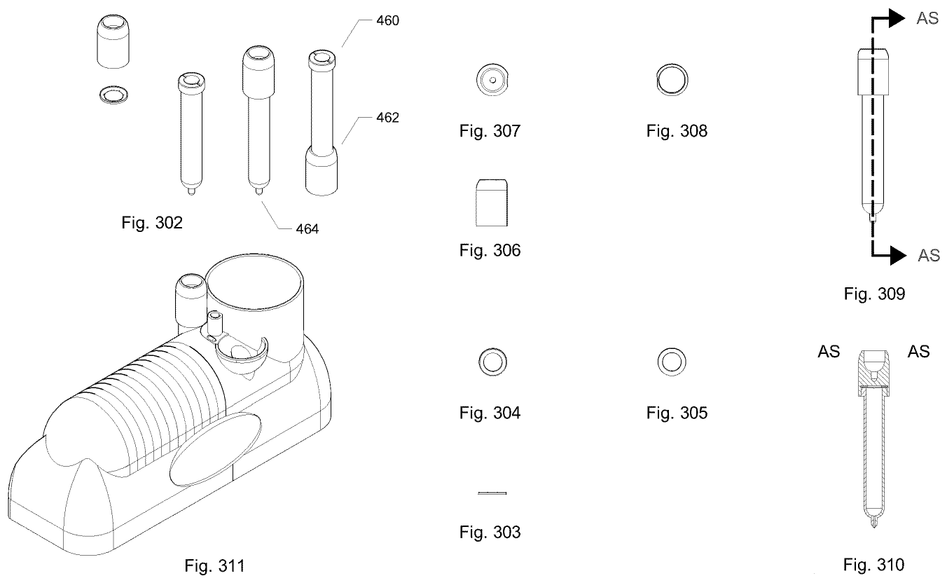

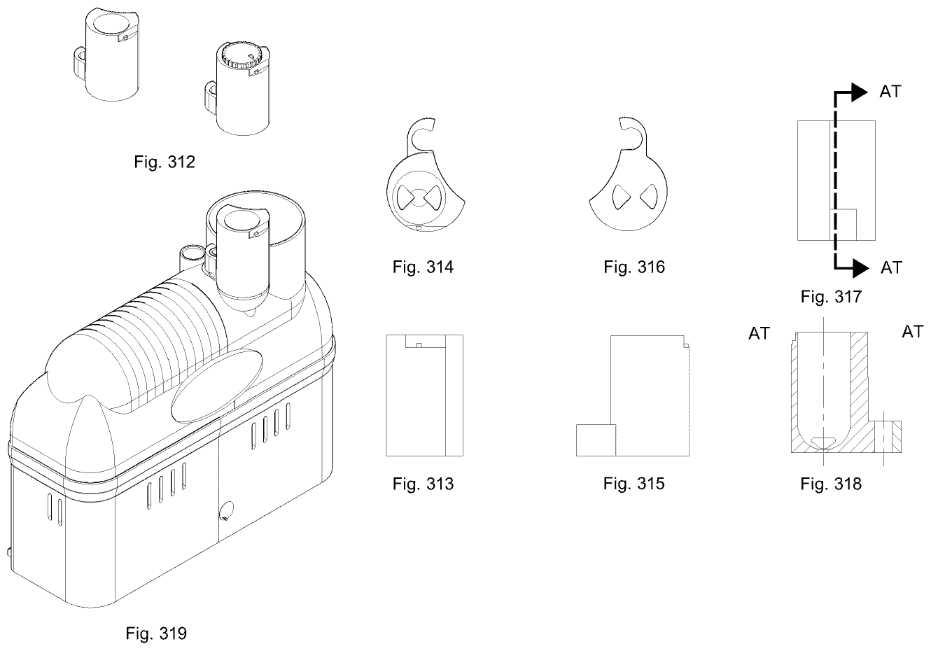

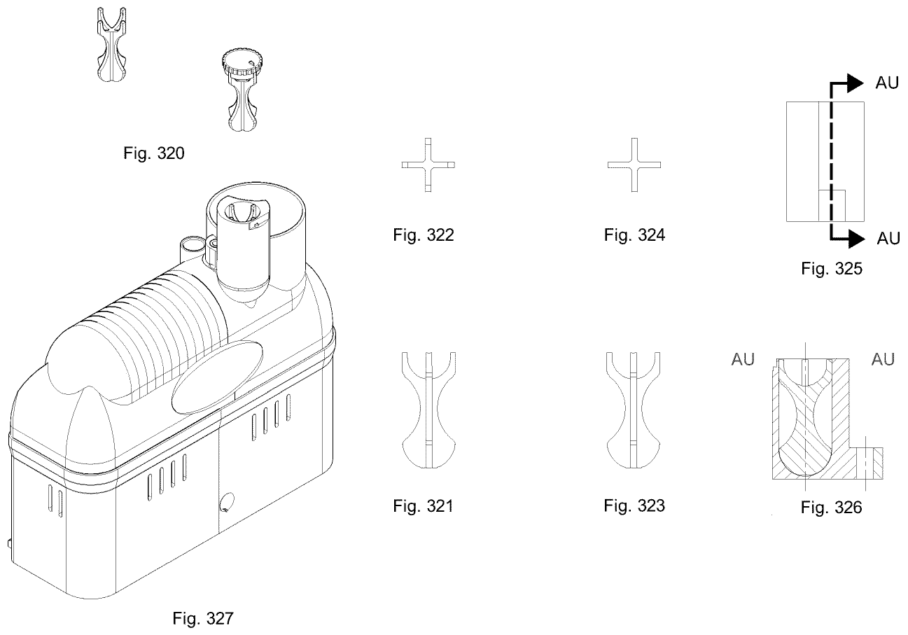

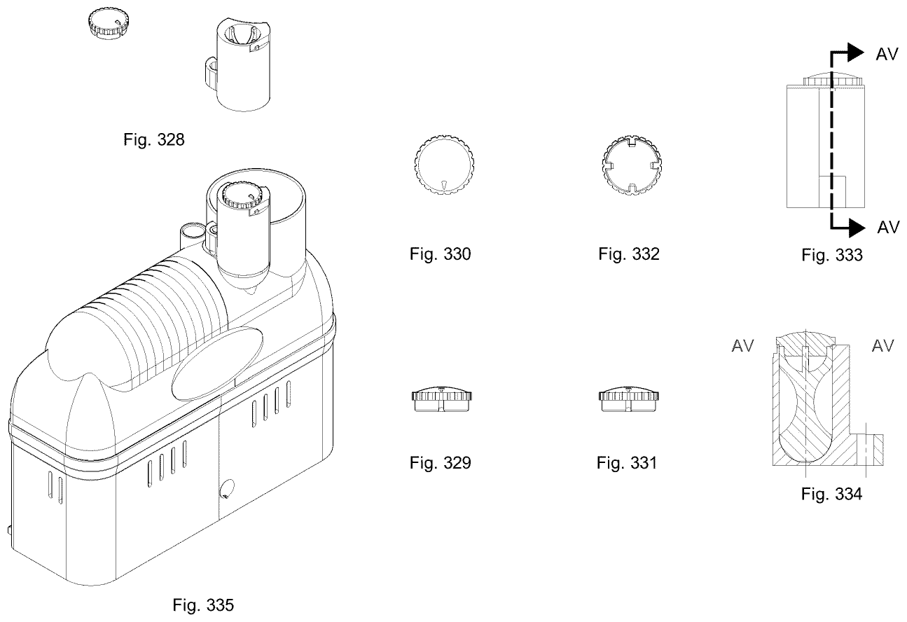

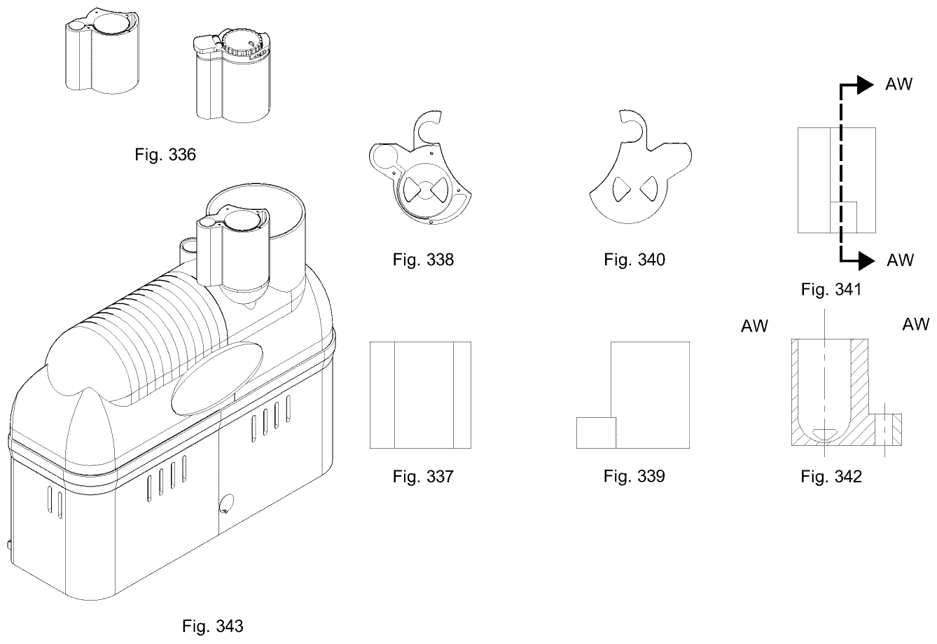

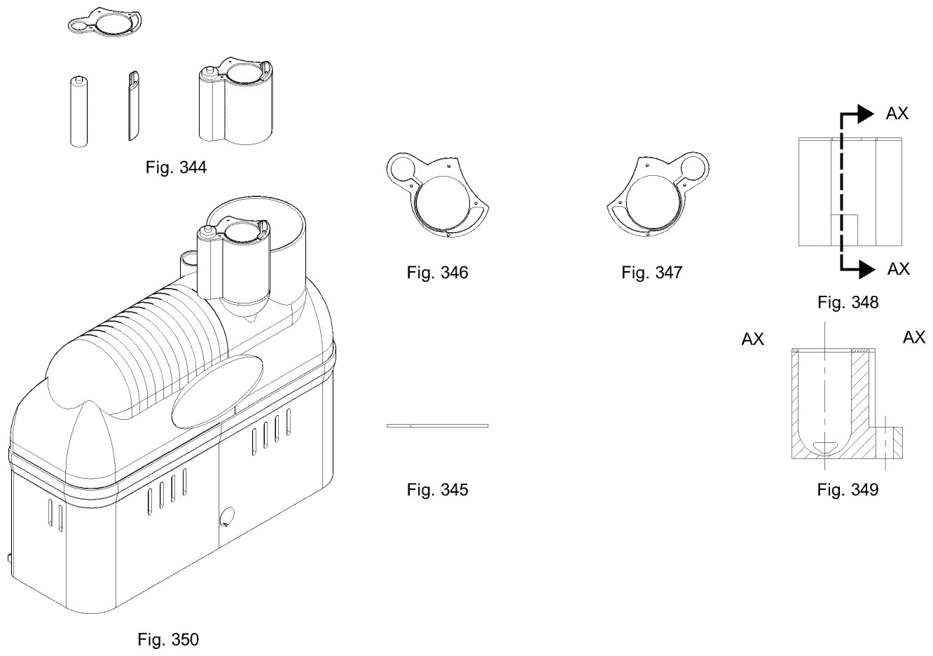

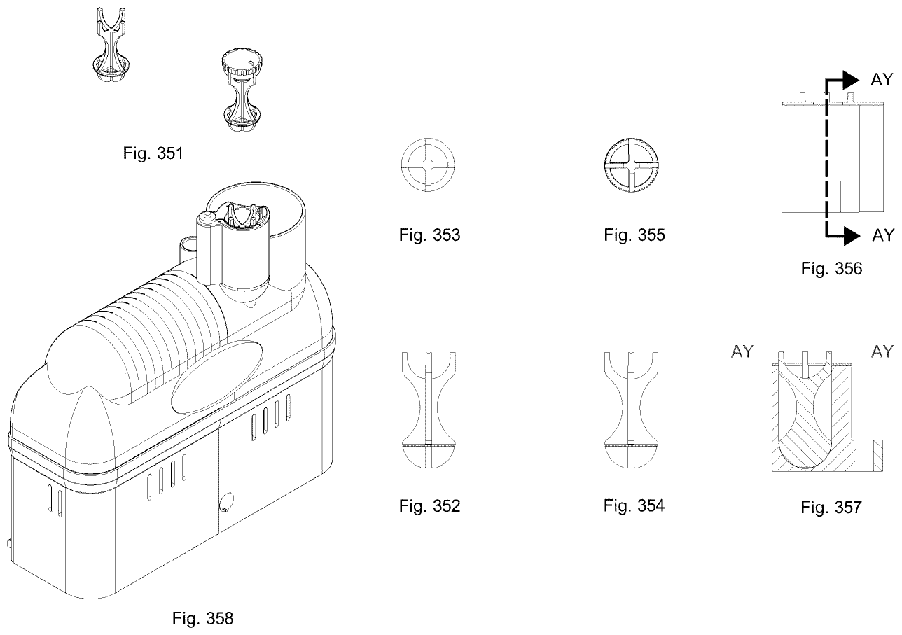

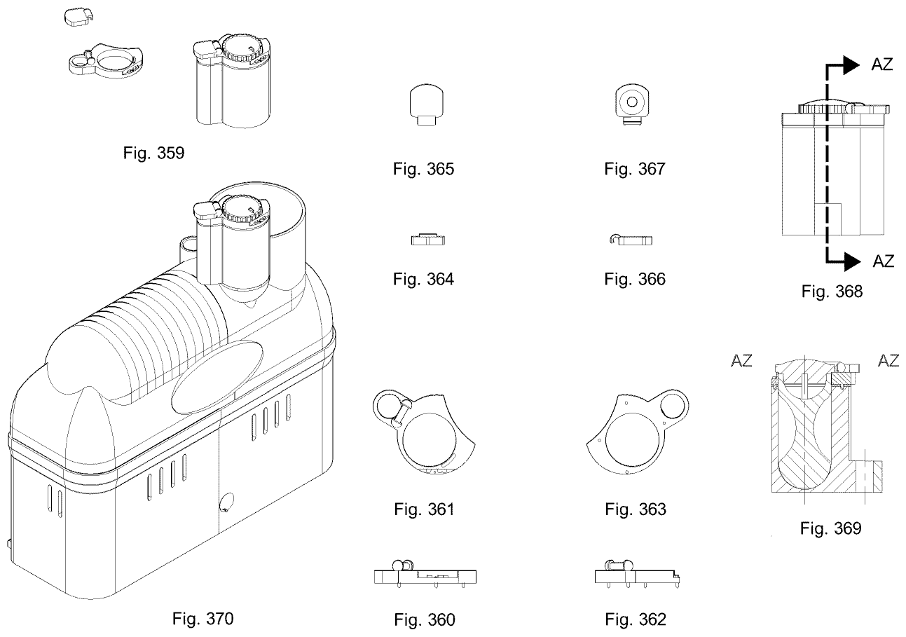

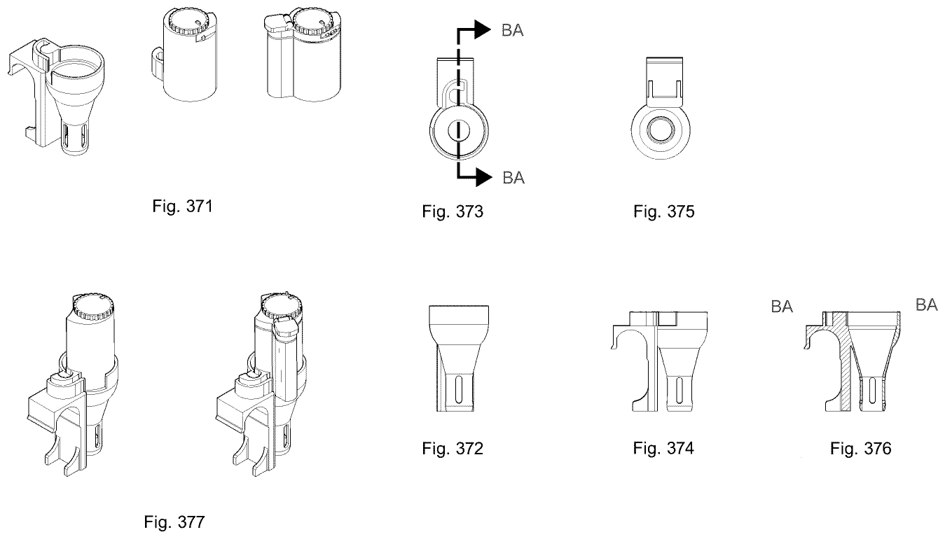

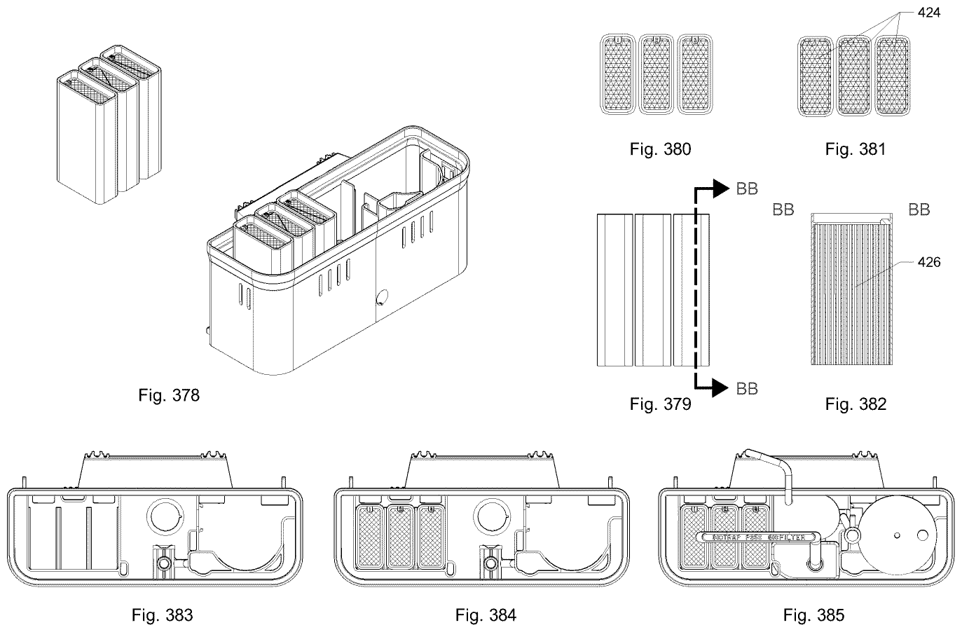

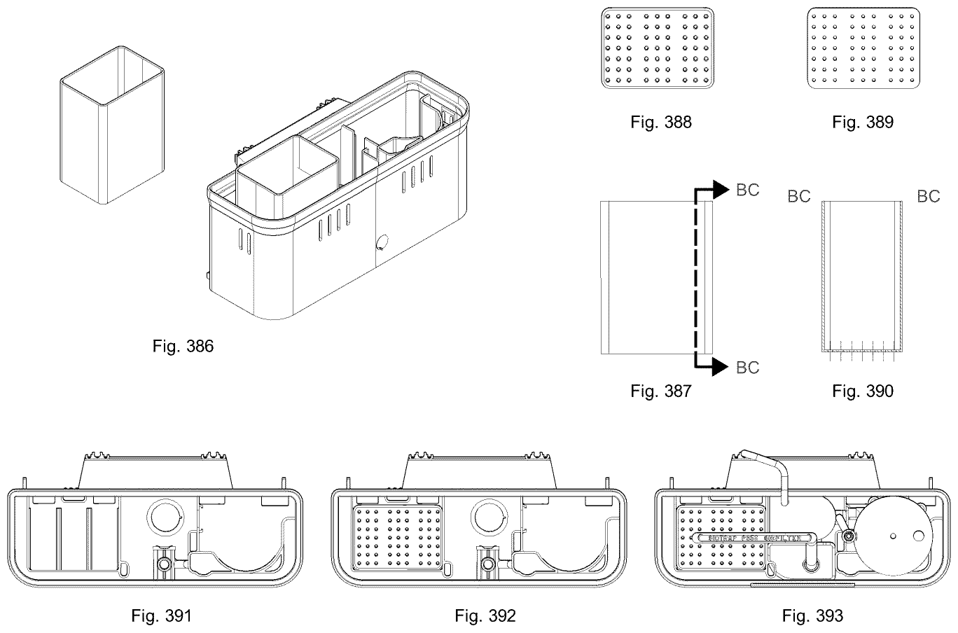

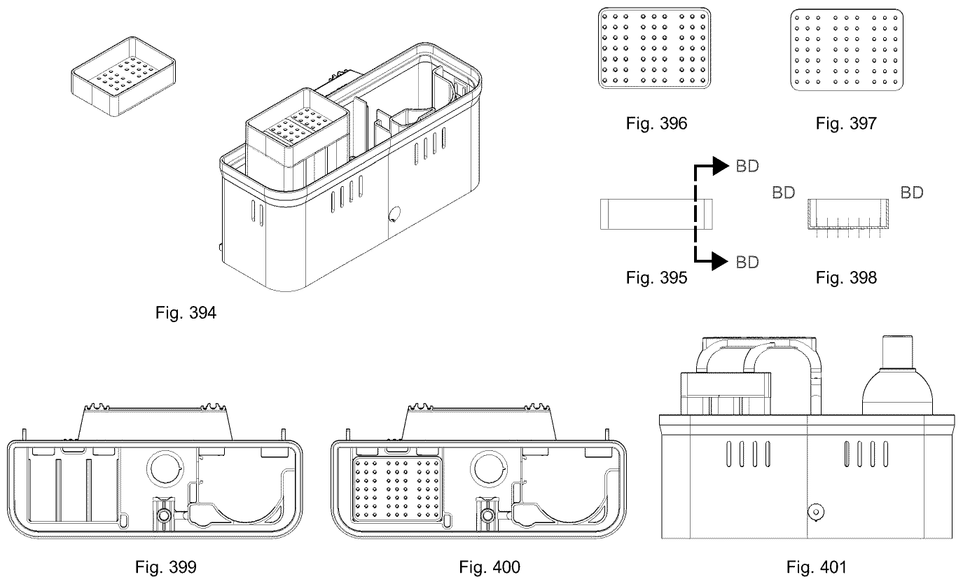

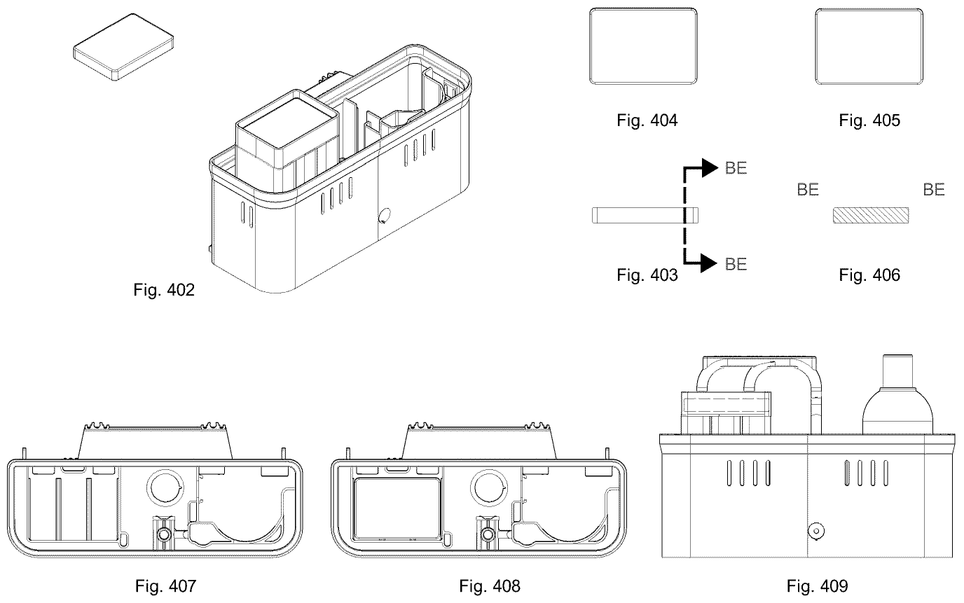

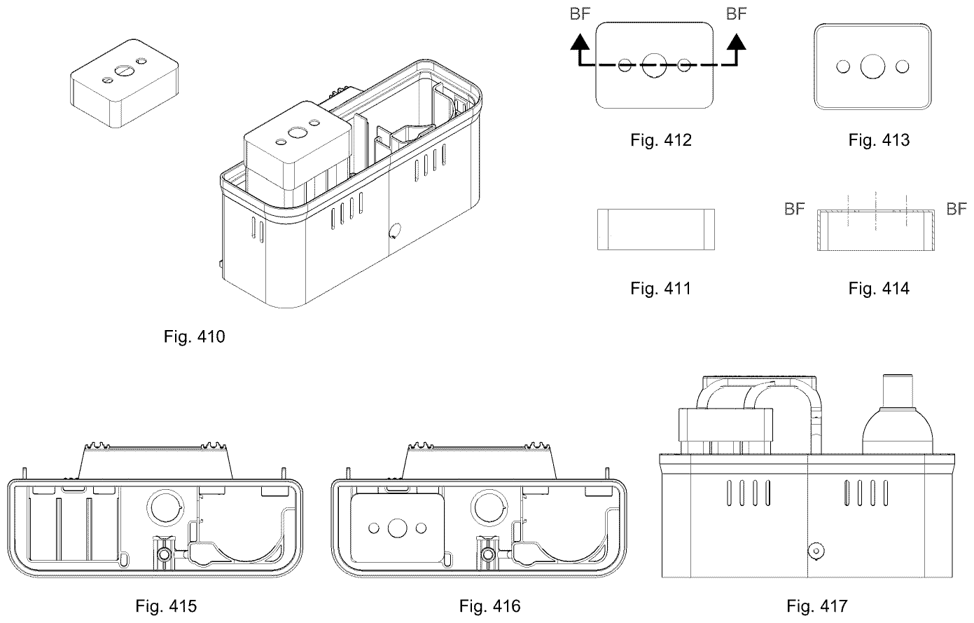

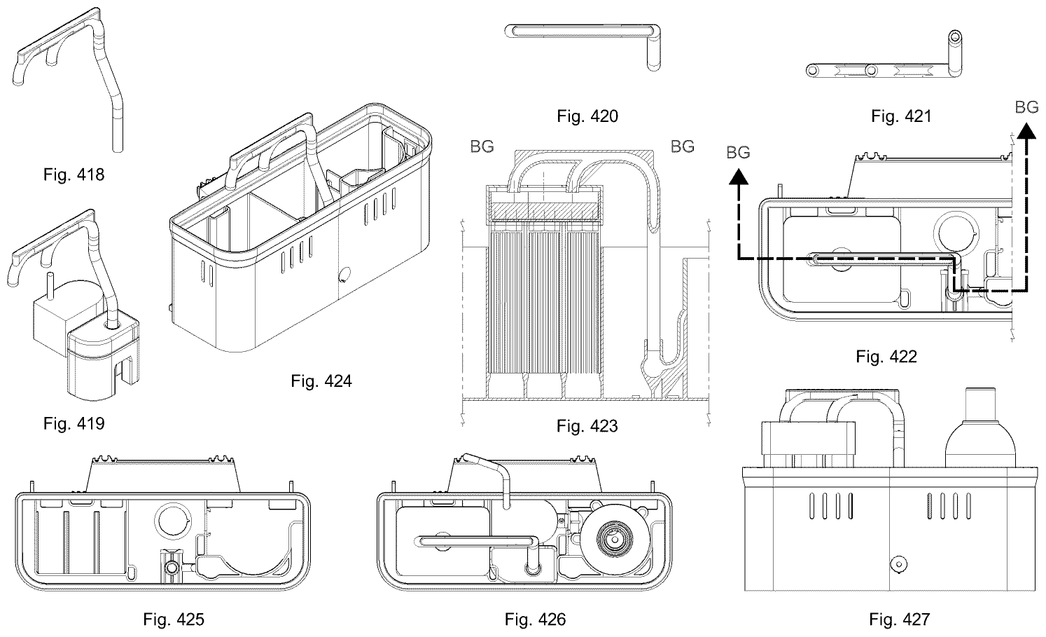

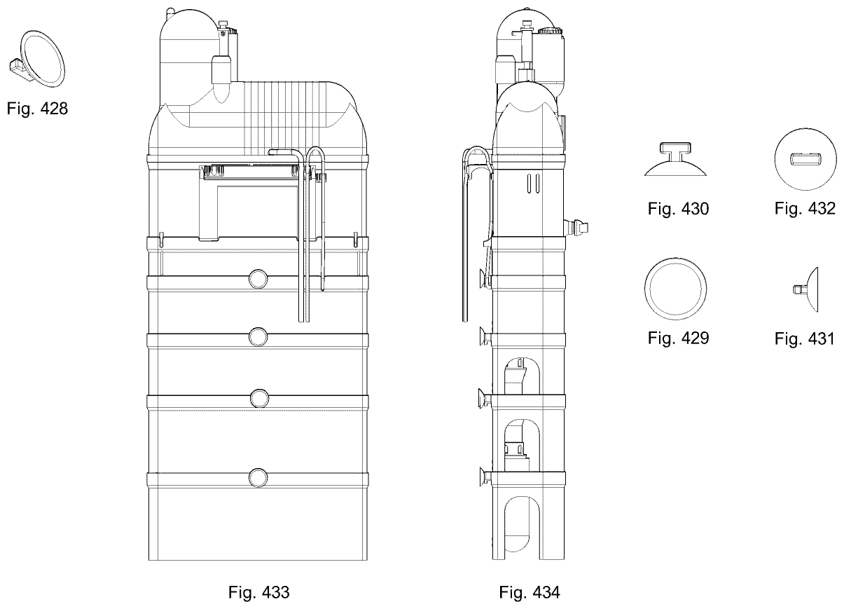

By twist/pulling up on the FIG. 463 doser additive tube cap/stand 328, the three piece assembly will rise out and free from FIG. 435 box top enclosure housing 102. Remove FIG. 463 doser additive tube cap/stand 328 with its internal FIG. 463 doser additive tube cap seal 326 and turn the pair over before setting them down on any flat surface. Now position the nippled-tip of FIG. 302 doser additive tube 454, into the back of the cap/stand so that FIG. 463 doser additive tube cap/stand 328, thus becomes a suitable stand for FIG. 463 doser additive tube 324.

Select or mix up the preferred pre-dissolved additive or liquid treatment and pour it into FIG. 463 doser additive tube 324 until it is filled to the desired level. The entire assembly can now be moved into position near the running filter. When ready to re-install the doser additive assembly, place one finger over the top of FIG. 302 doser additive tube 452 to prevent spillage as the assembly is then turned upside down.

Remove FIG. 463 doser additive tube cap/stand 328 revealing FIG. 302 doser additive tube nipple-tip 458 and set it aside. Place a finger tip over the nipple-tip and rotate the doser additive tube assembly once again so that it is returned to its original upright position.

Replace FIG. 463 doser additive tube cap/stand 328 atop FIG. 463 doser additive tube 324 and again turn the unit upside down. Depress FIG. 463 doser additive tube cap/stand 328 until it is seated and any air within the unit is expelled from the up ended nipple-tip. Right the unit (replace finger tip upon nipple-tip) and ease the combination so that the nipple-tip is directly over the port hole which resides atop FIG. 435 box top enclosure housing 102.

In one motion, quickly remove the finger tip from the nipple-tip and lower the doser assembly until it is fully seated on FIG. 435 box top enclosure housing 102. The unit uses gravity feed in a suction environment to create a continuous dripping of the liquid provided from its nipple-tip, this adds chemical filtration to the system.

By lifting off FIG. 463 doser additive tube cap/stand 328 when FIG. 463 doser additive tube 324 is fully installed, the vacuum feature is eliminated and the slow dripping trickle affect is then replaced with a very thin and speedy stream which may be used for a faster injection of liquid additives into the system.

By providing total control over any new additive and/or treatment saturation that goes on in the main habitat area, the aquaculturist can insure that no specific plant or animal is exposed to too heavy, or too high a level dose of any freshly introduced compound or treatment. This process guarantees that all introduced additives and/or treatments will not have a negative affect on any of the overall aquatic inhabitants.

Referring next to added fill: FIG. 435 box top enclosure housing 102 with built-in manual box top top-off, water fill, additive, and feeding port supports the addition of water into the habitat chamber even if the top of the aquatic environment is obstructed in some way. Merely spin away the clip-on FIG. manual or electronic soak feeder attachment 114, FIG. 440 118, which is located in front of the doser additive assembly atop FIG. 435 box top enclosure housing 102 and pour the water to be added directly into the provided FIG. 435 box top top-off, water fill, additive, and feeding port 106 there.

When adding water or “topping-off” the system, the introduced liquid travels down from FIG. 435 box top top-off, water fill, additive, and feeding port 106 and through the attached soak feeder tube, both components are located directly under FIG. 439 manual or electronic soak feeder attachment 114, FIG. 440 118 and FIG. 435 box top top-off, water fill, additive, and feeding port 106.

From the bottom of FIG. 25 box top soak feeder additive tube 458, FIG. 34 434, the flow drops down into FIG. 447 box filter w/c.o.d. diffuser bottoms' internal cyclonic pre-soak food and top-off water pre-release chamber 158, FIG. 36 252, FIG. 40 256, which is located directly below it and in the FIG. 435 Box Bottom enclosure 102. This chamber being fed directly from FIG. 22 box bottom cyclonic supply-in pipe head release port 444, FIG. 21 (Section A-A) 446, where the water is spun and mixed prior to its release from FIG. 456 submerged box bottom top-off, water fill, additive, and food release port 236, FIG. 473 384, FIG. 20 (Section A-A) 450, and FIG. 21 (Section A-A) 448.

It is here at the bottom of the filter box were the flow of added water passes from the food/water release opening and into FIG. 473 submerged elevation stand top-off, water fill, additive, and food port 384 which is located in the top of FIG. 447 box elevation stand w/c.o.d. diffuser 156.

The water path then bypasses the c.o.d. diffuser feature altogether as it moves down and out into the newly oxygen infused water that is being supplied to the water column of the habitat area. (If a FIG. 448 bottom box elevation stand w/submersible light 162 is present, the food will continue on through it via another FIG. 447 box bottom cyclonic food chamber w/lower food/water transfer port which bypasses FIG. 448 bottom box elevation stand submersible light chamber 164 completely and passes directly on, and out, and into, the newly oxygen infused water that is being supplied to the water column of the habitat chamber.)

Added Feeder: Although larger servings of food can be fed to the system manually through FIG. 435 box top top-off, water fill, additive, and food release port 106, and as mentioned before, there are the FIG. 439 manual soak feeder attachment 114 and 440 electronic soak feeder attachment 118, of which either can sit atop the FIG. 435 box top top-off, water fill, additive, and food release port 106 and just in front of FIG. 463 box top doser additive assembly, and next to FIG. 453 cyclonic bioskimmer foam collection cup lid 214 with it's attached FIG. 451 cyclonic bioskimmer foam collection cup float level indicator 202, 204.

The FIG. 460 manual soak feeder attachment, being an assembly which consists of three basic parts: FIG. 460 manual soak feeder attachment 264 (or body), FIG. 460 manual soak feeder transfer paddle 276, and FIG. 460 dual soak feeder dispenser body cap 266.

There is also the optional FIG. 462 top-off, water fill, additive, and feed tank wall clip 318 which allows FIG. 460 manual soak feeder attachment 264, FIG. 462 320 or FIG. 461 electronic soak feeder attachment 282, 296, 298, 302, 308, FIG. 462 322, to be mounted separately from the filter and all on their own. In addition, there are several other FIG. 439 manual soak feeder attachment 114 and 440 electronic soak feeder attachment 118 filter applications shown on FIG. 484 470, FIG. 486 472, 474, FIG. 487 476, 478, FIG. 488 478, 480.

The body assembly of the FIG. 460 manual soak feeder attachment 264 is designed to clip-on and rest upon the FIG. 435 box top top-off, water fill, additive, and food release port 106. By removing FIG. 460 dual soak feeder dispenser body cap 266 from FIG. 460 manual soak feeder attachment 264, it is then possible to pour food directly into FIG. 460 manual soak feeder attachment body 278 and FIG. 460 manual soak feeder transfer paddle 276 combo unit until the body is nearly full.

Replace the FIG. 460 dual soak feeder dispenser body cap 266 so that it clicks in place on FIG. 460 manual soak feeder transfer paddle 276 and then turn FIG. 460 dual soak feeder dispenser body cap 266 side to side, this allows for the inner-spin of FIG. 460 manual soak feeder transfer paddle 276 inside.

With each turn of FIG. 460 dual soak feeder dispenser body cap 266, or (with FIG. 461 electronic soak feeder and its power selector stationed at feed cycle one or two being similar 304, 306), FIG. 460 manual soak feeder attachment body 278 dispenses a partial serving of food from FIG. 460 manual soak feeder release ports 272 which are centrally positioned in FIG. 460 manual soak feeder attachment body bottom 278. Once released from the bottom of FIG. 460 manual soak feeder release ports 272, the food enters and then falls down through FIG. 25 box top enclosure housing cover cyclonic soak feeder tube 458, (once released, the food follows the same path as the added fill water did previously).

It is here at the bottom of 435 Box Bottom enclosure housing 102 were the flow of added water passes from its box bottom top-off, water fill, additive, and food release port and into the FIG. 473 submerged top-off, water fill, additive, and food port 384 which is located in the top of FIG. 447 box elevation stand w/c.o.d. diffuser 156.

The food arrives in a cyclonic mixing chamber being fed directly from FIG. 22 cyclonic supply-in pipe head release port 444, FIG. 21 (Section A-A) 446, where the food and water is spun and mixed prior to its release from 7 submerged elevation stand w/c.o.d. diffuser top top-off, water fill, additive, and food port 236, FIG. 473 384, FIG. 20 (Section A-A) 450, and FIG. 21 (Section A-A) 448.

The food path then bypasses the c.o.d. diffuser feature altogether as it moves down and out into the newly oxygen infused water that is being supplied to the water column of the habitat area. (If a FIG. 448 box elevation stand w/submersible light 162 is present, the food will continue on through it via another FIG. 447 submerged elevation stand w/light top top-off, water fill, additive, and food port 158 which bypasses FIG. 448 bottom box elevation stand submersible light chamber 164 completely and passes directly on, and out, and into, the newly oxygen infused water that is being supplied to the water column of the habitat chamber).

Referring next to control: The features of FIG. 1 box filter w/c.o.d. diffuser and cyclonic high flow bioskimmer go on and on. With the addition of FIG. 450 box top high flow cyclonic bioskimmer/skimbob/tidal air control valve 190, FIG. 467 350 and FIG. 449 box top high flow cyclonic bioskimmer/skimbob/tidal air control valve tubing 176, FIG. 467 352, that is secured in place on FIG. 469 box top high flow cyclonic bioskimmer/skimbob/tidal air control valve air-tube venturi connection nipple 364 which is located on the venturi side supply flow nozzle head of FIG. 449 469 dual head system pump w/venturi 178, FIG. 469 366, and then runs up through the entire unit until it finally plugs onto the bottom connection of FIG. 467 box top high flow cyclonic bioskimmer/skimbob/tidal air control valve bottom nipple 350, this makes it possible for any aquaculturist to manage several different aspects of the habitat chamber's “quality of life” with the simple turn of a knob.

Referring next to added flow: The main function of FIG. 450 box top high flow cyclonic bioskimmer/skimbob/tidal air control valve 190 is to “increase or decrease” the volume of the air that is being fed into FIG. 469 box top high flow cyclonic bioskimmer/skimbob/tidal air control valve air-tube venturi connection nipple 364 which is located on the venturi side supply flow nozzle head of FIG. 469 dual head system pump w/venturi 366. By turning FIG. 467 box top high flow cyclonic bioskimmer/skimbob/tidal air control valve knob 350 clockwise FIG. 450 box top high flow cyclonic bioskimmer/skimbob/tidal air control valve 190 begins to close (this equals less air), and by turning it counterclockwise, the valve begins to open (this equals more air).

Any injection of air from FIG. 450 box top high flow cyclonic bioskimmer/skimbob/tidal air control valve 190 is sent directly to the venturi side supply flow nozzle head of FIG. 469 dual head system pump w/venturi 366 where it is then injected into FIG. 450 cyclonic high flow bioskimmer filter body 194, FIG. 467 354, FIG. 469 366, which resides under FIG. 435 box top enclosure housing 102. This action in turn determines the amount of air which is made available for the FIG. 447 box elevation stand w/c.o.d. diffuser 156, FIG. 450 184, FIG. 451196, FIG. 452 210, and FIG. 453 212, injection process to take place and in response, its natural release of diffused oxygen mist into the habitat chamber area. (more oxygen equals more diffused oxygen release, less oxygen, equals less diffused oxygen release).

By increasing or decreasing the oxygen intake provided to the system by FIG. 450 box top high flow cyclonic bioskimmer/skimbob/tidal air control valve 190, the positive head pressure of FIG. 469 dual head system pump w/venturi 366 can also be adjusted, an affect which causes the overall water flow being delivered into the habitat chamber area from the FIG. 442 keyed front mounting port 128, or pre-selected FIG. 443 keyed bi-directional powerhead manifold embodiments 136, FIG. 444 142, FIG. 445 148, FIG. 446 152, FIG. 476, 477, 478, 479, 480, or other aftermarket powerhead attachments, to also increase or decrease in tandem the FIG. 469 dual head system pump w/venturi 366 supply flow and thus raise or lower the head pressure at FIG. 468 356, and FIG. 476 keyed bi-directional powerhead manifold embodiments, 477, 478, 479, 480, FIG. 477 adjustable powerhead manifold flow nozzle/(s) 398.

By adjusting the water flow to faster or slower in this way, the aquaculturist can cause a faster effect or (rising tidal simulation) or slower effect (slack tidal simulation) scenario within the habitat chamber areas water column. There is also the option of connecting an outside air source such as an external air pump to FIG. 450 box top high flow cyclonic bioskimmer/skimbob/tidal air control valve 190 via its additional box top high flow cyclonic bioskimmer/skimbob/tidal air control valve auxiliary port connection 192.

The FIG. 190 auxiliary box top high flow cyclonic bioskimmer/skimbob/tidal air control valve port connection 192, FIG. 467 348, allows for the “supercharging” of the cyclonic high flow protein bioskimmer and c.o.d. air-injection systems.

Referring next to protein and additional particulate removal during water processing: When the box top high flow cyclonic bioskimmer/skimbob/tidal air control valve is adjusted, it also manipulates the speed in which FIG. 450 cyclonic high flow bioskimmer 194 traps and removes contaminants and proteins from the main habitat area and delivers the newly created foam concentrate which is generated by the venturi/bioskimmer injection process to FIG. 452 cyclonic high flow bioskimmer foam collection cup 208 for removal.

The more oxygen, the more c.o.d. diffusion, the shorter the system purification process time required to “turn over the entire system” or “total water volume” and to address any (rising stress, death, ammonia or nitrate spikes) that may occur within the system as it runs over time. If a sudden load or spike should take place, increased air injected into the system will automatically enter the box filter into a “load equalizing” or “spike-leveling” mode of “cyclelessness” which safeguards the entire system and its inhabitants from any such harmful contaminate buildup or spike.

Next referring to added expansion: Located on the outside lip of FIG. 473 box bottom enclosure self-leveling edge/wall slide 386 are two sets of additional FIG. 441 cable and wire harness clip-on connections 126, FIG. 457 240, for securing pump power cords, lighting cables, and air lines.

The easily accessible FIG. 457 cable and wire harness clip-on connections 240 design ensures that the aquaculturist can incorporate the filter into any of their existing habitats, or start from scratch, with the knowledge that the system they create will be organized, easy to operate, and ready for any future expansion which may be needed down the line.

With this part of the journey at completion, and the old habitat water now mechanically sponge micron screened, biologically sifted, bioskimmed of unwanted proteins, c.o.d. infused and oxygenated, chemically carbon filtered, treated with additives, and thus fully processed, the newly purified system water is then pumped via FIG. 469 dual head system pump w/venturi 366 out from the the pre-selected and adjustable front FIG. 476 keyed bi-directional powerhead manifold embodiments, 477, 478, 479, 480, FIG. 477 adjustable powerhead manifold flow nozzle/(s) 398, chosen and out into the main habitat chamber area. (Additional system configurations are shown on p. 66/68, 67/68 and 68/68).

The (BAWPS)—cycleless biologic aquatic water purification system process continues twenty-four-seven, and builds the strongest most stable, and controllable, “cycle for life”, that is available to aquatic plant and animal aquaculturist today.

Sturdy and well built, the cycleless FIG. 1 biological trapping box filter w/c.o.d. diffuser and cyclonic high flow bioskimmer will run quietly and efficiently in the background while providing all levels of aquaculturist with the piece of mind they deserve.

1. A cycleless biological trapping box filter w/c.o.d. injection and cyclonic high flow bioskimmer that provides purification and circulation to the water within any aquarium, pond, stream, tank, sump, or main tank/habitat chamber containment area and comprised of:
A box filter w/c.o.d. injection that is available to install and hang on, or free stand in, or hang onto and stand in simultaneously, in/on any existing tank, tank rim, pond bottom, pond edge, or sump bottom and/or lip;
said box filter w/c.o.d. having a window or clear port to allow for viewing of the unit's inner workings;
said box filter w/c.o.d. having a front lower portion that hangs freely over the tank wall separator and straddles the inner side of any tank rim, edge or lip, and while submerged within the main tank/habitat chamber containment area, faces forward and outward and into the main tank/habitat chamber containment area;
said box filter w/c.o.d. having a rear mounting and bracketed section that straddles just the opposite, and is located outside of the main tank/habitat chamber containment area with the unit hanging freely over the tank wall separator and facing away from any supporting tank rim, edge or lip;
said box filter w/c.o.d. having an organizational harness section for mounting power cables, dosing lines and air lines;
said box filter w/c.o.d. having a lighting system with remote control;
wherein supply water is transferred from an internal filter system dual head pump with venturi valve, and into four different internal box bottom supply-in connections simultaneously; the main pump head pipe connection feeds the pump head mounting port which is located on the inside of the box filter w/c.o.d. box bottom and is piped internally into the main out flow port which is located on the front of the box filter w/c.o.d. and designed to hold an assortment of power head assemblies; additionally that same connection feeds an offshoot pipe run which is located internally and positioned less than midway up on the inside of that same main pipe run and feeds the internal cyclonic soak feeder chamber that resides inside the box filter w/c.o.d. box bottom, additionally that same connection also feeds an offshoot pipe run which is located internally and positioned midway up on the inside of that same main pipe run and feeds the wet/dry trickle filter system; the second pump head independently feeds the front supply-in port which is located on the front face of the cyclonic high flow evaporative protein bioskimmer filter which is located opposite of the wet/dry trickle filter;
wherein processed supply water that passes from the venturi side of the dual head system pump and into the protein bioskimmer with cup, conners bridge, lid, and float level indicator and which removes all detrimental proteins from the system water before transferring the flow onto the rear box bottom floor drains where the flow reaches the lower c.o.d. diffuser compression cups before final c.o.d. release back into the main habitat containment chamber water column, this adds mechanical filtration to the system, and when combined with the c.o.d., renders any aquatic system cycleless;
said box filter w/c.o.d. having on the main tank/habitat chamber containment area side, a sequence of top surface skimming slots which allow for a continuous intake of the main tank/habitat chamber containment area water at the same rate that the internal dual head system pump with venturi supplies it, this insuring that the main tank/habitat chamber containment area never stops filtering;
flow taken into the front of the box filter w/c.o.d. by the array of top surface skimming slots is drawn through the sponge media pre-filter topped off with a second carbon media pre-filter, the pair located inside the box bottom and just below the front top surface skimming slots, before the water then travels through to the extension deep pull pipe's inflow slots where it joins up with any in-coming flow from the extension deep pull pipe strainer with sponge media pre-filter and into the supply-in of the dual head system pump with venturi;
after leaving the non-venturi pump head outlet side of the water supply-in, the unprocessed water flow is forwarded to the bio media substrate containment drip tray;
wherein processed supply water from the main pipe connection flows past a wet/dry bio media splash guard before traveling through the wet/dry carbon media pre-filter located in the wet/dry trickle drip tray and past the wet/dry water trickle drip tray itself which allows for optimal oxygen introduction into the water flow before the water passes through the chosen biotower or bacteria biomass substrate material selected and in to the rear box bottom floor drains where the flow reaches the lower c.o.d. diffuser compression cups and final c.o.d. release back into the main habitat containment chamber;
said box filter w/c.o.d. having a dosing system for introduction of chemical additives and water treatments into the system flow;

2. The apparatus of claim 1, wherein the layout comprises a series of sub-section elevation stands which provide c.o.d. injection, food dispersement, lighting and elevation control;
said apparatus of claim 2, c.o.d. sub-section elevation stand which generates and distributes c.o.d. or “compressed oxygen diffusion” into the habitat chamber and/or water column on a continual basis and assists in rendering any aquatic environment cycleless;
said apparatus of claim 2, c.o.d. sub-section elevation stand being clipped on and positioned at the bottom of the box filter where it releases all processed water from the c.o.d. diffuser compression cups after initial pre-filter processing of the water by the cyclonic high flow evaporative protein bioskimmer filter, wet/dry trickle filter system, and bio media storage drip tray substrate, or biotower bio media storage generators and back into the water column for recirculation;
said apparatus of claim 2, lighted sub-section elevation stand with remote, wherein the stand clips onto the c.o.d. sub-section (or other elevation sub-sections in any sequence), the layout comprising a clip on elevation frame/stand which allows the box filter with c.o.d. diffuser to be free standing on its own, hung on the lip, rim or edge, or hung and standing simultaneously in/on any bottom, lip, rim or edge and at varied depths in on any tank, sump or pond and provide light as well as play/hiding spots to the habitat chamber containment area;
said apparatus of claim 2, sub-section elevation stand/(s), wherein the stands clip onto the c.o.d. sub-section (or other elevation sub-sections in any sequence), the layout comprising a clip on elevation frame/stand which allows the box filter with c.o.d. to be free standing on its own, hung on the lip, rim or edge, or hung and standing simultaneously in/on any bottom, lip, rim or edge and at varied depths in/on any tank, sump or pond and provide elevation as well as play/hiding spots to the habitat chamber containment area;

3. The apparatus of claim 1, wherein the layout comprises a method for the combined use of top water pre-filtering and top surface skimming with lower water column pre-filtering, and lower water column pull skim filtering either separately or simultaneously;
said apparatus of claim 3, extension deep pull pipe bypass plug which redirects all water entering the box filter w/c.o.d. to the box bottom's front upper surface skim slots;
said apparatus of claim 3, optional keyed extension pull pipe which can replace the box bottom pull pipe bypass plug;
said apparatus of claim 3, optional extension pull pipe/(s) positioned in tandem to create a box bottom extension deep pull pipe assembly which can replace the box bottom deep pull pipe bypass plug and provide sub-surface water pull skimming at varied depths;
said apparatus of claim 3, optional extension pull pipe strainer which can be added to the pull down pipe extension and prevent objects from entering the pumping system;
said apparatus of claim 3, optional extension deep pull pipe strainer sponge media pre-filter which can be added to the deep pull down pipe extension and strainer assembly to block smaller particle from entering the pumping system, this adds mechanical filtration to the system;
said apparatus of claim 3, optional extension deep pull pipe conversion vac pipe and skimbob assembly which can replace or be included with the box bottom extension deep pull pipe/strainer/sponge assembly and/or the box bottom deep pull pipe bypass plug;
said apparatus of claim 3, optional extension deep pull pipe conversion vac (vacuum or vacation) pipe having a tube nipple which connects to a section of tubing which is alternately connected to the opposing end of a top surface skimmer or skimbob;
said apparatus of claim 3, optional vacuum/vacation pipe extension with tube and skimbob assembly being positioned so that the skimbob floats freely in the habitat chamber area where it will skim the habitat chamber top surface water column continuously and pipe it into the optional vacuum/vacation pipe extension for its introduction into the filter system;
said apparatus of claim 3, optional vacuum/vacation pipe extension with tube and skimbob assembly allowing for the bypass of the box bottom front upper skim slots entirely so that when evaporation takes place over time and reduces the inner habitat chamber's overall water level to a point where the top habitat chamber water level reaches below the box bottom front upper skim slots, an action which would normally cause the system pump to run dry;

4. The apparatus of claim 1, wherein the layout comprises a method for the removal of detritus and protein based waste particles from the habitat containment water column through the incorporation of a high flow evaporative protein bioskimmer filter which adds mechanical filtration to the system;
said apparatus of claim 4, cyclonic high flow evaporative protein bioskimmer filter being plugged onto the supply-in, venturi pump head port side, of the dual head system pump w/venturi and includes a foam catch cup, conners bridge foam disbursement cap, and float with float level indicator;
said apparatus of claim 4, cyclonic high flow evaporative protein bioskimmer filter being positioned behind the incoming water flow of the apparatus of claim 1, front internal side of the box filter w/c.o.d.;

5. The apparatus of claim 1, wherein the layout comprises a method for use of a wet/dry trickle drip tray system with optional bio media storage drip tray or optional interchangeable biotower biologic storage generators;
said apparatus of claim 5, biotower biologic storage generators containing a specific mesh or weave that is designed specifically for the cultivation and storage of biologic wet and dry bacteria biomass collections which adds biological filtration to the system;

6. The apparatus of claim 1, wherein the layout comprises a method for the combined use of a doser which adds chemicals and treatments to the system, sponge pre-filter which adds mechanical filtration to the system, and a carbon media pre-filter which adds chemical filtration to the system;
said apparatus of claim 6, doser additive tube, doser additive tube seal, and doser additive tube cap/stand being located readily accessible;
said apparatus of claim 6, sponge media pre-filter being positioned in one or both the incoming water flow of the apparatus of claim 1, internal side of the box filter w/c.o.d. where it can add additional mechanical filtration to the system;
said apparatus of claim 6, carbon media pre-filter being positioned in the internal side of the box filter w/c.o.d. where it adds additional chemical filtration to the system;

7. The apparatus of claim 1, wherein the layout comprises a top-off, water fill, additive, and feeding port and/or manual or electronic feeding apparatus;
said apparatus of claim 7, top-off, water fill, additive, and feeding port being used for adding top-off water to the main tank/habitat chamber containment area after evaporation has taken place and/or for the introduction of introduced water treatments, additives or food into the main tank/habitat chamber containment area for submerged food release and/or submerged feeding;
said apparatus of claim 7, top-off, water fill, additive, and feeding port also provides a location to mount the apparatus of claim 7, clip-on manual soak feeder assembly, in addition to the apparatus of claim 7, alternate clip-on electronic soak feeder assembly versions;
said versions both being readily attachable to the apparatus of claim 7, top-off, water fill, additive, and feeding port combination for the ease of manually or automatically adding food into the main tank/habitat chamber containment area via the apparatus of claim 1, internal cyclonic transfer chamber which is actively fed by the apparatus of claim 1, submerged internal main supply pipe, and which leads directly down to the apparatus of claim 1, submerged top-off, water fill, additive, and food release port which is located submerged underwater on the apparatus of claim 1, box filter w/c.o.d.;
said apparatus of claim 7, wherein the layout comprises both the apparatus of claim 7, clip-on manual feeder assembly, in addition to the apparatus of claim 7, alternate clip-on electronic feeder assembly version which can be mounted separately and on their own to the apparatus of claim 7, sliding soak feeder tank wall clip, while performing their same feeding functionalities separately from the apparatus of claim 1, box filter w/c.o.d.;

8. The apparatus of claim 1, wherein the layout comprises the combined use of a tidal flow control system with an out-flow mounting port which can house the apparatus of claim 8, an assortment of bi-directional and adjustable flow control manifolds as well as other aftermarket powerhead assemblies which can assist with main tank/habitat chamber containment area water circulation and water return inflow;
said apparatus of claim 8, wherein the layout comprises a high and low tidal simulator, and tidal flow bioskimmer flow control valve which is used to adjust the level of air being introduced into the system at any given time, as well as the backpressure required to increase or decrease the water pressure and flow being released from the said apparatus of claim 8, an assortment of bi-directional and adjustable flow control manifolds;
said apparatus of claim 8, optional bi-directional and adjustable flow control manifolds or after market powerheads can be mounted to said apparatus of claim 1, box filter w/c.o.d to provide directional flow control for water released into the habitat containment chamber;

9. The apparatus of claim 1, wherein the layout comprises the apparatus of claim 9, thermostatic controller interface which works in conjunction with the apparatus of claim 9, sensors and the apparatus of claim 9, probes to provide the apparatus of claim 9, control interface digital display readout for the various water conditions such as temperature, salinity conductivity, redox-orp, and nitrite/nitrate levels, which may be present in the overall habitat chamber containment area water column at any given time;

10. The apparatus of claim 1, wherein the layout comprises the apparatus of claim 10, a clear viewing window which provides sight access to the inner workings of the apparatus of claim 1, box filter w/c.o.d. during operation.
